(19) United States
(12) Patent Application Publication
(10) Pub. No.: US 2008/0037420 A1
(43) Pub. Date: Feb. 14, 2008

(54) Immediate ready implementation of virtually congestion free guaranteed service capable network: external internet nextgentcp (square waveform) TCP friendly san

(76) Inventor: Bob Tang, London (GB)

Correspondence Address: MORRISON & FOERSTER, LLP, 555 WEST FIFTH STREET, SUITE 3500, LOS ANGELES, CA, 90013-1024, US

(21) Appl. No.: 11/807,265

(22) Filed: May 25, 2007

Related U.S. Application Data
(63) Continuation-in-part of application No. PCT/IB05/03580, filed on Nov. 29, 2005.
(63) Continuation-in-part of application No. 10/572,218, filed on Apr. 4, 2006.

(30) Foreign Application Priority Data
Nov. 29, 2004 (GB) 0426176.4
Jan. 31, 2005 (GB) 0501954.2
Mar. 8, 2005 (GB) 0504782.4
May 9, 2005 (GB) 0509444.6
Jun. 15, 2005 (GB) 0512221.3
Oct. 12, 2005 (GB) 0520706.3
Oct. 8, 2003 (GB) 03233580.1
Oct. 20, 2003 (GB) 0324459.7
Dec. 29, 2003 (GB) 0330114.0
May 5, 2004 (GB) 0410020.2
Jul. 1, 2004 (GB) 0414777.3

(51) Int. Cl. H04L 12/26; G08C 15/00

(52) U.S. Cl. 370/229; 370/231

(57) ABSTRACT

Various techniques of simple modifications to TCP/IP protocol and other susceptible protocols and related network's switches/routers configurations, are presented for immediate ready implementations over external Internet of virtually congestion free guaranteed service capable network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.

### CROSS REFERENCE TO RELATED APPLICATIONS

This application is a continuation-in-part of co-pending International Application No. PCT/IB2005/0003580 filed on Nov. 29, 2005 and published under PCT Article 21(2) on Jun. 1, 2006 as International Publication No. WO 2006/056880, which in turn references whole complete earlier filed related published PCT application WO 2005/053265 by the same inventor, and references whole complete Descriptions (and/or incorporates paragraphs therein where not already included in this application) and claims priority of following earlier filed applications: British Patent Application No. GB 0426176.4 filed Nov. 29, 2004, British Patent Application No. GB 0501954.2 filed Jan. 31, 2005, British Patent Application No. GB 0504782.4 filed Mar. 8, 2005; British Patent Application No. GB 0509444.6 filed May 9, 2005; British Patent Application No. GB 0512221.3 filed Jun. 15, 2005; and British Patent Application No. GB 0520706.3 filed Oct. 12, 2005. This application is also a continuation-in-part of U.S. patent application Ser. No. 10/572,218 filed Apr. 4, 2006, which in turn claims benefit under 35 U.S.C. 317 of International Application No. PCT/GB04/04272, the contents of which all are incorporated herein by reference.

### BACKGROUND OF THE INVENTION

At present implementations of RSVP/QoS/TAG Switching etc to facilitate multimedia/voice/fax/realtime IP applications on the Internet to ensure Quality of Service suffers from complexities of implementations. Further there are multitude of vendors' implementations such as using ToS (Type of service field in data packet), TAG based, source IP addresses, MPLS etc; at each of the QoS capable routers traversed through the data packets needs to be examined by the switch/router for any of the above vendors' implemented fields (hence need be buffered/queued), before the data packet can be forwarded. Imagined in a terabit link carrying QoS data packets at the maximum transmission rate, the router will thus need to examine (and buffer/queue) each arriving data packets and expend CPU processing time to examine any of the above various fields (eg the QoS priority source IP addresses table itself to be checked against alone may amount to several tens of thousands). Thus the router manufacturer's specified throughput capacity (for forwarding normal data packets) may not be achieved under heavy QoS data packets load, and some QoS packets will suffer severe delays or dropped even though the total data packets loads has not exceeded the link bandwidth or the router manufacturer's specified data packets normal throughput capacity. Also the lack of interoperable standards means that the promised ability of some IP technologies to support these QoS value-added services is not yet fully realised.

### SUMMARY OF THE INVENTION

Here are described methods to guarantee quality of service for multimedia/voice/fax/realtime etc applications with better or similar end to end reception qualities on the Internet/Proprietary Internet Segment/WAN/LAN, without requiring the switches/routers traversed through by the data packets needing RSVP/Tag Switching/QoS capability, to ensure better Guarantee of Service than existing state of the art QoS implementation. Further the data packets will not necessarily require buffering/queuing for purpose of examinations of any of existing QoS vendors' implementation fields, thus avoiding above mentioned possible drop or delay scenarios, facilitating the switch/router manufacturer's specified full throughput capacity while forwarding these guaranteed service data packets even at link bandwidth's full transmission rates.

Modifying existing TCP/IP stack for better congestions recovery/avoidance/preventions, and/or enables virtually congestion free guaranteed service TCP/IP capability, than existing TCP/IP simultaneous multiplicative rates decrease and packet retransmission mechanism upon RTO Timeout, and/or further modified so that the existing simultaneous multiplicative rates decrease timeout and packet retransmission timeout, known as RTO timeout, are decoupled into separate processes with different rates decrease timeout and packet retransmission timeout values

The TCP/IP stack is modified so that: simultaneous RTO rates decrease and packet retransmission upon RTO timeout events takes the form of complete ‘pause’ in packet/data units forwarding and packet retransmission for the particular source-destination TCP flow which has RTO TimedOut, but allowing 1 or a defined number of packets/data units of the particular TCP flow (which may be RTO packets/data units) to be forwarded onwards for each complete pause interval during the ‘pause/extended pause’ period. simultaneous RTO rate decrease and packet retransmission interval for a source-destination nodes pair where acknowledgement for the corresponding packet/data unit sent has still not been received back from destination receiving TCP/IP stack, before ‘pause’ is effected, is set to be
(A) uncongested RTT between the source and destination nodes pair in the network*multiplicant which is always greater than 1, or uncongested RTT between source and destination nodes pair PLUS an interval sufficient to accommodate delays introduced by . . .
OR
(B) uncongested RTT between the most distant source-destination nodes pair in the network with the largest uncongested RTT multiplicant which is always greater than 1, or uncongested RTT between the most distant source-destination nodes pair in the network with the largest uncongested RTT the most distant source-destination nodes pair in the network with the largest uncongested RTT PLUS an interval sufficient to accommodate variable delays introduced by various components
OR
(C) Derived dynamically from historical RTT values, according to some devised algorithm, eg multiplicant which is always greater than 1, or PLUS an interval sufficient to accommodate delays introduced by variable delays introduced by various components etc.
OR
(D) Any user supplied values, eg 200 ms for audio-visual perception tolerance or eg 4 seconds for http webpage download perception tolerance etc. Note for time critical audio-visual flow between the most distant source-destination nodes pair in the world, the uncongested RTT may be around 250 ms in which case such long distance time critical flows' RTO settings would be above usual audio-visual tolerance period and needs be tolerated as in present day trans-continental mobile calls quality via satellites where with RTO interval values in (A) or (B) or (C) or (D) above capped within perception tolerance bounds of real time audio-visual eg 200 ms, the network performance of virtually congestion free guaranteed service is attained.

Note the above described TCP/IP modification of ‘pause’ only but allowing 1 or a defined number of packets/data units to be forwarded during a whole complete pause interval or each successive complete pause interval, instead of or in place of existing coupled simultaneous RTO rates decrease and packet retransmission, could enhance faster and better congestions recovery/avoidance/preventions or even enables virtually congestion free guaranteed service capability, on the Internet/subsets of Internet/WAN/LAN than existing TCP/IP simultaneous multiplicative rates decrease upon RTO mechanism: note also the existing TCP/IP stack's coupled simultaneous RTO rates decrease and packet retransmission could be decoupled into separate processes with different rates decrease timeout and packet retransmission timeout values.

Note also the preceding paragraph's TCP/IP modifications may be implemented incrementally by initial small minority of users and may not necessarily have any significant adverse performance effects for the modified ‘pause’ TCP adopters, further the packets/data units sent using the modified ‘pause’ TCP/IP will only rarely ever be dropped by the switches/routers along the route, and can be fine tuned/made to not ever have a packet/data unit be dropped. As the modifications becomes adopted by majority or universally, existing Internet will attain virtually congestion free guaranteed service capability, and/or without packets drops along route by the switches/routers due to congestions buffers overflows.

As an example, where all switches/routers in the network/Internet subset/Proprietary Internet/WAN/LAN each has/or made to be of minimum s seconds equivalent (ie., s seconds sum of all preceding incoming links' physical bandwidths) of buffer size, and originating sender source TCP/IP stack's RTO Timeout or decoupled rates decrease timeout interval is set to same s seconds or less (which may be within audio-visual tolerance or http tolerance period), any packet/data unit sent from source's modified TCP/IP will not ever be dropped due to congestions buffer overflows at intervening switches/routers and will all arrive in very worst case within time period equivalent to s seconds number of nodes traversed, or sum of all intervening nodes' buffer size equivalents 1 seconds, whichever is greater (preferably this is, or could be made to be, within the required defined tolerance period). Hence it will be good practise to the intervening nodes' switches/routers buffer sizes are all at least equal or greater than the equivalent RTO Timeout or decoupled rates decrease timeout interval settings of the originating sender source's/sources' modified TCP/IP stack. The originating sender source TCP/IP stack will RTO Timeout or decoupled rates decrease timeout when the cumulative intervening nodes' buffer delays added up equal or more than the RTO Timeout interval or decoupled rates decrease (in form of ‘pause’ here) Timeout interval of the originating sender source TCP/IP stack, and this RTO Timeout or decoupled rates decrease Timeout interval value/s could be set/made to be within the required defined perception tolerance interval.

This is especially so, where the single or defined number of packets/data units sent during any pause periods/intervals are to be further excluded from or not allowed to cause any RTO ‘pause’ or decoupled rates decrease ‘pause’ events even if their corresponding Acknowledgement subsequently arrives back late after RTO timeout or decoupled rates decrease timeout. In which case, in the worst congestion case, the originating sender source TCP/IP stack will alternate between ‘pause’ and normal packets transmission phase each of equal durations→ie the originating sender source TCP/IP stack would only be ‘halving’ its transmit rates over time at worst, during ‘pause’ it sends almost nothing but once resumed when pause ceases it sends at full rates permitted under sliding windows mechanism.

Further with all the TCP/IP stacks, or majority, on the Internet/Internet subsets/WAN/LAN all were thus modified and with RTO Timeout or decoupled rates decrease timeout intervals set to a common value eg, t milliseconds within the required defined perception tolerance period (where t=uncongested RTT of the most distant source-destination nodes pair in the network*m multiplicant), all packets sent within the Internet/Internet subsets/WAN/LAN should arrive at destinations experiencing total cumulative buffer delays along the route of only s*number of nodes OR (t−uncongested RTT)+t whichever is lesser

This contrast favourably with existing TCP/IP stacks' RFC implementations, which could not guarantee no packets ever gets dropped and further could not possibly guarantee all packets sent arrive within certain useful defined tolerance period. During the ‘pause’ the intervening path's congestion is helped cleared by this ‘pause’, and the single or small defined number of packets sent during this ‘pause’ usefully probes the intervening paths to ascertain whether congestion is continuing or has ceased, for the modified TCP/IP stack to react accordingly.

### DETAILED DESCRIPTION OF INVENTION

Next Generation TCPs: Further Improvements and Modifications

External Internet Nodes (which could Also be Applicable to Internal Network Nodes)

The same decoupled ‘pause’/transmit rate decrement and actual packet retransmission timeouts mechanism (ACK Timeout and packet retransmission Timeout) applied to guaranteed service Internet subset/WAN/LAN, could be similarly applied to external nodes on the external Internal cloud/external WAN/external LAN. Here the uncongested RTTest (ie., a variable of the latest smallest minimum time period for a corresponding returning ACK received so far), is used in place of the known uncongested RTT value within guaranteed service Internet subset/WAN/LAN from the received ACK (which could be ACK for the usual data packets sent, or ICMP probe, or UDP probe), a variable of the latest minimum time period for an ACK to be received (since corresponding packet SENT TIME) is updated, this uncongested RTTest serves as most recent estimate of uncongested RTT value between source and destination (better still were the uncongested RTT between the source and external Internet node is actually known). Knowledge can be made of fact that the most distant uncongested RTT on the planet is eg 400 ms, thus could make use of the fact the maximum uncongested RTTest is eg 400 ms (but care should be taken where both ends are eg small 56K modem bandwidth and large packet eg 1500 bytes are transported, in that it takes around 250 ms for 1500 byte packet to completely exit or enter the modems, thus it would be preferable to also obtain the time packet actually completed exiting the modem entirely, to adjust the uncongested RTTest value accordingly).

If any packets RTT (derived from its ACK) a>uncongested RTTest (where a is a multiplicand always greater than 1), THEN ‘pause’ is triggered (but allow 1 or a number of data packets through, or allow only the probe packets through, during the ‘pause’ or extended ‘pause’ interval/s), OR rates decrease to certain percentage, for example, 95% of existing rates (which could, for example, be implemented via traffic shaping techniques or decrementing the Congestion Window size etc.), AND/OR just not incrementing the modified TCP's Window size/Congestion Window size upon subsequent ACKs, as long as the most recent/subsequent received ACK's RTT a continues to be >uncongested RTTest or for a defined period of time derived based on devised algorithms, OR a combination of any of the above.

The rates decrement implementation directly on the TCP stack is trivial, but on Monitor Software/IP forwarding module/Proxy TCP, etc., could be implemented via existing rates shaping/rates throttle techniques OR implementing as another Window size/Congestion Window size mechanism for each TCP flows within Monitor Software/IP forwarding module/Proxy TCP which simply mirror the most recent Effective Window Size value for the particular TCP flows (and/or suspend operations of this mechanism), BUT not mirroring, stops mirroring the most recent Effective Window Size value (ie., start operations of this mechanism) when as long as the particular flow's most recent received ACK's RTT a continue to be >uncongested RTTest. INSTEAD during this time when/as long as the most recent received ACK's RTT*a continue to be >uncongested RTTest the Monitor Software's Window size/Congestion Window size value for this particular flow would be decreased to m %, for example, 95% of the flow's most recent mirrored derived/computed current Effective Window size ie the lesser of Window size/Advertised Window size/Congestion Window size value (NOTE above operation could optionally be delayed by t seconds, for example, 1 second or based on some devised algorithms).

[NOTE: When implementing on Monitor Software, Sender TCP congestion Window size is not directly obtainable on Windows platforms in absence of Windows TCP stack source code thus needs be derived from network, hence Sender TCP source current effective Window size could be derived (effective window size=min Window size, Congestion Window size, Receiver advertised Window size). There are various existing state of art methodology in deriving/approximating current Sender TCP source's current effective Window size/congestion window size values. As an example we can however assume when not overflowing the connection, Sender TCP source's congestion Window size to be Current Send Rate uncongested RTTest (ie., Current Send Rate calculated by picking one ‘distinguished’ packet per RTT monitoring its SENT TIME and its returning ACK TIME, Current Send Rate=(number of bytes in transit between SENT TIME and returning ACK TIME)/(returning ACK TIME−SENT TIME), we can assume Sender TCP source's current Congestion Window size to be equal to number of bytes in transit.

Another example could similarly likewise derive Sender TCP source's current effective Window size/current congestion window size derive by monitoring total bytes forwarded by Monitor Software within an RTT interval.

At the Monitor Software, percentage rates decrement may optionally not need to depend on deriving/estimating the current effective Window size as in above, in its place Monitor Software may effect ‘pause’ (and/or allowing one or a number of packets to be forwarded during this pause interval) instead.

If periodic spaced paused intervals total p*I (I being periodic spaced paused intervals, 1 sec) within, for example, 1 sec, effectively congestion window=(1−(p*I))/1 sec of present throughput (current effective window size*current RTT). Hence to effect 5% rates decrement, (P*I) should be equal to 0.05. This ‘pause’ interval may not even need to be evenly spaced apart periodically, and/or each ‘pause’ intervals may not even need to be of same pause durations.

### EXAMPLE

were there in total 5% less time to transmit during to ‘pause/s’, the bandwidth delay product of the source-destination would now be reduced to 0.95 of existing value. This is because now there would be 5% less number of non-overlapping RTT intervals within eg 1 sec to transmit up to a total effective Window size worth of data bytes for each non-overlapping RTT intervals above. The ‘pause’ interval duration should preferably be set at least equivalent to a minimum of uncongested RTTest, but could be made smaller if required: example in VoIP transmissions sending one sampled packet every 20 ms (assuming much smaller than uncongested RTTest) we can make the single ‘pause’ interval duration of 50 ms within eg 1 sec (ie effecting rates decrement equivalent to 5% effective Window size decrement) into 5 evenly spaced periodic ‘pauses’ within eg 1 sec, each of the ‘pauses’ here to be of duration 10 ms (so as not to introduce lengthy delay in time critical VoIP packets forwarding), or 10 evenly spaced periodic ‘pauses’ within eg 1 sec, each of the ‘pauses’ here to be of duration 5 ms . . . and so forth.

Further, the Sender TCP source code may similar implement the current effective Window size settings entirely utilising ‘pause’ methods, totally replacing need for Congestion Window size settings: in these modified TCPs the current effective Window size at any time would be [min (Window size, Receiver advertised Window size)*((1−(p*I))/1 sec)] not to repeatedly decrement when streams of continued received ACK's RTT*a continue to be >uncongested RTTest: BUT additionally if the most recent received ACK's stream RTT*b (b always >a) which eg corresponds to a packet sent since the most recent latest rates decrement now>uncongested RTTest the Monitor Software's Window size/Congestion Window size value may now be further optionally repeatedly decreased to eg 90/95% (L % or m %) of the ‘present already decreased to L %/m % Monitor Software's Window size/Congestion Window size value {b denotes more severe level of congestion than a, or even packet drops. either or both a and b could be such that they very likely signify/packet drops events. Monitor Software may optionally delay above operations by t sec, eg 1 sec so that all existing unmodified TCPs will synchronise in rates decrement} AND/OR not increment the Window size/Congestion Window size for certain period based on some devised algorithm when certain conditions hold, eg as long as the flow's most recent/subsequent received ACK's RTT*a continue to be >uncongested.

When using Monitor Software, the TCP of course continues to do its own Slow Start/Congestion Avoidance/coupled RTO . . . etc. Monitor Software could predict/detect TCP RTO event, eg when a sent segment's ACK has yet to be received back after a very long period eg 1 sec . . . etc, or from sudden halving of the flow's send rates . . . etc. Monitor Software may further choose to decrement its mirrored Window size/Congestion window size value to eg 90% (n %) of existing, AND/OR just not increment its own Effective Window size/Congestion Window size for the particular flow for some period of time derived based on some devised algorithms eg as long as the most recent/subsequent received ACK's RTT*a continue to be >uncongested RTTest.

Monitor Software could additionally implement its own packet retransmission timeout as well, this requires the Monitor Software to always retain a dynamic Window's worth of copies of sent packets and similar retransmission software module as in TCP, hence Monitor Software could perform above paragraph functions much quicker not needing to wait for TCP RTO indications. Monitor Software could optionally hence prevents late ACKs from causing RTO at the TCP eg by spoofing ACKs to TCP, and control/pace TCP via generated/spoofed ACKs to TCP, eg setting spoofed ACK's with Advertised Receiver Window sizes of 0 to ‘pause’ TCP for period of time or some desired values to decrement TCP's Effective Window size, DUP ACKs with Acknowledgement Number field value=latest sent Seq No value to cause TCP to halve Effective Window size without necessary causing actual packet retransmissions . . . etc. Monitor Software may optionally delay above operations by t sec, eg 1 sec so that all existing unmodified TCPs will synchronise in various rates decrement.

Various different algorithms/combinations of different algorithms could be devised in place of those illustrated/outlined above. Various existing state of art methods or component methods could further be incorporated within any of the methods or component methods described herein as improvements.

The modified TCP (or even modified RTP over UDP/modified UDP . . . etc) flow here does not need to halve rates, since they do not have to increment rates when congested (during buffering events) to cause packet drops, and the eg 10%/5% decrement in transmit rates ensures new flows non-starvations (any other existing unmodified TCP flows would ensure 50% decrement, but they always would strive to increment rates to again cause packet drops). New flows would build up their fair share over time. This also nicely preserves low latencies . . . etc of existing established flows (suitable for VoIP/Multimedia), and reflects existing traditional PSTN calls admissions schedules.

Modified TCPs/modified RTP over UDP/modified UDP here retains their established share, or most of their established share, of link's bandwidth, but do not cause further additional congestions/packets drops.

TCP exponential increase to threshold, linear increase during congestion avoidance after threshold, Sliding windows/Congestion window mechanisms, etc, ensure bottleneck link's onset of congestion is gradual, hence modified TCP and existing unmodified could react accordingly to eliminate congestions. Modified TCP/modified RTP over UDP/modified UDP here may even employ quick sudden burst of sufficient extra traffics, eg when congestion level close to packets dropping, to ensure all or selective existing flows traversing the particular congested link/s gets packets drop notifications to reduce transmit rates: existing unmodified TCPs would halve their rates and takes a long time to build back up to previous congestion causing transmit rates, while modified TCPs would retain most of all their established share of bandwidths along the link/s.

This will be most helpful encourages incremental adoptions of this simple decoupled TCP modifications on the public Internet. Modified Sender TCP sources would achieve higher throughputs, retain their established share of bottleneck link's bandwidths upon bottleneck link's congestion causing drops (or just physical transmission errors causing packet drops) while preserving fairness among flows (cf existing TCPs which lose half their established bandwidths on a single packet drops), and on their own will not cause any packet drops. This modified sender source TCP overcomes existing TCP rates recovery problems, caused by just a single packet drop, in high bandwidth long latencies networks.

Were the Sender TCP Source's traffics originate from external Internet nodes/WAN/LAN and assuming the external originating traffics are time stamped (enabling Receiver TCP to derive the path transmissions time or one-way transmission delay from source to destination), the above modified Sender Source TCP methods could be adapted to act as Receiver based methods.
The timestamps of the originating source needs not be accurately synchronised to the receiver. Receiver could ignore the timestamp drifts of the source system clock here. The OTTest (most current update estimate of one way transmission latency, of received packets from source to destination, being the lowest value derived so far equivalent to current Receiver system time when packet received—Received packet's Sender timestamp) is derived at the receiver. Any increment in OTT observed in subsequent received packets will indicate incipient onset of congestions along the path (ie at least one forwarding link along the path is now fully utilised 100% and packets start being buffered along the path), would now signify that Sender TCP Source should now trigger the modified rates decrement or ‘pause’ mechanism. Receiver could signal this to Sender TCP Source by setting the advertised Window size to zero in the returning ACKs for an appropriate period, before reverting back to same original advertised Window size after the appropriate ‘pause’ or appropriate ‘periodic’ pauses.

By setting the advertised Window size to an appropriately decremented value of the current derived/estimated effective Window size of the Sender TCP Source (effective Window size=min (Window size, Congestion Window size, Receiver Window size), for example, to 95% of current derived/estimated effective Window size of Sender TCP source. Here the Sender TCP Source would not continuously increment the Effective Window size for ACKs received within each RTT, as long as modified Receiver TCP keeps ACKing with same advertised decremented current derived/estimated effective Window size. However if the returning ACK's advertised Receiver Window size now subsequently changed, their increments will not cause any packet drops since the modified Receiver TCP would ensure Sender TCP Source would eventually decrement its effective Window size upon the next incipient onset of congestion along the path. Other possible techniques includes for Receiver TCP to DUP Acks (3 DUP ACKs in succession to trigger halving of Sender TCP source multiplicative Congestion Window decrease). During initial TCP connection establishment phase, the modified Receiver TCP would negotiate to have timestamp option with the Sender TCP Source. This Receiver based modified TCP/modified Monitor Software does not require Sender TCP to be modified.

When both Sender and Receiver TCPs are modified, together with timestamp options, would enable better precise OTTs/OTTs variations knowledge in both directions (both modified TCPs/modified Monitor Software could pass the knowledge of OTT's in their direction's to each other thus modified TCPs/modified Software Monitor could now provide better control using OTTs instead of RTT, eg if the sent segment's OTT indicates no congestion but the returning ACK's OTT indicates congestion, there is no need to rates decrement/‘pause’ even if their RTT as used in earlier RTT based method would have timedout. RTT based modified TCPs, when implemented at Sender only, used together with timestamp option, would enable Sender to similarly be in possession of returning ACK's OTTest and/or OTT variations to similarly provide better controls.

It is noted that were the modified TCP techniques be implemented at both ends of Intercontinental submarine cables/satellite links/WAN links would increase bandwidth utilization and throughput of the transmission media for TCPs, in effect like doubling of the physical link's physical bandwidths.

Those skilled in the arts could make various modifications and changes, but will fall within the scope of the principles.

Prioritising UDPs

It is noted that giving UDP priority over TCP, etc., at each nodes within Internet/Internet subset/WAN/LAN would still results in UDP drops even when UDP traffics does not utilise over 100% of the forwarding link's bandwidth, due to the node's input queue's prior existing TCP buffered packets=>buffered delay for UDP packets or even UDP packet drops:

1. needs upgrade/modify router/switch software to place all UDP packets at the front of the node's input queue buffer (and/or priority placing UDP packets at front output queue from the UDP input queue prioritised over TCP packets even when the TCP packets are already enqueued at the output queue) pushing all TCP packets towards the end of the queue (hence all TCP packets will be dropped before any UDP packet drop at the input and/or output queue).

2. Upgrade router/switch software to allow creation of separate UDP input queue (which could be very small) and TCP input queue, UDP queue gets scheduled to the output queue ahead of TCP packets. And/or implement UDP high priority output queue, and lower priority TCP output queue.

UDP traffics alone may exceed link's physical bandwidth, could have UDP sending sources reduce transmit rate ie resolution qualities and/or router/switch nodes to perform this resolution reduction process on all UDP flows (eg sending only alternate packets of the flow and discard the other alternate UDP packets, or to combined two (or several) eg VoIP UDP packets' data into one packet of same size but of lower resolution quality) nodes may ensure TCP non-complete starvation by guaranteeing minimum proportions of forwarding link's bandwidth for various UDP/TCP, etc., flows.

Bandwidth Estimations

Further modification includes (and could be used in conjunction together with earlier described uncongested RTT/RTTest/RTTbase/OTTest/OTTbase/Receiver OTTest methods, thus allowing ample time for the techniques below, which may needs some time to provide output results, to complement above methods):

1. using methods like pipechar, pipechar, traceroute, pathchar, pchar, pathload, bprobe, cprobe, netest, chirp . . . and similar techniques to ascertain each traversed node's forwarding link's bandwidth, utilization, throughput, queue length, delay encountered . . . etc to ‘pause’ for appropriate interval derived from algorithm devised for the purposes/rates decrease (according to some optimised algorithm devised) when certain conditions encountered eg forwarding link utilization approaches 100% so as to ‘pause’/rates decrease so that no queues gets formed/no packet gets buffered (ie., pre-empts buffer delays so all nodes traversed do not introduce any buffer delays whatsoever).

For example, when utilization (which could be inclusive of all UDPs ICMPs TCPs) at a particular link approaches eg 95% could just not increment window size anymore for ACKs received, and only if/when subsequently packet gets dropped then decrement by eg only 10% (to allow new flows to not get completely ‘starved’ of bandwidth at the particular link) and/or perhaps thereafter not increment window size for each ACKs. We do not need to stop decrementing window size if packets dropped due to physical transmission errors (ie not due to buffer overfilled congestions), if link utilization at the particular link along the path is under, for example, 95% (or specified percentage) utilization solving high bandwidth long RTT TCP rates recovery problems. This will be most helpful encourages incremental adoptions of this simple decoupled TCP modifications on the public Internet. New flows (UDPs ICMPs TCPs), and/or existing unmodified TCPs/RTP over UDPs/UDPs, should now always have at least 5% non-starvation guaranteed bandwidth to grow at all time, as modified TCPs/RTP over UDPs/UDPs could eg all not increment transmit rate when link utilization exceeds eg 95%. And if/when subsequently the link drops packets, then modified TCPs/RTP over UDPs/UDPs will decrement Window Size/Transmit rate by eg 10% (or pause for an interval x periodically before transmitting at unrestricted rates permitted by the sending source immediate transmission media for period y, such that eg x/(x+y)=0.1, ie equiv to Sliding Window or Congestion Window size decrement/rates decrement of eg 10%). Pausing for interval x, instead of Sliding Window/Congestion Window Size decrement/rates decrement, would gives fastest possible early clearing of congested buffers at the node, and helps keeps buffer delays at the nodes along the path to the very minimum.

Buffer size requirements here is not a very relevant factor for considerations at all. Could conceivably keeps all traffics to within/not exceed 100% of the available physical bandwidths at all time (subject to very sudden burstiness may be needing to be buffered).

For VoIP/Multimedia (eg utilising RTP over UDP/UDP), or aggregate VoIP/Multimedia traversing the same path/same portions of path, upon a link starting to exceeding eg 95% or even nearer to 100%, the source VoIPs/Multimedia may now transmit at eg some percentage eg half the resolution quality and wait until the other traffics' growth now bringing link utilization back up to eg 95%/100%, to now sudden burst back to full resolution quality transmission and/or plus extra resolution eg 200% or more (with extra redundant erasure codings . . . etc) to cause immediate sudden burst and buffer packets dropped triggering other TCP flows (modified or not) to rates decrease (usually within 1 sec in existing RFC TCP implementations), and when the other flows eg TCPs now rates decrement, to then immediately revert back to 100% original transmission quality (or even perhaps continue to grab as much bandwidth staying with 200% resolution quality transmissions, depending on link's bandwidth/proportions of bandwidth utilised by VoIP/Multimedia/buffer size at the node . . . etc)=>ensure minimum possible buffer delays of VoIP/Multimedia.

Perhaps VoIP/multimedia may even begin with higher resolutions transmission quality (eg 200% of normal required resolutions, with redundant erasure codings, etc. This is helpful to all flows as it ensures as little buffer delays periods as possible at the nodes traversed, for all flows. Router Software may further be upgraded to permit authorised request to drop flow packets (eg 1 packet from each TCP flow to signify sender to rates decrement), and/or to do this upon detection of eg 95%/100% link utilizations.

Above method may be used in conjunction with existing eg RIP/BGP router table update packets, and/or similar techniques, to ensure minimum or no buffer delays at all nodes, upgraded router software does the links preference routing table update to pre-empts eg exceeding 95%/100% of particular forwarding links . . . and/or propagates this throughout network not just neighbouring routers (but would need to be enhanced to allow more frequent real time speed updates).

Another next generation network design may be for router to signal neighbouring routers of particular forwarding link's eg 95%/100% utilization (100% utilization would indicate imminent onset of packets buffering) and/or other configuration details such as links' raw bandwidths/queuing policies/buffer sizes . . . etc, for neighbouring router to not increase existing sending rates to this router/or just this forwarding link, AND/OR per flow rates decrement/rates shaping on the flows which traverses the notified router link by some percentages based on devised algorithms depending on updated informations or even some corresponding ‘pause’ interval x before continue unrestricted sending rates for period y (limited in fact only by the link bandwidth between the routers). Any TCP flows' packets needing buffering during the ‘rates decrement’/‘pause’ would only be at most of Window size at any one time, and RTP/UDP flows could likewise be buffered=>conceivable now to may be possibly even do away with any source Congestion Avoidance TCP rates limiting mechanism! The router may also modify setting the advertised Window size field in the ACKs returning to Sender TCP source to be zero for certain duration or certain duration periodically (causing ‘pause’ or periodic ‘pause’), or even modify/set the advertised Window field value to certain decremented percentage of derived/estimated current effective Window size of Sender TCP source (thus effecting rates limiting of source traffics). The switch/router on the Internet/Internet subset/WAN/LAN needs only maintain table of all flows' source-destination addresses and/or ports together with their latest Seq Number and/or ACK number fields (and/or per flow forwarding rates along the link, current derived/estimated per flow Effective Window sizes along the link . . . etc) to enable router to generate Advertised Window Size updates via ‘pure ACKs’ and/or ‘piggyback ACKs’ and/or replicated packets’ . . . etc (eg notifying source TCPs to ‘pause’ via continuous advertised Receiver Window size of 0 for certain period before reverting to existing Receiver Window size value prior to the ‘pause’, or reduce rates via advertised Receiver Window size of decremented value based on derived/estimated current source TCP Effective Window size). Neighbouring routers would reduce/traffic shape packets destined to the along the notified router's link of next router, neighbouring knowing certain packets IP addresses are destined to be routed along the notified next router's link from Routing Table entries, RIP/BGP updates, MIB exchanges, etc. For example, an already periodically paused flows at the neighbouring router preceding the notifying router (rates controlled via periodic ‘pauses’) would now further increase the affected flows' ‘pause’ interval length and/or increase the number of ‘pauses’ within the period. The periodic pauses may cease or lessen in frequency/individual pause interval, upon eg some defined period derived from devised algorithms eg when the notifying router now updates neighbouring routers indicating link utilizations which has fallen back down below certain percentage eg below 95%.

RED/ECN mechanism could be modified to proved this functionality, ie instead of monitoring buffered packets and selectively drop packets/notify senders, RED/ECN may base policies on link utilizations eg when utilizations approaches some percentages, for example, 95%, etc.

Above bottleneck link utilization estimation, available bottleneck bandwidth estimation, bottleneck throughput estimation, bottleneck link bandwidth capacity estimation techniques could be further incorporated into the earlier described rates decrement/‘pause’ methods based on uncongested RTT/RTTest/RTTbase/Receiver OTTest methods: here there would be plenty of time for the bottleneck link utilization estimation, available bottleneck bandwidth estimation, bottleneck throughput estimation, bottleneck link bandwidth capacity estimation techniques to be derived/estimated for sufficient good accuracy to further enhance the earlier described rates decrement/‘pause’ methods based on uncongested RTT/RTTest/RTTbase/Receiver OTTest methods. Various further techniques to complement/provide path's topology/configurations may include SNMP/RMON/IPMON/RIP/BGP . . . etc.

2. periodic probes could be in form of Windows Update probe (to query receiver Window Size, even though receiver has yet to advertise 0 window size) or similar probe packets, or uses actual data packets as periodic probes (where available for transmissions), etc, or UDPs to destination with unused port number (to get return msg destination port unreachable), and/or plus timestamp options from all nodes. OR similarly TCP to destination with unused port number (THE TCP PACKET MAY BE TCP SYNC TO UNUSED PORT NUMBER).

Various Notes

[Note If paused intervals total p*I within eg 1 sec, effectively congestion window=(p*I)/1 sec of present throughput (current effective window size*current RTT)]

Upon detecting congestion time critical applications could send burst to cause packet drops, or receiver detecting congestion from timestamp to cause or notify server to cause burst perhaps in form of large probes conveniently.

In addition to RTTest technique on external Internet nodes, could improve using bandwidth est techniques in conjunction: eg receiver processor delay, raw bandwidth, available bandwidth, buffer size, buffer congestion level, link utilisations Receiver based OTTest need not deploy GPS synchronisation, just need uncongested OTTest or uncongested OTTbase or known uncongested OTT and OTT monitor variations!!!

Sender and/or Receiver based raw bandwidth and throughput ESTIMATIONS=>LINK UTILISATIONS.

Use timestamp (sender and echoer) so sender can block out receiver processing delay variances.

Modified TCP/modified Monitor Software when paused, could optionally immediately generate and send (despite ‘pause’) a pure ACK carrying no data payload corresponding to every newly arrived data segments with ACK flag set (ie piggyback ACK segments or pure ACKs, ignoring normal data segments which does not ACK anything) from host source TCP which now needs to be buffered. All generated pure ACK/s during this pause interval/extended pause intervals, which is/are sent immediately, could have its/their Seq Number field value set to be the very same Seq Number as that of the very 1^{st} buffered data segment MINUS 1 (which could be normal data segment with or without ACK flag set, or pure ACK segment). If newly arrived segments are pure ACKs just buffer them all the same, and generate/send a pure ACK corresponding to this newly arrived now buffered pure ACK! forwarding this newly arrived pure ACK at this time ahead of other buffered data segments may cause receiving TCP to now receive a packet with Seq Number larger than its next expected Seq Number which should be the same as the last sent Acknowledgement number. Once generated pure ACKs are sent, the corresponding now buffered pure ACK may optionally now be removed and discarded from the buffer, since there is no point in sending duplicate pure ACK. A pure ACK may be instead be generated and corresponding to the buffered segment with the largest Acknowledgement number among all buffered packets within this pause/extended pause interval period.

Modified TCPs/modified Monitor Software may optionally enable segments with URGENT/PSH flags . . . etc to be immediately forwarded even during ‘pause’/extended ‘pause’

Could also derive Actual rate=bytes transmitted since segment's SENT TIME/ACK Timeout. Keeps event list of entries containing Seq No, ACK Timeout, bytes in this segment. Or set Actual rate=bytes transmitted since segment's SENT TIME/(this particular ACK Timedout segment's SENT TIME−last unacked segment's SENT TIME on the list, if there is no last segment on list with SENT TIME=this ACK Timedout segment+ACK Timeout period. Or use Actual rate based on immediately previous sent segments within ACK Timeout period. (perhaps may also derive actual rate=Acks received ie total bytes corresponding to all those segments acked) within an RTT or ACK Timeout period).

Receiver base could distinguish between congestion loss and physical transmission error, and detect rates, OTT or OTTbase, onset of congestions separately in either directions much more accurately. Even better sender receives ACK back with timestamp of when receiver first receives the packet, and/or when receiver last touch the packet (and/or ACK) sending back to sender (eg IPMP).

Note could also derive throughput=Window*MSS/RTT bytes/sec

Modified TCP technology implementations for Multicast needs implementation/hierarchical coordinations at router's multicast module.

Monitor software may coordinate better once sender and/or receiver identified each other's presence, eg via unique port number establishments=>Monitor software could then switch to appropriate mode/combination of modes operations.

May not want to ‘pause’ if sending/receiving over external nodes, but preferable if to enable this preferred ‘pause’ inclusion such as when the incremental adoption over Internet becomes vast majority (perhaps user selectable option)!

May initially probe for available bandwidth and/or raw bandwidth capacity of the path (corresponding to the bottleneck), then start TCP Window size such that eg 95% of available bandwidth or eg 95% of capacity immediately utilised.

May increment Window size much faster, eg*1/cwnd . . . etc, if RTT continues<ACK Timeout.

Note ACK Timeout (and or actual packet retransmission Timeout value) value may be dynamically derived based on devised algorithm for the purpose, from returning real time RTTs similar to existing RTO estimation algorithm from historical RTTs.

In RFCs, DUP ACKs should not be delayed, here we complied by already sending generated pure ACKs immediately for every buffered ACK packets or just their highest ACK No.

To avoid the problem of rerouting paths which could give erroneous estimations of the RTTs, we can adopt a hop-by-hop RTT estimation and bandwidth probing. Using the active networking technology for practical implementation, a per-section dialogue is performed between adjacent nodes including the routers.

Note: In RFCs A TCP receiver MUST NOT generate more than one ACK for every incoming segment, other than to update the offered window as the receiving application consumes new data.

Could reduce Window sizes/increase ‘pause’ period depending on DIFF (RTT, uncongested RTT/RTTest). Percentage rates decrement/‘pause’ interval lengths may be adjusted depending on the size of the buffer delays experienced along the path eg OTT−OTTest (or OTT−known uncongested OTT), or RTT−RTTest (or RTT−known uncongested RTT).

When modified Receiver TCP receives the modified Sender TCP's generated pure ACKs for sender's buffered ACK packets while ‘paused’ (or even any and all ACKs), modified Receiver can optionally/especially generate 1 byte with Seq number set to last ACK number−1 ie to generate returning ACK thus modified Sender TCP knows been definitely received (in which case may need to ensure each and every buffered packets are individually generated pure ACKs, instead of largest Seq Number ACK only): sender TCP may infer if the 1 byte data generated pure ACK not returned by receiver in ‘packet replication ACK’ (even though replicated packets are not passed to applications at receiver)=>to then react accordingly (eg could be reverse path congestion/congestion loss/transmission errors, or forwarding's, in which case may want to send the generated 1 byte data pure ACK again . . . etc.

Monitor Software at both ends, or Sender only or receiver only: Acking the ACK (to remove main cause of RTO, ie lost ACK. Lost data segments usually gets DUP ACKed−>fast retransmit) using receiver's latest Seq No (replicated packet) or latest Seq No and 1 byte data or even latest remote's ACK No−1.

Receiver based: Resends ACKs if ACKs not confirmed back received. Send DUP ACKS (fast retransmit) to arrive again before eg 1 sec since original segment SENT TIME, to prevent RTO which cause TCP to re-enter slow start with CWND=1. Can dynamically adjust Receiver Window size, as % of estimated Sender's maximum actual transmitting Window size (corresponding to the actual rate, could assume this actual transmitting Window size is equiv to total packets in flight) during preceding RTT interval.

Future RFCs for TCP should have one extra Acking ACK field (Acking the ACKs control feedback loop), this completes the control loop (ie existing TCPs are blind as to whether RTOs are due to data segment loss on the forwarding link or its corresponding ACK loss on the returning link), improves both TCP's knowledge of events states.

OR

Monitor Software may perform this ACKing the ACKs via ACK with Seq No (replicated segments), etc.

With Monitor Software at both ends, receiver could coordinate to pass one way transmission times, in both directions, to the other. Receiver based Monitor Software could derive external Internet node's OWD (One way delay) from timestamp option requested at SYNC connection establishment. Sender based Monitor Software could estimate OWD to remote receiver via IPMP, NTP . . . while receiver to Sender OWD via timestamp option. In cases where both ends with cooperating Monitor Softwares, OWDs in both directions can be established=>together with ACKs ACKing loop, this enables distinguishing packet loss due to packet drop in sending direction or ACKS LOSS IN RETURNING DIRECTION or physical transmission errors.

OWD needs timestamp to derive, or ipmp/icmp probes/ntp . . . etc. With Monitor Software at both ends, just timestamp segment when received and when returning Acking the Segment Seq No (all these 2 timestamp values, coupled with sending monitor recording of segment seq no SENT TIME kept in event list, and arrival time of the Seq No's ACK provides all OWDs, ends processing delays, etc.

Known OWD both directions eg submarine cables, WAN links and/or known timestamps drifts/accuracies and/or known switch/router/end host processing latencies under congestive/non-congestive operations environment bounds, would improve performance.

ICMP about only packet with ready send, receive, return time stamps giving OWDs both directions, in wan/lan/small internet subsets traverses same paths as tcp/udp both directions. RFC for tcp/udp should enable these timestamps. Periodic icmp probes could complement passive tcp rtt measurements. IPMP provides similar timestamp capability and traverses the same paths as the sent TCP segments, and could be utilized as the probe packets sent with same IP addresses as the flow/s TCP IP addresses but with different port addresses. Were both ends implement modified TCP/modified Monitor Software, the periodic probe packets may take the form of separate independent TCP or UDP or IPMP connection established between the two ends' modified TCP/Monitor Software with same IP addresses as the flow/s TCP IP addresses but with different port addresses, and both ends' modified TCPs/Monitor Software could now include timestamps of time when segment with the Seq Number first arrive and/or time when segment with the same Seq Number is ACKed and returned, enabling OWD measurements by both ends.

Implementing TCP Modifications to Work Over External Internet

Where either one of the source sender or receiver (or both) resides at external Internet, the data packets communications between the source sender and receiver could be subject to congestion packet drops beyond our control: eg http webpage download/ftp from external Internet sites. Note the Method/s here extend our modifications/inventions to also be applicable where either one of the source sender or receiver (or both) resides at external Internet, BUT could also be applied where both resides within Internet subsets/WAN/LAN/proprietary Internet as in various earlier described Methods in the description body.

The above effects of congestion packet drops would trigger RTO packet retransmissions timeout and accompanying return to ‘slow start’ with CWND then set to 1 segment size at the source sender TCP, for the source sender TCP transmit rate per RTT/TCP congestion window size CWND to climb back to eg 1K*segment size would take around 10 exponential increases of the CWND from initial ‘slow start’ (2ˆ10=1K), ie source sender would need to receive 10 consecutively successful uninterrupted ACKs from receiver (no congestion drops) which with RTT of 200 ms would take 10*300 ms=3 seconds to climb back up to CWND of 1K*segment size. Once the CWND reaches SSThresh value, the CWND would now only increment linearly per RTT instead of exponential increment per ACK during ‘slow start’. See RFC 2001 http://www.faqs.org/rfcs/rfc2001.html.

It is the onset of RTO packet retransmissions timeout and accompanying re-entering into ‘slow start’ with CWND set to 1 segment, upon congestion packet drops, that causes the most degradations in the end-end transfer performance. Thus it would be advantageous for the source sender TCP to be modified to react quicker to generate DUP ACKs to trigger fast retransmit with . . . at the remote source sender TCP.

With DUP ACKs Fast Retransmit/Recovery algorithm now commonly implemented in most TCP, sender source TCP would now only RTO packet retransmit timeout with accompanying re-entry into ‘slow start’ only under two Scenarios sender source TCP sent data packet/s to receiver (one single packet or continuous block of packets), which all never arrives being lost/dropped, hence Receiver TCP would have no way of knowing whether these packet were actually sent or not to generate DUP ACKs for these non-arriving next expected Seq Number packet/s. Note if any of the later of these sent continuous block of packets did arrive even though some of the earlier of these packets were dropped, Receiver TCP would still be in position to generate DUP ACKs to sender source TCP to trigger fast retransmit/recovery which only halves the CWND instead, thus averting sender source TCP's RTO packet retransmissions timeout event which would cause sender source TCP re-entering ‘slow start’ with CWND of 1 segment. Note existing RFC stipulates default RTO timeout lowest minimum floor of 1 second under any circumstance, thus DUP ACKs triggering fast retransmit/recovery, if the subsequent Acknowledgements for these retransmitted packets arrives back to sender source TCP within the RTO timeout of eg minimum 1 second, would avert the pending normal RTO packet retransmissions timeout event.

The Acknowledgements generated by receiver back to sender source TCP were lost/dropped thus never arrives back at sender source TCP, thus sender source TCP would now RTO timeout re-entering ‘slow start’ with CWND of 1 segment size.

Scenario (A) above could be prevented by modifying sender source TCP so that eg IF the immediately next sent data packet's Acknowledgement is not received back after eg 300 ms (or user input value, or algorithmic derived value which may be based on RTTest(min) and/or OTTest(min) . . . etc, 300 ms was chosen example here as being larger than the Delayed Acknowledgement max period of 200 ms) of the immediately previous sent data packet's Acknowledgement which has been received back or eg 300 ms+latest RTTest elapsed since the immediately next sent data packet's Sent Time whichever is the later (ie we can now quite safely assume the immediately next sent packet was lost/dropped or its Acknowledgement from the receiver back to sender source TCP was lost/dropped, THEN [hereinafter refers to as algorithm A] (Except where all sent data segments/data packets have all already been returned Acknowledged back, ie latest sent ‘largest’ valid SeqNo=latest received ‘largest’ valid ACKNo) ie sender TCP should now instead continue normally unaffected by the ‘elapsed-time-interval event) sender source TCP should now immediately enter into ‘continuous pause’ state but allowing eg only one regular data packet and/or several pure ACK packets transmissions during each eg 150 ms (or user input value, or algorithmic derived value which may be based on RTTest(min) and/or OTTest(min) . . . etc) that elapsed during this ‘continuous pause’ state UNTIL an Acknowledgement packet/regular data packet is next received back from the receiver TCP (thus signifying the round trip path is now not totally congested ie not dropping each and every packets in either of the directions) whereupon the ‘continuous pause’ ceases immediately reverting to same transmission rates/CWND size as previous to the initial elapsed 300 ms triggering ‘continuous pause’.

Parts of Algorithm A's ‘could be adapted differently in various different combinations thereof:
1. instead of entering into ‘continuous pause’ upon initial elapsed 300 ms, the sender source TCP only reduces its CWND to x % (eg 95%, 90%, 50% . . . which could be user input or based on some devised algorithms)
and/or
2. instead of entering into ‘continuous pause’ upon initial elapsed 300 ms, the sender source TCP only ‘pause’ for ‘pause-interval’ which may be user input or derived from some devised algorithms (eg pause-interval of 100 ms would be equivalent to above Step 1 reducing CWND to 90%) without changing the CWND size
and/or
1. in addition to Step 1 and 2 above, instead of entering into ‘continuous pause’ upon initial 300 ms elapsed, only immediately ‘pause’ for an ‘initial pause-interval’ only which may be user input or derived from some algorithm, eg 500 ms to ensure all the cumulative buffered packets delays built up along the router/switches nodes traversed by packets from sender source TCP to receiver TCP would be cleared by this eg 500 ms amount, reducing buffer latencies experienced by subsequently sent packets.
and/or
4. in addition to Algorithm A or Steps 1, 2 and 3 above, where the packets sending rates is limited to 1 regular data packet and/or several pure ACK packets per eg 150 ms elapsed period during the ‘continuous pause’ or ‘pause-interval’ or ‘initial pause-interval’ as in Algorithm A, sender source TCP now instead transmit at rates permitted by the new CWND size during ‘continuous pause’ or ‘pause-interval’ or ‘initial pause-interval’ OR not transmitting any packet/s at all
and/or
5. in addition to Algorithm A or Steps 1, 2, 3 or 4 above, where UNTIL an Acknowledgement packet is next received back from the receiver TCP (thus signifying the round trip path is now not totally congested ie not dropping each and every packets in either of the directions) whereupon the ‘continuous pause’ or ‘pause-interval’ or ‘initial pause-interval’ ceases immediately reverting to same transmission rates/CWND size as previous to the initial elapsed eg 300 ms triggering ‘continuous pause’, HERE sender source TCP resumes transmission rates where applicable as limited by the new CWND size.

Just one example of a useful combinations of above would be to ‘initial pause’ for eg 500 ms to clear buffer delays either sending no packets at all during this eg 500 ms or allowing 1 regular data packet and/or several pure ACK packets every eg 150 ms during this eg 500 ms, follows by ‘pause-interval’ upon eg 500 ms now elapsed either sending no packets at all during this ‘pause-interval’ or allowing 1 regular data packet and/or several pure ACK packets every eg 50 ms during this ‘pause-interval’ of eg 100 ms, THEN upon an Acknowledgement packet is next received back from the receiver TCP to immediately ceases ‘pause-interval’ reverting to same transmission rates/CWND size as previous to the initial elapsed eg 300 ms event or new transmit rate as limited by the new CWND size. Note suitable choice of derivations of the initial eg 500 ms would help other time critical packets like VoIP/Multimedia to not experience severe buffer delays. Timestamp options could enable OTTest information to be utilised in sender source TCP decisions, SACK option if used would reduce occurrences of DUP ACKs events.

Sender source TCP could be further modified as above to do away with requirement for re-entering ‘slow start’ under any circumstances whether packet loss is due to congestion drops or physical transmission errors . . . etc, ie TCP could now be made to eg maintain transmit rate/CWND to eg 90% of the transmit rate/CWND (or equivalent ‘pause-interval’ of 10 ms, without changing CWND) previous to the RTO packet retransmissions timeout or DUP ACKs fast retransmit, instead of re-entering RTO ‘slow start’, fast retransmit rates halving . . . etc. This would also be applicable to any of the preceding methods/sub-component methods described in the description body. Here the further modified TCP could react much quicker to congestion drops react accordingly eg including an ‘initial pause-interval’ to clear cumulative buffered delays cf existing RFC's minimum RTO default lowest floor of 1 second.

The above Algorithm A itself and/or its various modified combinations could be further modified/adapted, but would still fall within the principles disclosed therein. As an example among many, where the modification is implemented within modified Monitor Software/modified proxy TCP/modified IP Forwarder . . . etc instead of directly within TCP stack itself, modified Monitor Software/modified proxy TCP/modified IP Forwarder . . . etc could keep copy of current window's worth of data segments/data packets transmitted and perform the actual 3 DUP ACKs fast retransmit and RTO actual packet retransmit (instead of TCP which now simply would not carry out any fast retransmit and RTO retransmit whatsoever at all) eg when modified Monitor Software/modified proxy TCP/modified IP Forwarder . . . etc realises particular data segment/data packet sent has not been returned ACKed and TCP would soon perform RTO timeout, to then ‘spoof’ the particular Acknowledgement for the particular ‘soon late’ data segment/data packet and perform the actual data segment/data packet retransmissions here, AND upon receiving fast retransmit DUP ACKs to not forward these to TCP and instead perform the fast retransmit here (thus this modified end's TCP will not ever reduce its CWND/transmit rate which may then stay at max TCP window size transmit rate, however the ‘pause’ period here would adjust the sender's actual effective transmit rates ie by limiting the time slice available for unrestricted TCP transmissions within each seconds).

Very often the modified TCP is installed at user local host PC only, and the remote sender source TCP such as http web servers/ftp servers/multimedia streaming servers have yet to implement the above modified TCP. Hence the modified local host PC's TCP would here need to act as Receiver based modified TCP, ie to influence the remote sender source TCP remotely. Some of the ways local host TCP could influence the remote sender source TCP congestion controls/avoidance are via sending receiver window size updates to remote sender source TCP, sending DUP ACKS to remote sender source TCP to fast retransmit/recover averting RTO packet retransmissions timeout at the remote sender source TCP . . . etc

Here is described an outline for a very simplified Receiver based modified TCP implemented in Monitor Software (which can be further modified/adapted, and can also be implemented directly within TCP itself instead of Monitor Software):
1. whenever receiving TCP packet from remote sender, check Source Address and Port if already in table of per flow TCPs ELSE create new per flow TCP TCB with various parameters: (NO NEED TO MAINTAIN EARLIER SEQ NO/TIME SENT TABLE ENTRIES FOR ALL INTERCEPTED PACKETS)
latest packet RECEIVED LOCAL SYSTEM TIME (received from remote sender, pure ACK or regular data packet), latest receiver packet's advertised window size (sent by local MSTCP to remote sender), latest receiver packet's ACK Number ie next expected Seq Number expected from remote sender (sent by local MSTCP to remote sender, requires per flow incoming and outgoing packets inspections, and we now should be able to immediately removes the per flow TCP table entry upon FIN/FIN ACK not just waiting for usual 120 seconds inactivity), etc, (optional). Upon Sync/Sync ACK completed, immediately set remote sender's CWND to eg 8K. This is preferable done via eg 15 immediate DUP ACKs with eg ACKNo=remote sender's initial SeqNo+1, Divisional ACKs may not work well as some TCPs increment CWND only by the number of bytes ACKed instead and Optimistic ACK behaviour may not be identical in all TCPs.

Note: alternative we would wait for the 1st data packet received from remote sender to then generate eg 15 DUP ACKs with ACKNo set to the same just received SeqNo from remote sender (at just 1 byte unnecessary retransmission expense), or using Divisional ACKs.

TCP uses a three-way handshaking procedure to set-up a connection. A connection is set up by the initiating side sending a segment with the SYN flag set and the proposed initial sequence number in the sequence number field (seq=X). The remote then returns a segment with both the SYN and ACK flags set with the sequence number field set to its own assigned value for the reverse direction (seq=Y) and acknowledge field of X+1 (ack=X+1). On receipt of this, the initiating side makes a note of Y and returns a segment with just the ACK flag set and an acknowledgement field of Y+1.

2. If 300 ms expires without receiving next packet then
==>we just need to within software detect next expected Seq No not arriving within 300 ms of previous last received packet to generate 3 DUP ACKs with ACK No set to the non-arriving next expected Seq No, AND at the same time to convey window update of 1800 bytes within the 3 DUP ACKs (equiv to sender's ‘pause’+1 packet): keeps sending the same 3 DUP ACKs window update of 1800 bytes incremented by 1800 bytes each time if eg 100 ms elapsed without receiving any pure ACK or regular data packet, BUT if any ACK or any regular data packet next received at all THEN send USUAL (not 3 DUP ACKs) same single window update restoring previous window size (ACKNo field set to ‘; recorded’latest ‘largest’ ACKNo sent from local MSTCP to remote, or −1) repeatedly every 100 ms until any ACK or regular data packet next received again from remote THEN repeat above eg 300 ms expiration detection loop at very start of step 2 above.

Note here we could also send 3 DUP ACKs in place of the single window update packet but after 2 further 100 ms elapsed the single window update ACK packets would have totaled to 3 DUP ACKs window update packets, of course an alternative here could also be any window update packets eg DUP SeqNo window update packet . . . etc.

(This ensures SCENARIO A causing pending remote MSTCP RTO timeout re-entering slow start is AVERTED, replacing the pending RTO by DUP ACKs fast retransmit/recovery event. IF there really wasn't any packets sent at all, it doesn't really matter that we unnecessarily sent 3 DUP ACKs with ACK Number=next expected Seq Number.

SCENARIO B is taken care of by keeping sending same 3 DUP ACKs every 100 ms, UNTIL a next ACK or data packet is received from remote (ie bottleneck now not dropping every remote sent packets): WHEREUPON we keeps sending single window size restoring packet every 100 ms until ANY NEXT PACKET RECEIVED (ie even if worst case all the window restore packets dropped, 300 ms later the process will repeat, again ensuring window ‘pausing’ followed by window restore attempts).

Note: we increment the advertised receiver window size successively, because the remote may have used up the earlier available receiver advertised window size BUT the sent packet/s were dropped never reaching receiver. Making sure remote never re-enter slow start ie CWND=1 due to normal RTO, we have achieved very big webpage download time reductions. Note fast retransmit does not cause slow start, 3 DUP ACKs only halves the remote's existing CWND
The above algorithm could be further simplified without needing to send receiver window size update to ‘pause’ the other end's TCP, as follows:
1. whenever receiving TCP packet from remote sender, check Source Address and Port if already in table of per flow TCPs ELSE create new per flow TCP TCB with various parameters: (NO NEED TO MAINTAIN EARLIER SEQ NO/TIME SENT TABLE ENTRIES FOR ALL INTERCEPTED PACKETS)
latest packet RECEIVED LOCAL SYSTEM TIME (received from remote sender, pure ACK or regular data packet), latest receiver packet's ACK Number ie next expected Seq Number expected from remote sender (sent by local MSTCP to remote sender, requires per flow incoming and outgoing packets inspections, and we now should be able to immediately removes the per flow TCP table entry upon FIN/FIN ACK not just waiting for usual 120 seconds inactivity) . . . etc
   (optional) Upon Sync/Sync ACK completed, immediately set remote sender's CWND to eg 8K. This is preferable done via eg 15 immediate DUP ACKs with ACKNo=remote sender's initial SeqNo+1, Divisional ACKs may not work well as some TCPs increment CWND only by the number of bytes ACKed instead and Optimistic ACK behaviour may not be identical in all TCPs.

Note: alternative we would wait for the 1st data packet received from remote sender to then generate eg 15 DUP ACKs with ACKNo set to the same just received SeqNo from remote sender (at just 1 byte unnecessary retransmission expense), or using Divisional ACKs.

TCP uses a three-way handshaking procedure to set-up a connection. A connection is set up by the initiating side sending a segment with the SYN flag set and the proposed initial sequence number in the sequence number field (seq=X). The remote then returns a segment with both the SYN and ACK flags set with the sequence number field set to its own assigned value for the reverse direction (seq=Y) and acknowledge field of X+1 (ack=X+1). On receipt of this, the initiating side makes a note of Y and returns a segment with just the ACK flag set and an acknowledgement field of Y+1.

2. If 300 ms expires without receiving next packet then:
==>we just need to within software detect next expected Seq No not arriving within eg 300 ms of previous last received packet to generate 3 DUP ACKs with ACK No set to the non-arriving next expected Seq:

keeps sending the same 3 DUP ACKs if eg 100 ms elapsed without receiving any pure ACK or regular data packet, BUT if any ACK or any regular data packet next received at all THEN repeat above eg 300 ms expiration detection loop at very start of step 2 above.

(This ensures SCENARIO A causing pending remote MSTCP RTO timeout re-entering slow start is AVERTED, replacing the pending RTO by DUP ACKs fast retransmit/recovery event. IF there really wasn't any packets sent at all, it doesn't really matter that we unnecessarily sent 3 DUP ACKs with ACK Number=next expected Seq Number.

SCENARIO B is taken care of by keeping sending same 3 DUP ACKs every looms, UNTIL a next ACK or data packet is received from remote (ie bottleneck now not dropping every remote sent packets): WHEREUPON we keeps sending single window size restoring packet every 100 ms until ANY NEXT PACKET RECEIVED (ie even if worst case all the window restore packets dropped, 300 ms later the process will repeat, again ensuring window ‘pausing’ followed by window restore attempts)

The above very simplified algorithm is derived from various other similar algorithms here:
1. Receiver based objective is to make remote sender source TCP which has not implemented the modifications to behave like ‘mirror image’ sender based as far as is possible (but there are some slight differences which needs workarounds eg Receiver based has no way of knowing if sender source TCP has already transmitted the non-arriving next expected SeqNo data segment . . . etc): sender based ‘pauses’ when regular data packet's ACK is late BUT allows 1 regular data packet per pause-interval to be forwarded as probe, when MSTCP timeout retransmit (detected by Seq No=<recorded last sent Seq No then ‘spoof’ ACKs to MSTCP for interval ACKTimeout to bring CWND up to previous level prior to RTO. We now get a simplified barebone version up first, to enhance subsequently.
2. Regular Data packet probe method is straightforward enough, using Seq No/Sent Time main event list and retransmission event list. Needs to ensure Timestamp option negotiated during SYNC/SYNC ACK, by modifying intercepted SYNC/SYNC ACK packets and/or PC registry setting
3. when arriving OTTest>current recorded OTTest(min)+300 ms, this signals congestion buffer delays (OTTest(min) is our latest best estimate of uncongested OTT from remote sender to us)==>send window update of 1800 bytes to allow 1 regular 1500 bytes ethernet packet to be received and also several small pure ACKs.
4. Keeps sending the same window update of 1800 bytes incremented by 1800 bytes if OTTest(min) elapsed without receiving a regular data packet or pure ACK with arriving OTTest>current recorded OTTest(min)+300 ms (so for each OTTest(min) that elapsed, remote can forward a single new regular data packet as probe). IF at anytime an arriving ontime OTTest=<current recorded OTTest(min)+300 ms, THEN immediately send window update restoring previous receiver window size, ie remote now resumes previous regular sending rate.

(Note: this attempts to prevent packet drops by throttling rates so remote never needs to slow start again, but being external Internet does not really work well! hence paragraph 4 above should be replaced by paragraph 4 below which simply now concentrate on restoring remote sending rates as fast as possible upon packet loss event, ie we no longer care if packet drops causes slow start at remote IF we can restore remote sending rates immediately similar to sender based ‘spoofing’ upon detecting retransmitted packet)
4. Remote sender packet ‘pending’ retransmissions is detected whenever arriving Seq No>next expected Seq No AND 300 ms now elapsed without the missing gap Seq No/s packet being received (ie can now safely assumed the gap packet had been lost, and remote sender would now have retransmit with slow start pending on expiration of RFC's 1 sec minimum ceiling)==>BUT our MSTCP would already on its own generate 3 DUP ACK upon receiving 3 out of order Seq No packets causing remote to fast retransmit without entering slow start again (if remote sender just happened to have only 2 out of order Seq No to transmit and nothing, this shouldn't disrupt things as we can simply allow remote to slow start since remote is not sending much at this time)==>we just need to detect next expected Seq No not arriving within 300 ms of previous received packet to generate 3 DUP ACKs with ACK No set to the non-arriving expected Seq No.

(Note SACK could be useful reducing occurrences of DUP ACKs, Divisional ACK, DUP ACKs, Optimistic ACK useful to restore remote sending rates similar to sender based ‘ACKs spoofing’, see http://www-2.cs.cmu.edu/˜kgao/course/network.pdf and http://www-2.cs.cmu.edu/˜kgao/course/network.pdf and Google Search term ‘Ack spoofing’) attach here a (sample only) algorithm for receiver based method:
1. subnet user inputs, only monitor TCP flows to-from subnets specified;
2. TCP flows involving external source/destination will be monitored differently;
   2.1 External source (ie customised TCP acts as Receiver based flow controller);
   select Timestamp option for these flows during connection establishment (can modify Sync packet ? or may need to set the PC registry so all flows in paragraphs 1, 2 above also lumped with timestamp ? Window server 2003 only allows timestamp option if initiated by remote TCP!?);
   check incoming packet of this TCP for remote sender TSVal, record this as OTTest(max) and also OTTest(min) for the very 1st packet received (present receiver system time−TSVal). OTTest stands for one way trip time estimate, ie the max and min OTT observed so far. OTTest(max) and OTTest(min) is updated from every subsequent packets received.
   If incoming packet's OTTest−OTTest(min)>eg 100 ms (user input parameter), THEN remote sender should ‘pause’, customised TCP generate 1 byte garbage (or no data) segment window size advertisement packet of eg 50 bytes (not necessarily 0, to allow remote sender TCP to reply/pure ACK), with Seq No set to receiver's last sent sequence no OR last received ACK No−1 (in case receiver does not send data segments to remote sender at ball thus there is no receiver's last sent Seq No).
   Receiver continues sending same generated window advertisement packet (but the Seq No or last received ACK No−1 may have changed), UNTIL there is a reply confirmation received to one of these ‘replicated packet window update’ packets thus signifying at least one of these window update packets has been received at sender and its reply confirmation now arrived (could be lost in either direction), and whose OTTest−OTTest(min) must be <eg 100 ms (we do not cease ‘pause’ until no congestions).
   The ‘pause’ may also be ceased upon any other packets eg regular data packets arriving within OTTest(min)+100 ms. Where upon receiver sends same window update packet but with window size field set to the value immediately prior to the ‘pause’ (this value is recorded prior to effecting eg 50 bytes advertisement.
   2.2 Remote destination (ie customised TCP acts as sender based)
   Timestamp option is not necessary but useful to know the one way delay back to better determine cause of RTT<timeout (could be caused by reverse path congestion)
   upon MSTCP originating packet/s with Seq No<last Seq No sent (packet drops retransmission), MSTCP would enter slow start again: customised TCP would now spoof ‘ACKs’ back to MSTCP for every packets originated by MSTCP for a period of eg 100 ms. This would bring the congestion window back up to eg TCP window size. Any subsequent forwarded buffered packets drops could be fast retransmitted via receiver's 3 DUP ACKs received (where upon customised TCP may again spoof ACKs back).

Our Algorithm:

1. whenever receiving TCP packet, check Source Address and Port if already in table of per flow TCPs ELSE create new per flow TCP TCB with various parameters: (NO NEED TO MAINTAIN EARLIER SEQ NO/TIME SENT TABLE ENTRIES FOR ALL INTERCEPTED PACKETS)
latest packet RECEIVED LOCAL SYSTEM TIME (pure ACK or regular data packet), latest receiver packet's advertised window size,
latest receiver packet's ACK Number ie next expected Seq Number (requires per flow incoming and outgoing packets inspections, and we
now should be able to immediately removes the per flow TCP table entry upon FIN/FIN ACK not just waiting for 120 seconds)

2. If 300 ms expires without receiving next packet then:
==>we just need to within software detect next expected Seq No not arriving within 300 ms of previous last received packet to generate 3 DUP ACKs with ACK No set to the non-arriving next expected Seq No, AND at the same time to convey window update of 1800 bytes within the 3 DUP ACKs (equiv to sender's ‘pause’+1 packet): here we should expect the 3 DUP ACKs to again be return ACKed by remote, keeps sending the same 3 DUP ACKs window update of 1800 bytes incremented by 1800 bytes each time if eg 100 ms elapsed without receiving return ACKs, BUT if any return ACK or any regular data packet next received at all (regardless of OTT time) THEN send 3 DUP ACKs window update restoring previous window size

(This ensures SCENARIO A causing pending remote MSTCP RTO timeout re-entering slow start is AVERTED, replacing the pending RTO by DUP ACKs fast retransmit/recovery event. IF there really wasn't any packets sent at all, it doesn't really matter that we unnecessarily sent 3 DUP ACKs with ACK Number=next expected Seq Number.

SCENARIO B is taken care of by keeping sending same 3 DUP ACKs every 100 ms, UNTIL ‘ACKing the ACK’ is received., or a next regular data packet is received (ie bottleneck now not dropping every remote sent packets): WHEREUPON we keeps sending 3 DUP ACKs restoring advertised window size every 100 ms until ‘ACKing the ACK received.

As an alternative to sending 3 DUP ACKs for next expected Seq No segment, we could set the ACK No field in the 3 DUP ACKs to next expected Seq No−1 instead (at the expense of only 1 extra byte retransmitted) IN WHICH CASE WE DEFINITELY NEEDS SETTING SEQ NO FIELD USING ROTATIONAL next expected Seq No−100, −99, −98 . . . −1.

But see http://www.cs.rutgers.edu/˜muthu/wtcp.pdf where it is suggested TCP will in this case retransmit ‘beginning from the lowest unacked packets or the first unsent packet in current congestion window’.

Hope this gets closer to a specification, the software still remains ‘passive passthru’ not altering any received and sent packets. Remote MSTCP will now not ever RTO re-entering slow start.

For single PC shareware, we don't need any probes nor timestamp feature at all (paragraph 2): window updates can simply repeats every 100 ms (instead of 3*OTTest(min) in paragraph 4) UNTIL receiving any pure ACK or regular data packet (receive time does not matter). Here when our flow drops packet, we know the other flows' MSTCP traversing the same bottleneck where packet is dropped would RTO rates at around the same time as our own MSTCP==>we can safely restore remote sender's CWND:

1. objective is to make remote behaves like ‘mirror image’ sender based as far as is possible: sender based ‘pauses’ when regular data packet's ACK is late BUT allows 1 regular data packet per pause-interval to be forwarded as probe, when MSTCP timeout retransmit (detected by Seq No=<recorded last sent Seq No then ‘spoof’ ACKs to MSTCP for ACKTimeout interval to bring CWND up to previous level prior to RTO. We should now get a simplified mirrored barebone receiver based version up first, to enhance subsequently (eg SACK gap packets feature could be useful).

2. Regular Data packet probe method is straightforward enough, using Seq No/Sent Time main event list and retransmission event list. Needs to ensure Timestamp option negotiated during SYNC/SYNC ACK, by modifying intercepted SYNC/SYNC ACK packets and/or PC registry setting

[NO LONGER REQUIRED IN SIMPLIFIED ALGORITHM 3. when arriving OTTest>current recorded OTTest(min)+300 ms, this signals congestion buffer delays (OTTest(min) is our latest best estimate of uncongested OTT from remote sender to us)==>send window update of 1800 bytes to allow 1 regular 1500 bytes ethernet packet to be received and also several small pure ACKs.]

[NO LONGER REQUIRED IN SIMPLIFIED ALGORITHM 4. Keeps sending the same window update of 1800 bytes incremented by 1800 bytes if OTTest(min) elapsed without receiving a regular data packet or pure ACK with arriving OTTest>current recorded OTTest(min)+300 ms (so for each OTTest(min) that elapsed, remote can forward a single new regular data packet as probe). IF at anytime an arriving ontime OTTest=<current recorded OTTest(min)+300 ms, THEN immediately send window update restoring previous receiver window size, ie remote now resumes previous regular sending rate.]

(Note: this attempts to prevent packet drops by throttling rates so remote never needs to slow start again, but being external Internet does not really work well! VERY HARD TO KNOW OTTest JUST BEFORE PACKET DROPS hence paragraph 4 above should be replaced by paragraph 4 below which simply now concentrate on restoring remote sending rates as fast as possible, upon packet loss event, ie we no longer care if packet drops causes slow start at remote IF we can restore remote sending rates immediately similar to sender based ‘spoofing’ upon detecting retransmitted packet).

4. Remote sender packet ‘pending’ retransmissions is detected by software whenever arriving Seq No>next expected Seq No AND 300 ms now elapsed without the missing gap Seq No/s packet being received (ie can now safely assumed the gap packet had been lost, and remote sender would now have retransmit with slow start pending on expiration of RFC's 1 sec minimum ceiling)==>BUT our MSTCP would already on its own generate 3 DUP ACK upon receiving 3 out of order Seq No packets causing remote to fast retransmit with/without entering slow start again (if remote sender just happened to have only 2 out of order Seq No to transmit and nothing, this shouldn't disrupt things as we can simply allow remote to slow start since remote is not sending much at this time)==>we just need to within software detect next expected Seq No not arriving within 300 ms of previous last received packet to generate 3 DUP ACKs with ACK No set to the non-arriving next expected Seq No, AND at the same time to convey window update of 1800 bytes within the 3 DUP ACKs (equiv to sender's ‘pause’+1 packet): here we should expect the 3 DUP ACKs to again be return ACKed by remote, keeps sending the same 3 DUP ACKs window update of 1800 bytes incremented by 1800 bytes each time if eg 3*OTTest(min) elapsed without receiving return ACKs, BUT if any return ACK or any regular data packet next received at all (regardless of OTT time) THEN send 3 DUP ACKs window update restoring previous window size.

(HERE WE ONLY DETECT PACKET DROP EARLY TO UPDATE RECEIVER WINDOW SIZE, equiv to sender based ‘pause’+1 packet).

5. The actual DUP ACKs causing remote to fast retransmit is all handled by MSTCP itself. Software needs only detect intercepted MSTCP's 2 additional DUP ACKs (altogether 3 if including the earlier regularly ACKed) to THEN immediately restore remote CWND via Divisional ACK/DUP ACK/Optimistic ACK techniques, see http://arstechnica.com/reviews/2q00/networking/networking-3.html and http://www.usenix.org/events/usits99/summaries/.

(HERE WE DOING SIMILAR TO SENDER BASED ‘SPOOF’ ACKs upon MSTCP sending 2 additional DUP ACKs)

Note: SCENARIO B is taken care of by keeping sending same 3 DUP ACKs every 100 ms, UNTIL ‘ACKing the ACK’ is received., or a next regular data packet is received (ie bottleneck now not dropping every remote sent packets). WHEREUPON we keep sending 3 DUP ACKs restoring advertised window size every 100 ms until ‘ACKing the ACK’ received just in case.

MSTCP always Acks any out of order ACK (ie ACK which acknowledges segments which has yet to be sent), otherwise would need to include Seq No field in the 3 DUP ACKs where the ACK No field all set to same next expected Seq Number (NOTE: DUP Seq Number packet always gets ACKed in RFC!?).

We may want to use previous discussed method of rotational using 100 previous Seq Number fields in the DUP ACKs (ie ‘recorded’ next expected ACK−100) with ACK No field all set to same next expected Seq Number, so the DUP ACKs will now each have different Seq No field set to any of the recorded next expected Seq No−100 (no two DUP ACKs will have same Seq Number).

NOTE: ITS ALSO ASSUMED 3 DUP ACKs for yet unsent Segment doesn't unnecessarily trigger remote MSTCP halving CWND and set SSTHRESH to ½ present CWND (the packet could either have been sent but dropped in which case it will definitely do fast retransmit halving CWND, or not yet sent in which case it may or may not fast retransmit halving CWND unnecessarily) ELSE slight unnecessary performance impairment.

Methods Using Inter-Packet-Arrivals Delay as Congestion Indications
In any of the methods, sub-component methods described earlier in the body description, congestion or packet drops indications could now instead be detected/inferred by modified TCP/modified Monitor Software/modified proxy/modified Port forwarder . . . etc by observing the delay between inter-packet-arrival eg in particular when the ‘elapsed-time-interval’ between immediately successive packets exceed certain user input interval (or derived from some algorithm which may be based on RTTest, OTTest, RTTest(min), OTTest(min) . . . etc) since the last packet received from the remote sending source TCP or the remote receiver TCP (whether pure ACK or regular data packet . . . etc). Note here TCP connection between symmetrical with each end capable of sending and receiving at the same time and one end's sent data segments/data packets and their corresponding return response ACKs from the other end [hereinafter refers to as sub-flow A] may be co-mingled with the other end's independently sent data segments/data packets and their independent corresponding return response ACKs from the other end [hereinafter refers to as sub-flow B]: thus modified TCP/modified Monitor Software/modified proxy/modified Port forwarder . . . etc when observing the delay between inter-packet-arrival above should ‘discern’ and separately observe the inter-packets-arrivals of sub-flow A and/or sub-flow B completely independently→so that when one end's ie sub-flow A's sent data segments/data packets were dropped along the onwards path to the other end thereby their corresponding return response ACKs will not be returned from the other end along the return path, independently the other end's ie sub-flow B's sent data segments/data packets arriving along the return path (if any) will not now cause this end to now mistakenly assume the ‘elapsed time interval’ for independent sub-flow A to not have expired. Modified TCP/modified Monitor Software/modified proxy/modified Port forwarder . . . etc on one end when acting as sender would only observe their own sub-flow A's corresponding return response ACKs stream for inter-packet-arrivals delays for ‘elapsed time interval’ expiration ignoring the other end's independent sub-flow's sent segments/packets. Modified TCP/modified Monitor Software/modified proxy/modified Port forwarder . . . etc on one end when acting as receiver would only observe the other end's own sub-flow B's incoming segments/packets for inter-packet-arrivals delays for ‘elapsed-time-interval’ expiration ignoring this end's own independent sub-flow A's (if any) corresponding arriving returned response ACKs stream. The task should be simple enough: one end when acting as sender based would only needs monitor its own sent packets' corresponding incoming return response ACKs for ‘inter-packets-interval’ delays for ‘elapsed time interval’ expiration, whereas when acting as receiver based would only needs monitor the other end's sent data segments/data packets: further were the other end's independent sub-flow's sent packets continue to arrive, before ‘elapsed time interval’ expiration of this end's independent sub-flow's sent packets' corresponding return response ACKs from the other end whose ‘inter-packets-interval’ delays has now ‘elapsed time interval’ expired, this would provide additional definite indications/definite inference that the one way path from the other end to this end is ‘UP’ and that the one way path from this end to the other end is ‘DOWN’, to react accordingly. This has the advantage of being able to eg specify the ‘elapsed time interval’ much smaller than the RTTest or OTTest or RTTest(min) or OTTest(min) . . . etc, enabling much faster rate response time by being able to detect/infer congestions and/or packet drop and/or physical transmission error events (even uncongested RTT, OTT etc could amount to several hundreds of milliseconds over the Internet and could not be ascertained, or its max bound may not be ascertained in advance, whereas the above elapsed time interval since last receiving a packet could be chosen as small as eg 50 ms instead of the several hundreds of milliseconds).

During eg ftps/http website downloads the regular data packets are transmitted continuously when not interrupted by RTO packet retransmission timeout re-entering slow start with CWND reset to 1 or segment size. Assuming the lowest bandwidth link of the path traversed by packets here to be of the sending source TCP's first miles' eg 500 Kbs DSL, the transmit time delay for a single packet to completely exit onto the DSL transmission media from the sending source would not be an important factor here, being small eg 24 ms for a packet with large 1500 bytes Ethernet size (1500*8/500000=24 ms). Whereas for a last mile 56 Kbs modem dial up, the transmit delay time for a typical 500 bytes packet would take around 71 ms (500*8/56000=71 ms). On the Internet today, the lowest possible bandwidth link along the path traversed by a packet would be 56 Kbs in the worst case scenario. The default packet size is usually about 500 bytes, as is usually negotiated by TCP during connection establishment. The ‘inter-packets-arrivals’ method (and/or ‘Synchronisation’ packets method, see later sections) may begin with ‘elapsed time-interval’ value settings and ‘synchronisation’ interval value settings based on assumptions of 56 Kbs lowest bandwidth link along the path and negotiated largest packet size, then continuous monitor the actual observed latest minimum value of received inter-packet-arrivals interval between regular data packets (or between ACKs for actual data packets sent) to dynamically adjust the ‘elapsed time interval’ value setting and ‘synchronisation’ interval value settings eg if the latest minimum ‘inter-packets-arrivals’ interval is now only 20 ms then ‘elapsed time interval’ value could now be set to eg 80 ms and the ‘synchronisation’ interval value could now be set to eg 40 ms . . . etc or derived based on devised algorithms. The inter-packet spacings when data packets are continuously sent from sending source TCP, and received at receiver TCP, should show the above same inter-packet arrivals spacings centering around 24 ms or 71 ms respectively PLUS a total amount of intervals due to the single packet transmit time delay encountered at each nodes along the path traversed where the node/s uses store and forward switching (instead of cut through switching which would render the single packet transmit time delay encountered at each nodes, cf store and forward), even if the links traversed introduced various delays and/or buffer delays since this will affect the data packets uniformly and they will still arrive at receiver spaced apart centering around above 24 ms or 71 ms respectively, assuming the buffer delays of course does not very suddenly immediately adds on extra eg 200 ms to a following next packet from previous packet (ie the additional buffer delays would continuously gradually be added onto each successive following packets) and no packet is dropped/lost along the route which if so might then add ‘infinite’ delays to this following packet which is dropped/lost from the immediately previous sent packet (we could detect/infer this congestion and/or packet loss and/or physical transmission error events by observing that the inter-packet delay now suddenly exceed certain value eg 100 ms, ie its been 100 ms since the last packet was received ie 100 ms now has elapsed without receiving the immediately following packet ie packet with the correct next expected Sequence Number: However, even if other subsequently following packets may be received within this 100 ms and just this particular immediately following packet was not received, we could if desired similarly regard this as ‘gap’ congestion and/or packet drops and/or physical transmission error events and handle in similar or slightly different manner).

The total amount of intervals due to the single packet transmit time delay encountered at each nodes along the path traversed where the node/s uses store and forward switching (instead of cut through switching which would render the single packet transmit time delay encountered at each nodes, cf store and forward) could vary from few milliseconds if the nodes along the path traversed are of high bandwidth capacity links (even if store and forward switching is implemented instead of cut through switching) to tens or even few hundred milliseconds if the links traversed are of low bandwidth capacities. Eg with 500 Kbs first mile, onto 10 Mbs next link, then 100 Mbs next link, then 10 Mbs next link and finally receiver last mile link of 500 Kbs DSL, the total transmit completion time delays encountered by a single 1500 bytes size packet at each successive stage of the forwarding links with the nodes all implementing store and forward switching cf cut through switching here assuming no congestion buffer delays whatsoever at each of the nodes traversed would be around 24 ms+1.2 ms+0.12 ms+1.2 ms+24 ms=50.52 ms, ie when finally received at destinations the inter-packet-arrivals interval would centre around 50.52 ms between immediately successive packets. Whereas with 56 Kbs first mile modem link, onto 10 Mbs next link, then 100 Mbs next link, then 10 Mbs next link and finally 56 Kbs receiver last mile modem link, the total transmit completion time delays encountered by a single 500 bytes size packet at each successive stage of the forwarding links with the nodes all implementing store and forward switching cf cut through switching here assuming no congestion buffer delays whatsoever at each of the nodes traversed would be around 71 ms+0.4 ms+0.04 ms+0.4 ms+71 ms=142.84 ms, ie when finally received at destinations the inter-packet-arrivals interval would centre around 50.52 ms between immediately successive packets. Any congestion buffer delays, which increases the time it actually takes for a packet to finally arrive from source to destinations and may cause a much later sent packet (ie not immediately successive next packet to the referenced earlier sent packet eg spanning several seconds or tens of seconds) to take, for example, 300 ms longer than the much earlier referenced sent packet to actually arrive at destination receiver caused by the cumulative congestion buffer delays encountered at the nodes traversed, BUT since between any two immediately successive next sent packet and the immediately previous sent packet the ‘extra’ increased cumulative congestion buffer delays encountered by the immediately successive next packet compared to its immediately previous sent packet's could be only, for example, 3 ms, ie., several magnitude order very much less than above eg 300 ms as between two distant sent packets spanning several seconds apart (assuming the congestion level is increasing here, the same reasonings similarly applies where the congestion level is decreasing). This ‘extra’ additional congestion buffer delays would be small as between immediately successive next packet and its immediately previous sent packet, would only increases gradually between any subsequent pairs of immediately successive next packet and its immediately previous counterpart. This possible extra small amount of congestion buffer delays as between any subsequent pairs of immediately successive next packet and its immediately previous counterpart, even though small and evenly neutralised where the congestion level stabilises/evenly smoothes out between other subsequent pairs of immediately adjacent later sent pairs, should/could however be factored in when choosing/deriving the elapsed time period value when not receiving next/immediately next packet from sender source TCP to detect/infer congestions and/or packet drops and/or physical transmission error events. On very rare occasions, however the congestion level could (not impossibly) suddenly builds up eg 200 ms of buffer delays within short period eg 100 ms such as eg when the incoming link is 100 Mbs and the outgoing link is only 10 Mbs . . . etc, in which case we may here conveniently include the scenario to cater for the elapsed time interval to detect/infer this very rare very sudden congestion buffer delay event, in addition to the congestion and/or packet drops and/or physical transmission error events. Note as between any later subsequent further sent pairs of immediately successive next packet and its immediately previous counterpart, this sudden very rare congestion level build up would by now no longer cause the ‘elapsed time interval’ to expire being evenly neutralised upon the sudden congestion build up stabilises/evenly smoothes out between other subsequent further sent pairs of immediately adjacent later sent pairs.

Note a TCP connection is full duplex ie each of the both ends of the connection could be sending and receiving acting as sender source TCP and receiver TCP at the same time. Even if only one end of the connection is doing almost all or all of the sending of regular data packets eg ftp file downloads/http webpage download . . . etc the receiving end TCP would always be sending back Acknowledgements in response to regular data packets received back towards the end TCP doing almost all or all of the regular data packets sending. Hence the ‘elapsed time interval’ methods outlined in above foregoing paragraphs similarly applies to the end TCP doing almost all or all of the regular data packets sending, in that upon ‘elapsed time interval’ expired without receiving pure ACK packets and/or piggyback ACK packets from the other end TCP receiving the downloads, the end TCP doing almost all or all of the regular data packets sending could now infer detection of the congestion and/or packet drops and/or physical transmission error and/or ‘very rare’ very sudden’ congestion level built-up events, and react accordingly. Here however when the receiver end TCP implements Delayed Acknowledgement (ACK generated upon every other packet or 200 ms expirations, whichever occurs first) and this Delayed ACK option is activated for a particular per flow TCP connection, in setting of ‘elapsed time interval’ value chosen or derived algorithmically considerations should be given to include the possible additional 200 ms delay introduced by the Delayed ACK mechanism eg in Delayed ACK cases the ‘elapsed time interval’ should have 200 ms added to it, or optionally instead of adding 200 ms to ‘elapsed time interval’ to instead include this encountered worst case 200 ms delay event to be among the various events inferable/detected upon ‘elapsed time interval’ expiration. This event would be rare and occurring such as eg when there is a slack in sender source TCP sending of packets to the receiver end TCP, thus would not impact much on throughput performances due to worst case Delayed ACK scenario.
Upon detecting/inferring the events above when the ‘elapsed time interval’ expires without receiving next packet (NOTE here we needn't even require any information nor need the use of RTT, OTT . . . etc at all optionally nor RTO calculations based on historical RTT values (in its place actual packet retransmission timeout could be triggered eg upon certain user input value or derived from algorithms based on eg historical inter-packet-arrivals interval values . . . etc) such requirements may optionally be removed from modified TCPs being redundant surplus to requirement now), the modified TCP/modified Software Monitor/modified proxy/modified IP Forwarder/modified firewall . . . etc may then proceed with existing coupled actual packet retransmissions simultaneous with CWND decrease/rates decrease, and/or modified decoupled CWND decrease/rates decrease only without accompanied by actual packet retransmissions, and/or various modified ‘pause’ methods with or without accompanying CWND decrease/rates decrease . . . etc as described in earlier methods/sub-component methods in the body descriptions. Once the above processes were triggered upon ‘inter-packets-interval delays’ ‘elapsed time interval’ expired, when subsequently upon an arriving packet that next arrives from the same sub-flow from the sending source TCP the triggered processes could now be terminated either immediately or optionally after certain defined interval, and the CWND size/rates limit be optionally restored to previous values prior to the ‘elapsed time interval’ expires, and/or optionally the ‘pause’ in progress be ‘unpaused’ . . . etc. The arrival of this packet now signifies that the path from sender source TCP to the receiver TCP is now not totally congestion dropping all and every packet/s: optionally we may further requires that this arriving packet if regular data must be the very next expected packet with the correct next expected Sequence Number and/or if pure ACK packet should have its Sequence Number field last received valid Sequence Number received from sender source TCP to receiver TCP (or the latest largest valid Acknowledgement Number sent from receiver TCP to the sender source TCP−1).

Similarly the modified TCP/modified Software Monitor/modified proxy/modified IP Forwarder/modified firewall . . . etc may OPTIONALL and/OR FURTHER also then proceed with causing the other end TCP doing existing coupled actual packet retransmissions simultaneous with CWND decrease/rates decrease, and/or modified decoupled CWND decrease/rates decrease only without accompanied by actual packet retransmissions, and/or various modified ‘pause’ methods with or without accompanying CWND decrease/rates decrease . . . etc as described in earlier methods/sub-component methods in the body descriptions. OR the modified TCP/modified Software Monitor/modified proxy/modified IP Forwarder/modified firewall . . . etc may OPTIONALL and/OR FURTHER also then ONLY proceed with causing the other end TCP (without causing local TCP to do so at all! such feature would be useful eg when the other end TCP doing almost all or all of the regular data packets sending being existing unmodified standard TCP) doing existing coupled actual packet retransmissions simultaneous with CWND decrease/rates decrease, and/or modified decoupled CWND decrease/rates decrease only without accompanied by actual packet retransmissions, and/or various modified ‘pause’ methods with or without accompanying CWND decrease/rates decrease . . . etc as described in earlier methods/sub-component methods in the body descriptions. Once the above processes were triggered upon ‘elapsed time interval’ expired, when upon an arriving packet that arrives from the same sub-flow from the other end TCP the above triggered processes could now be terminated either immediately or optionally after certain defined interval, and the CWND size/rates limit be optionally restored to previous values prior to the ‘elapsed time interval’ expires, and/or optionally the ‘pause’ in progress be ‘unpaused’ . . . etc. Its not readily possible to cause the other end TCP, if the other end TCP being existing unmodified TCP or not already specifically modified to allow such mechanism, for remote TCP/remote applications/remote processes to alter the other end TCP's internal CWND size/transmit rates directly via some protocol commands. However its readily possible to cause the other end TCP, even if the other end TCP being existing unmodified TCP or not already specifically modified to allow such mechanism, to cause the other end TCP to ‘pause’ and/or ‘unpause’ and/or ‘pause but allows a defined maximum number of bytes/packets to be transmitted . . . etc as outlined in various earlier Methods/sub-component Methods in the body descriptions eg sending receiver window size update packet of ‘0’ bytes and/or ‘1600 bytes’ . . . etc to cause various ‘pause’ at the other end TCP, sending receiver window size update packet of previous size prior to the ‘triggered’ event to ‘unpause’/restore normal operations of the other end TCP . . . etc., (see also earlier section on Implementing TCP modifications to work over external Internet).

Independently, and/or optionally, in addition to the foregoing various methods, for example, ‘elapsed time interval’ methods, existing or earlier described TCPs/Monitor Software/TCP proxy/IP forwarder/Firewall . . . etc may be modified/further modified to ensure each of the both modified ends of a TCP connection automatically generate ‘synchronizing’ data packets to the other modified end (or just the one modified end of a TCP connection automatically generate ‘synchronising’ data packets to the other unmodified or modified end) ensuring that where required there is always 1 packet send towards the other end's modified TCP at least every ‘synchronising’ interval period (such as eg half of ‘elapsed time interval’ chosen value, or the packets' traversed path's lowest bandwidth link's transmit time delay for a single packet to completely exit onto the transmission media multiplicant, whichever is the larger: note the ‘elapsed time interval’ value here should always be greater than the above ‘synchronisation’ value) eg by generating ‘synchronizing’ packet and to send to the other end's TCP whenever ‘synchronisation’ interval expired without any single packet of the same sub-flow being sent towards the other end's TCP. Thus, if both ends were modified and each sending ‘synchronisation’ packets to the other modified end, each end of both modified ends' TCPs would immediately know/infer/detect the one-way path from the other end to local end TCP is encountering congestions and/or packet drops and/or physical transmission error and/or very rare very sudden congestion level build-up event (BUT not including rare 200 ms Delayed ACK event here: Further if only one of both ends were modified and sending ‘synchronisation’ packets to the other unmodified end's TCP eg in the form of DUP Sequence Number packet outside of normal window which elicits return response ACKs back from the other unmodified end's TCP, the local modified end's TCP would only be able to immediately know/infer/detect that either of, but not knowing which one definitely, the forwarding or returning paths between local modified end TCP and the other unmodified end TCP is encountering congestions and/or packet drops and/or physical transmission error and/or very rare very sudden congestion level build-up event BUT not including rare 200 ms Delayed ACK event here), when a sub-flow's ‘elapsed time interval’ expired and no packet of any type from the same sub-flow (including the sub-flow's generated ‘synchronisation’ packet type) is being received from the other end's TCP. This additional definite detection/definite inference of the one way path from one end to the other end, and/or the other end to this end, is definitely ‘UP’ or definitely ‘DOWN’ at this time would be useful to better react accordingly. This may or may not be practicably usefully utilized, noting that were the return one way path happens to be ‘DOWN’, there is no way to know if the onwards one-way path is ‘UP’ or ‘DOWN’ at all. Note also any missing ‘gap’ packets lost/dropped but which didn't cause inter-packet-arrivals (of the physically arriving packets) delays ‘elapsed time period’ to expire, eg due to other later out-of-order physically arriving packet arrives within the ‘elapsed time interval ’, would normally be taken care of via usual 3 DUP ACKs fast retransmit mechanism alternatively the inter-packet-arrivals delays ‘elapsed time interval’ mechanism may instead strictly insists any missing ‘gap’ packets should trigger ‘elapsed time out’ expiration if not received within ‘elapsed time interval’ of the arrival time of its immediate in-order predecessor sent packet (such as ordered by packet's Sequence Number . . . ) . . . etc

When upon a sub-flow's inter-packets-arrivals delays ‘elapsed time interval’ expired and no packet of any type from the same sub-flow (BUT excluding the sub-flow's generated ‘synchronisation’ packet type, or where applicable the sub-flow's corresponding return response ACKs) happening local end modified TCP may either immediately trigger and cause local end's modified TCP (and/or optionally also ‘remotely’ cause the other end's TCP) doing existing coupled actual packet retransmissions simultaneous with CWND decrease/rates decrease, and/or modified decoupled CWND decrease/rates decrease only without accompanied by actual packet retransmissions, and/or various modified ‘pause’ methods with or without accompanying CWND decrease/rates decrease . . . etc as described in earlier methods/sub-component methods in the body descriptions, OR to do so only after a further certain period eg 250 ms (user input value or some derived value based on algorithm including factors such as RTTest, OTTest, RTTest(min), OTTest(max) . . . etc) has passed since the last/latest packet of any type from the same sub-flow (BUT excluding the sub-flow's generated ‘synchronisation’ packet type, or where applicable the sub-flow's corresponding return response ACKs) was received from the other end's modified TCP (and without a subsequent new intervening arriving packet of any type from the same sub-flow (BUT excluding the sub-flow's generated ‘synchronisation’ packet type, or where applicable the sub-flow's corresponding return response ACKs) being received from the other end's modified TCP during this eg 250 ms time) . . . etc and/or a whole current effective window's worth of packets of the same sub-flow had been sent and yet none of the packets has been Acknowledged back.

Where both ends implement ‘inter-packets-arrivals’ method and ‘synchronisation’ packets method, the ‘synchronisation’ packets sent to the other modified end's TCP could simply be in the form of a generated packet with same source IP address Port number and same destination IP address and Port number as the particular per flow TCP connection, together with suitable Identifications uniquely identifying such packets as ‘synchronisation’ packets: such as eg special fixed length unique identification in the data field portion or ‘padding’ field portion inserted eg containing source IP address Port Number and/or destination IP address Port number, without requiring to elicit the other receiving modified end's TCP to generate returning response ACKs . . . etc. Were only one of the end's being modified and the other end being unmodified (BUT also applicable even where both ends are modified), the ‘synchronisation’ packet when sent by the modified end towards the other unmodified end would need to be in the form of a packet which elicits return response ACKs from the receiving unmodified end such as eg a generated packet with same source IP address Port number and same destination IP address and Port number as the particular per flow TCP connection together with a Duplicated Sequence Number field value not within Window which elicits a return response ACK from the receiving unmodified end (such as sending eg out of order Seq No packet not within window which receiving TCP always generate a ‘do nothing’ return ACK see Internet newsgroup topic ‘Acking out of Order packet’ http://groups-beta.google.com/group/comp.protocols.tcp-ip [symbol] 1 Phil Karn Mar. 2, 1988 2 CERF Mar. 2, 1988 . . . , and Google Search term ‘ACKing the ACK’, note also sending single DUP ACK will not cause fast retransmit. Or alternatively such as sending eg out of order ACK see Google Search term ‘out of order ACK’, ‘eliciting an ACK’, DUP Sequence Number ACK’, ‘ACK for unsent data’, ‘unexpected ACK’ . . . etc). The elicited returned response ACK from the other unmodified end would simply has its ACK field value set to be the Next Expected Seq Number to be received by the other unmodified end from the modified end, upon receiving this return response ACK the modified end would just discard and ignore this returned response ACK since the Next Expected Sequence Number data segment has yet to be sent. In the very rare ‘once in a blue moon’ scenario where this Next Expected Sequence Number data segment was actually sent just the very moment before receiving the returned response ACK, the modified end would now only ‘unnecessarily’ fast retransmit upon and after receiving 3 return response DUP ACKs all with the very same ACK Number, which is again also very very unlike since the data segment actually sent just the very moment before receiving the initial returned response ACK and/or subsequent following data segments sent would now increment the other unmodified end's Next Expected Sequence Number making the next return response ACK now carrying a different larger incremented ACK Number field value.

The above immediately preceding paragraphs described scenarios mainly where both ends' TCPs implement sending of ‘synchronizing’ packets to the other end's TCP. This enables each end's TCP to be able to definitely ascertain/definitely infer the one-way path from the other end's TCP to local end's TCP is congested and/or packet drops and/or physical transmission errors and/or very rare very sudden congestion level build-up (but 200 ms Delayed ACK mechanism will not be the cause now, since ‘synchronising’ packets mechanism is implemented here) whenever ‘elapsed time interval’ expires without receiving any packet of the same sub-flow (including generated ‘synchronisation’ packets for the same sub-flow) from the other end's TCP. More complete combination scenarios includes the following (assume both ends' modified TCPs further includes ‘synchronizing’ packets method):
1. when ‘elapsed time interval’ expires at local end's modified TCP without receiving any packet of the same sub-flow (including both the sub-flow's generated ‘synchronisation’ packet type) from the other end's modified TCP→definitely knows/definitely inferred the one-way path from the other end's modified TCP to local end's modified TCP is ‘DOWN’→local end's modified TCP should now immediately react accordingly and/or cause the other end's modified TCP to react accordingly.
2. when the one-way path from the other end's modified TCP to local end's modified TCP is ‘UP’ ie successive packets (and/or ‘synchronizing’ packets) are received from the other end's modified TCP without causing ‘elapsed time interval’ to expire, AND IF expected Acknowledgements (for data packets sent by local end's modified TCP) are not received back from the other end's modified TCP within certain criteria (such as decoupled rates decrement timeout, coupled RTO packets retransmission timeout, decoupled ACKtimeout causing ‘pause’ . . . etc) THEN local end's modified TCP should now immediately react accordingly and/or cause the other end's modified TCP to react accordingly with the definite knowledge/definite inference that the one-way path from the local end's modified TCP to the other end's modified TCP is ‘DOWN’

Where only one end of a TCP connection implements ‘synchronous’ packets method, the foregoings could be adapted in this situation by having the end's modified TCP which implements ‘synchronous’ packets method sending out the ‘synchronous’ packets to the other end's unmodified TCP in the form of ‘packets’ which traditionally elicits an Acknowledgement response from the other end's unmodified TCP (such as sending eg out of order Seq No packet not within window which receiving TCP always generate a ‘do nothing’ return ACK see Internet newsgroup topic ‘Acking out of Order packet’ http://qroups-beta.google.com/qroup/comp.protocols.tcp-ip [symbol] 1 Phil Karn Mar. 2, 1988 2 CERF Mar. 2, 1988 . . . , and Google Search term ‘ACKing the ACK’, note also sending single DUP ACK will not cause fast retransmit. Or alternatively such as sending eg out of order ACK see Google Search term ‘out of order ACK’, ‘eliciting an ACK’, DUP Sequence Number ACK’, ‘ACK for unsent data’, ‘unexpected ACK, etc.).

‘Synchronisation’ packet method should ensure there would be at least a ‘packet’ sent from local end modified TCP to the other end's TCP (whether modified or not) at intervals smaller than ‘elapsed time interval’ value (such as eg half the ‘elapsed time interval’ value . . . etc). Where both ends implement ‘synchronisation’ packets method both the modified TCP protocols could preferably allows detection of presence of each others, agreement of synchronization ‘intervals parameters . . . etc eg during TCP connection phase or immediately thereafter . . . etc. But here upon not receiving any packet from the other end's unmodified TCP within ‘elapsed time interval’ expiration, local end's modified TCP could only definitely infer that either of the one-way paths (but not definitely which of the from local end's modified TCP to the other end's unmodified TCP or from the other end's unmodified TCP to the local end's modified TCP is ‘DOWN’ (cf when both ends are modified and implement ‘synchronisation’ packet techniques).

Various methods/sub-component methods illustrated in earlier body descriptions could be adapted to using ‘elapsed time interval’ method and/or ‘synchronization’ packets method eg instead of decoupled rates decrement upon ACKTimeout (ie instead of monitoring Acknowledgement for Seq No segment sent not received within eg uncongested RTT*multiplicant to react accordingly, the ‘elapsed time interval’ for any next packet received is monitored instead). This allows for much faster reaction time (‘elapsed time interval’) than the possibly much larger uncongested RTT*multiplicant.

Where timestamp option being selected, this would enable both of one-way paths latencies (ie OTTest and OTTest(min) . . . etc be derived instead of just RTTest and RTTest(min) . . . etc) to react better accordingly. SACK option would enable less unnecessary retransmissions of packets which had already been received out-of-order. The ‘synchronization’ packets and/or earlier periodic probe packets method could if required be sent independently in form of new TCP connection established between the per TCP flow/s with destination IP address and Port, source IP address unchanged but source Port now assigned a different unused Port number.

Note: the ‘inter-packets-arrivals’ (and/or optionally) ‘synchronization’ packets method within each per flow TCP can be made operational upon certain criteria/events being fulfilled, to settle in the per flow TCP, such as eg only after the initial Sync/Sync ACKs and/or only after a small number n of successive packets being received from the other end's TCP (modified or unmodified) and/or only after a small number m of successive packets being received from the other end's TCP which all arrives within ‘elapsed time interval’ of each other's immediately preceding previous packet. When the ‘synchronisation’ interval expired requiring ‘synchronization’ packet to be sent, the local end's modified TCP could instead re-send/re-transmit yet unacknowledged previously sent regular data packet/s to the other end's TCP (which would also elicit an Acknowledgement response back from the other end's TCP) in the place of pure ‘synchronization’ packet.

Note the Method/s here extend our modifications/inventions to also be applicable where either one of the source sender or receiver (or both) resides at external Internet, BUT could also be applied where both resides within Internet subsets/WAN/LAN/proprietary Internet as in various earlier described Methods in the description body.

User interface may be provided in the various earlier described modified TCPs/modified Monitor Software/modified TCP forwarder/modified IP forwarder/modified firewall in the description body, to allow user inputs of various TCP tuning/registry parameters (eg initial ssthresh, initial RTT, MTU, MSS, Delay ACK option, SACK option, Timestamp option . . . etc), user inputs of proprietary LAN/WAN subnet IP addresses (so that packet traffics with both source and destinations within these subnets could be ascertained as ‘internal traffics’ cf to/from external Internet) and the ACKTimeout and/or ‘elapsed time interval’ and/or ‘pause-interval’ and/or ‘synchronisation’ interval between each and every of these subnet addresses (for better performance, instead of using just eg the maximum ACKtimeout value such as eg=maximum uncongested RTT between the most distant pair of nodes within the whole subnet*multiplicant), user inputs of common TCP ports (so packet traffics to/from such common ports could be handled differently) and/or additional used TCP ports and/or either of source or destination ports to be excluded from such special handlings (eg some multimedia streams uses TCP with specified port numbers instead of UDP), etc.

Here are some examples instances in some scenarios, in outlines only, among various many possibilities of combinations of methods/sub-component methods described in the body description and/or inter-packet-arrival methods and/or ‘synchronisation’ packets method (where only one end of the TCP connection is modified, were both ends modified this will obviously makes the tasks much easier after both ends detected each other's modification presence):

1. local end modified TCP, acting as sender source to external Internet, and TCP stack is directly modified

Upon the ‘trigger’ event (such as eg 300 ms ‘elapsed time interval’, 3DUP ACKs, RTO actual packets retransmission timeout . . . etc), among other possibilities this would only require the TCP itself to only ‘pause’ (or not even paused at all) for a defined pause-interval and/or allowing a small number of packets transmission during pause to act as probes, then either resume (or continue without the pause) without altering CWND/rates limit or reduce CWND/rates limit by x % eg 5%, 10%, 50% . . . etc.

Note here if ‘pausing’ implemented on eg 300 ms ‘inter-packet-arrivals’ expiration, Sender based modifications has the advantage here of knowing whether the eg 300 ms ‘inter-packet-arrivals’ expiration was solely due to the fact that local end Sender has no data packets to transmit to the other end thus would not need to unnecessarily ‘pause’ and/or react accordingly unnecessarily (cf where the local end acts as receiver it would have no way of knowing whether the eg 300 ms ‘inter-packet-arrivals’ expiration was due to ‘trigger’ events or simply because the other end's Sender has no further data packets to transmit temporarily).

Inter-packets-arrival methods could be used in place ‘uncongested RTT*multiplicant’ methods as trigger events to react accordingly, further if ‘synchronisation’ packets method (here only generated from local end modified sending sourceTCP but eliciting responses such as eg returning ACKs from the other end's unmodified TCP) and/or timestamp options were incorporated would enable definite detection/definite inference of which direction's link is definitely ‘DOWN’ or definitely ‘UP’:

2. local end modified TCP, acting as sender source to external Internet, and TCP stack could not be directly modified.

Modified Software Monitor/modified TCP proxy/modified Firewall . . . etc here would need to perform the tasks instead of TCP stack itself. Upon the ‘trigger’ event (such as eg 300 ms ‘elapsed time interval’, 3DUP ACKs, RTO actual packets retransmission timeout . . . etc), among other possibilities this would only require the modified Software Monitor/modified TCP proxy/modified Firewall . . . etc here to only ‘pause’ intercepted TCP packets forwarding for a defined pause-interval and/or allowing a small number of packets transmission during pause to act as probes, then when resuming eg ‘spoof’ a fixed number of ACK to all arriving intercepted outgoing TCP packets (to quickly restore TCP's CWND/rates limit which might eg have been reset to 1 segment size on re-entering ‘slow start’), and/or even eg handle all fast retransmit 3 DUP ACKS/RTO timeout actual packet retransmissions within the modified Software Monitor/modified TCP proxy/modified Firewall . . . etc (instead of TCP itself, which would now not ever be required to retransmit any sent packets) by keeping actual copies of window's worth of transmitted data suppressing all fast retransmit DUP ACK packets by not forwarding such DUP pure ACKs to TCP and/or removing the ACK bit in piggybacked DUP ACK packets recomputing checksum before forwarding to TCP and/or ‘spoof’ ACKs to TCP just before TCP would have RTO timeout . . . etc) . . . etc. Note here if ‘pausing’ implemented on eg 300 ms ‘inter-packet-arrivals’ expiration, Sender based modifications has the advantage here of knowing whether the eg 300 ms ‘inter-packet-arrivals’ expiration was solely due to the fact that local end Sender has no data packets to transmit to the other end thus would not need to unnecessarily ‘pause’ and/or react accordingly unnecessarily (cf where the local end acts as receiver it would have no way of knowing whether the eg 300 ms ‘inter-packet-arrivals’ expiration was due to ‘trigger’ events or simply because the other end's Sender has no further data packets to transmit temporarily).

Inter-packets-arrival methods could be used in place ‘uncongested RTT*multiplicant’ methods as trigger events to react accordingly, further if ‘synchronisation’ packets method (here only generated from local end modified softwares but eliciting responses such as eg returning ACKs from the other end's unmodified TCP) and/or timestamp options were incorporated would enable definite detection/definite inference of which direction's link is definitely ‘DOWN’ or definitely ‘UP’:

3. local end modified TCP, acting as receiver from external Internet sender source, and TCP stack is directly modified

Inter-packets-arrival methods could be used in place ‘uncongested RTT*multiplicant’ methods as trigger events to react accordingly, further if ‘synchronisation’ packets method (here only generated from local end modified receiver TCP but eliciting responses such as eg returning ACKs from the other end's unmodified TCP) and/or timestamp options were incorporated would enable definite detection/definite inference of which direction's link is definitely ‘DOWN’ or definitely ‘UP’. Further techniques such as Divisional ACKs/DUP ACKs/Optimistic ACKs could be used to increment the other end's unmodified sending source TCP's CWND/transmit rates whenever required, and window size update packet techniques could be used to cause the other end's unmodified sending source TCP to ‘pause’ . . . etc.

4. local end modified TCP, acting as receiver from external Internet sender source, and TCP stack could not be directly Modified.

Modified Software Monitor/modified TCP proxy/modified Firewall . . . etc here would need to perform the tasks instead of TCP stack itself. Upon the ‘trigger’ event (such as eg 300 ms ‘elapsed time interval’ of the particular sub-flow), among other possibilities this would only require the modified Software Monitor/modified TCP proxy/modified Firewall . . . etc here to only remotely cause the other end's sender TCP to ‘pause’ the particular sub-flow's packets forwarding for a defined pause-interval and/or allowing a small number of packets transmission during pause to act as probes, then when resuming eg quickly send a fixed number of DUP ACKs to the other end's sender TCP (to quickly restore the other end's TCP's CWND/rates limit which might eg have been reset to 1 segment size on re-entering ‘slow start’. Inter-packets-arrival methods could be used in place ‘uncongested RTT*multiplicant’ methods as trigger events to react accordingly, further if ‘synchronisation’ packets method (here only generated from local end modified receiver TCP but eliciting responses such as eg returning ACKs from the other end's unmodified TCP) and/or timestamp options were incorporated would enable definite detection/definite inference of which direction's link is definitely ‘DOWN’ or definitely ‘UP’. Further techniques such as Divisional ACKs/DUP ACKs/Optimistic ACKs could be used to increment the other end's unmodified sending source TCP's CWND/transmit rates whenever required, and window size update packet techniques could be used to cause the other end's unmodified sending source TCP to ‘pause’ . . . etc.

TCP connection being symmetrical ie a local end may be both sending and receiving data at the same time (even if it is not sending real data at all there is always returning ACKs generated towards the other end), the local end's modified TCP/modified Monitor Software/modified TCP proxy/modified Firewall . . . etc could of course acts as both sender based and receiver based at the same time. Further where both ends are all modified, each end may again acts as both sender based and receiver based at the same time, working together: but preferable and/or alternatively once both ends detected each others' modification presence, they could agree to each work only acting only as sender based only, or each as receiver based only, or only one end will act as both receiver based and sender based with the other end's modified operations disabled. An example of the many possible ways to detect each other's modified presence is eg to send a packet to the other end with special unique fixed length Identification pattern within the ‘padding field’ or fixed length data portion.

Example Methods Derivable from Combination of Various Methods and/or Sub-Component Methods Disclosed in the Description Body

To enable measurements and/or estimations of various One-Way-Trip-Time OTT, OTTest and estimated uncongested OTTest(min) . . . etc would require timestamp option to be negotiated during TCP connection establishment SYNC/SYNC ACK phase. The one-way-trip-time OTT from sending source to receiver for a particular sent segment/packet could be derived by the sender from the returning corresponding ACK's various timestamp fields values. Obviously OTT, OTTest, OTTest(min) values when made available to either sending source or receiver would enable better and more efficient transmissions controls, since RTT, RTTest, RTTest(min) inherently includes the uncertainty elements introduced by the onwards and return paths asymmetry).

(A) Sender Based Monitoring of latest uncongested RTTest(min) and/or latest uncongested OTTest(min) . . . etc to detect onset of packets beginning to be buffered and/or packet loss, in proprietary networks such as LAN/WAN/proprietary Internet

In proprietary networks, all that is needed to enable guaranteed service capability is to have each and every PCs/Servers . . . etc in the proprietary network (or just a substantial number of the heavy traffic sources) install any of the earlier described modified TCP upgrades or Monitor Software (or the applications software residing on the PCs/Servers . . . etc implement the modifications directly within the applications eg directly within RTSP streaming applications) . . . etc.

Were each and every inter-subnets' uncongested RTT values or uncongested OTT values known before hand within the proprietary network (note the uncongested RTT values or uncongested OTT values could vary for data packets of different sizes especially where the media links' are of low bandwidths such as ISDNs, most TCP packets size are pre-negotiated during the TCP connection establishment phase: commonly negotiated Maximum Segment Size MSS values being around 800 bytes, 1500 bytes . . . etc), each of the modified TCP upgrades or Monitor Softwares . . . etc here could simply throttle back transmit rates of the individual per TCP flows (via ‘pause’ periods, or via CWND window size percentage decrements . . . etc) when eg the particular source-destination flow's uncongested RTT or uncongested OTT time period+specified time period B elapsed without receiving back a corresponding ACK for particular sent packet/s. Time period B here corresponds to the total packet buffers delay cumulative introduced and experienced by the packet while being buffered at various node's along the path traversed: setting this value to small period of eg 20 ms here would ensure other real time critical VoIP/VideoConference UDP packets' enjoyed very good guaranteed service level, since UDP packets here would not likely encounter very much more than 20 ms cumulative total buffers delay along the various nodes traversed. Setting B=0 here would ensure that TCP flows would always attempt to immediately avoid any onset of packets buffering delay, keeping the network free of buffer-delays or only very insignificant buffer-delays during the occasional intervals when they do occasionally occur. The TCP rates throttle decrement percentage could be set to various fixed values or algorithmic derived to various dynamic values for an example such as (B ms+eg T ms)/1000 ms and if with B=50 ms and T=50 ms the rates decrement percentage here would be 10% ie the TCP transmit rates will now be throttle back to 90% of existing transmit rate→it can now be seen that the bottleneck link's throughput level would thereafter now be maintained around steady 90% of the bottleneck link's bandwidth capacity assuming the flows traversing the bottleneck link do not now further increment or decrement their transmit rates at all thereafter. Other possible non-exhaustive examples of the TCP rates throttle decrement percentage algorithmic derived values could be simply eg B ms/uncongested RTT value of the per TCP flow and with B=50 ms uncongested RTT=400 ms the rates decrement percentage here would be 12.5%. The time period T ms was earlier added/could also be added here so that with the larger rates decrement percentage the flows traversing the bottleneck link (incrementing their transmit rates as is usual with TCPs) would now take longer time to again reach 100% link throughput levels or more to then requires buffering which would then impact slightly on other realtime critical guaranteed service UDP packets.

The modified TCP upgrades or Monitor Software . . . etc may whenever required effect the per TCDP flow/s rates throttle via CWND percentage decrement and/or via ‘pauses’ in such manner . . . etc so as achieve required desired bottleneck link's throughputs (eg to subsequently cause 100%, 99%, 95%, 85% . . . etc bottleneck links bandwidths utilizations, instead of present over 100% utilization level with accompanying packets buffering delay) subsequent to various specified ‘trigger event/s’ (eg cumulative total buffered delay of B ms encountered . . . etc). Various algorithms and policies and procedures may further be devised to handle all kinds of ‘trigger events’ in various different manners.

It is here noted that the modified TCP upgrades or Monitor Software . . . etc do not necessarily require prior knowledge of the inter-subnets' uncongested RTTs nor the inter-subnet's uncongested OTTs between various subnets within the proprietary network. Instead here the modified TCP upgrades or Monitor Software . . . etc could keep tracks of the current latest observed smallest RTT value or current latest observed smallest OTT value of the individual per TCP flows, and treat this as dynamically equivalent to uncongested RTT or uncongested OTT of the individual per TCP flows. Common sense lower and upper limits on these RTTest(min) or OTTest(min): eg their max upper ceiling limits could be set to known most distant location pairs' RTTmax value within the proprietary network . . . etc.

(A1) Receiver Based Monitoring of latest uncongested RTTest(min) and/or latest uncongested OTTest(min) . . . etc to detect onset of packets beginning to be buffered and/or packet loss, in proprietary networks such as LAN/WAN/proprietary Internet

(This is straight forward enough from earlier receiver based methods/sub-component methods and various methods/sub-component methods described in sections here and in the various parts of the Description Body, using remote ACK Divisions/multiple DUP ACKs/Optimistic ACKs, and window size updates of various sizes to cause ‘pause/s’, and eliciting ‘do-nothing’ ACK responses via replicated packets method, 3 DUP ACKs to trigger fast retransmit to pre-empts RTO retransmissions, and . . . etc)

(B) Sender Based Monitoring of latest uncongested RTTest(min) and/or latest uncongested OTTest(min) . . . etc to detect onset of packets beginning to be buffered and/or packet loss, in proprietary networks such as LAN/WAN/proprietary Internet and/or external Internet

The external Internet is subject to other existing unmodified TCP flows not within control as in proprietary network. The example/s in (A) above would need be further modified to take this into considerations.

The ‘trigger events’ to cause rates throttle decrements via CWND percentage decrements and/or ‘pause/s’ . . . etc here needs be further modified, eg not incrementing for specified or dynamically algorithmic derived s seconds after fallback to eg 100%/99%/95%/85% . . . etc, IF again bottleneck link's throughput utilization subsequently reaches back to 100% or more causing onset of packets buffering delay within the above s seconds, then allows transmit rates to begin increments/growths again UNTIL ‘trigger event/s’ (which could be packet drops/buffering delays threshold exceeded . . . etc), ELSE start allowing transmit rates increments/growths after s seconds elapsed. Various algorithms and policies and procedures may further be devised to handle all kinds of ‘trigger events’ in various different manners.

Here over external Internet where uncongested RTT and/or uncongested OTT would not be readily known before hand for newly established per TCP flows, hence current latest observed RTTest(min) or OTTest(min) would instead provide dynamic estimation equivalent of the uncongested RTT and/or OTT values.

Existing standard TCPs emphasize fair-shares and friendliness of competing TCP flows, but inefficient in full utilization of available bandwidths for maximum throughputs as is evidenced in the very long period required to re-attain previous established transmit rate/throughput after even just a single packet drop RTO timeout or after 3 DUP ACKs Fast Retransmission especially over long distance fat pipes with high bandwidth and long RTT latency (due mainly to existing TCPs conservative linear CWND increments in Congestion avoidance mode after attaining Ssthresh CWND size during Slow Start's exponential CWND growth). A new improved criteria for modified TCP should now include high utilizations of available bandwidth and/or available buffers for maximum TCP throughputs, NOT just inefficient slow very friendly fair sharing. Very fast reaction time (instead of existing RFC's default minimum lower ceiling value of 1 second for dynamically derived RTO value) of the modified TCPs here to ‘pause’ and/or reducing CWND upon various ‘trigger events’ would minimizes packet drops percentage, earlier described ‘continuous pause’ would further very flexibly reduces transmit rates decrements sizes ie from eg 64 Kbytes per RTT to just 40 bytes per eg 300 ms).

Modified TCPs here could be made more aggressive in CWND increment sizes (and/or equivalent ‘pause’ interval, ‘continuous pause’ interval settings eg to be of smaller values) in many various different ways. CWND could be incremented eg a specified integer multiple or dynamically derived integer multiple of MSS per ACK received and/or per RTT instead of existing RFC's 1 MSS per ACK received and/or per RTT, Ssthresh value could be initialized to specified value and/or permanently fixed to very large value such as to be the same as the Maximum Window Size negotiated during TCP connection phase . . . etc. While effecting rates decrements upon ‘trigger events’ (such as packet drop/s coupled/decoupled RTO timeout, 3DUP ACKs fast retransmit, decoupled rates decrements upon ACKs returning outside tightly set specified interval . . . etc) modified TCPs could strive to decrement rates in such a way that ensuing bottleneck link/s utilization would be maintained at high throughputs eg 100%/99%/95%/85% . . . or even at various above 100% congestive buffering delay levels etc (assuming all TCPs traversing the path were all modified TCPs).

As an illustration among various many possibilities, modified TCPs (at either sender or receiver or both) here would be in possession of prior knowledge of uncongested source-receiver-source RTT or uncongested source-receiver OTT value, or dynamic best estimation RTTest(min)/OTTest(min) equivalent of the above: when all the links traversed each does not exceed their respective 100% available bandwidths (ie no packet buffering occurs at any of the nodes traversed), the RTT or OTT or RTTest(min) or OTTest(min) values derived from eg the returning ACKs will now be the same as the real actual uncongested RTT or uncongested OTT value (with very small random variances introduced by nodes processing delays/source or receiver hosts processing delays . . . etc, hereinafter refers to as V ms: this value V ms variances would usually be magnitude order smaller than other earlier described system parameters such as specified or dynamically derived B ms . . . etc. Were V ms to unexpected on very rare occasions briefly become very large eg Window OS are not real time OS, this could be ‘exceptionally’ treated in the same manner as arising/introduced/occasioned by nodes buffering delays encountered instead). So long as the RTT or OTT or RTTest(min) or OTTest(min) values derived from eg the returning ACKs continues to show no buffering delays encountered along the path/s traversed modified TCP could either continue to conservatively allow increments/growth of transmit rates as in existing RFC or to increment/grow more aggressively. Upon exceeding certain level/s of buffering delay indicated/derived from returning ACKs ie the value in milliseconds of [(returning RTT or OTT)−(RTTest(min) or OTTest(min))] would now indicate the cumulative total buffering delay/s encountered at various nodes along the path/s traversed (hereinafter refers to as C ms)
Eg upon 20 ms/50 ms/100 ms . . . etc of the value of C being exceeded, modified TCPs could now eg reduce transmit rates so that the bottleneck/s' link utilization thereafter would be maintained at eg 100%/99%/95%/85% . . . etc assuming all TCPs traversing the bottleneck link/s are all modified TCPs (now knowing the latest estimation equivalent value of the actual uncongested RTT or uncongested OTT of the per TCP flows, and value of C, the required CWND decrement percentage and/or ‘pauses’ intervals or sequences of appropriate required ‘pauses’ could now be ascertained to achieve the required desired end results). Modified TCP now could eg stop any further rates increments/growth of the TCP flows for a period s seconds (specified or dynamically algorithm derived) as eg described earlier to then respond accordingly as eg described earlier or in various different manners further devised. This particular example has the effect of achieving high utilization throughputs in addition to existing RFC's friendly fair-sharing, and also helps keeps cumulative buffering delays of the traversed path/s maintained at low level correlated to C value: in the absence of other strong dominant unmodified TCP flows, in which case modified TCP flows here would/may start allowing rates increments/growth within seconds, to then together with all other unmodified TCP flows eventually cause packet drops event: whereupon unmodified TCP flows would re-enter ‘Slow Start’ taking very long time to re-attain previous achieved transmit rates whereas modified TCP flows could retain arbitrary high proportion of previous achieved transmit rates/throughputs (solving the existing responsiveness problems associated especially with long RTT long distance fat pipes). With modified TCPs rates decrements to achieve eg subsequent 95% bottleneck link/s utilization, new TCP flow/s (and/or other new UDP flow/s . . . etc) would always be able to immediately utilize up to 5% of available bottleneck link/s bandwidths to begin flow rates increments/growth without introducing packets buffering delay/s along the route, further the bottleneck link/s would be able to immediately accommodate new additional sudden instantaneous traffics surge of X milliseconds equivalent of available bandwidths without dropping packets (most Internet nodes commonly has between 300 ms-500 ms equivalent buffer sizes): this is consistent with common wisdom of preserving existing flows' established throughputs while allowing gradual controlled new additional flows' growths.

Alternatively, modified TCP could always allow rates increments/growth conservatively as in existing RFC's linear growth or more aggressively (instead of throttling back upon IC ms of cumulative total buffering delays detected . . . etc), and only throttle back accordingly upon packet drops ‘events: this would only be in the interest of maximizing TCP flows’ throughputs and not good for other real time critical UDP flows BUT the nodes traversed could easily ensure very good guaranteed service performances of real time critical UDP packets by simply reserving a guaranteed minimum percentage of the available physical bandwidths for UDP packets priority forwarding . . . etc.

Website servers/servers farm could advantageously implement above described modified TCP implementations. Typical websites are often optimized to be of around 30 Kbytes-60 Kbytes for speedy downloads (for an analog 56K modem downloading at around 5 Kbytes/sec continuously uninterrupted by packet/s drops . . . etc this will still take around 6 seconds-12 seconds). Immediately after SYNC/SYNC ACK/ACK TCP connection establishment phase, sending source server's modified TCP would have an initial very first estimation of the uncongested RTT or uncongested OTT of the per TCP flow/s in form of current latest observed minimum source-receiver-source RTTest(min) or source-receiver OTTest(min) value (whether it is representative of the actual uncongested RTT or uncongested OTT value, or not). Sending source server's modified TCP may optionally now immediately begin sending the very 1^{st} data segments/packets starting immediately with CWND window size of W segments eg with negotiated Maximum Segment Size MSS of around 1600 bytes and W=20 it would only take 2*RTT for all 60 Kbytes contents to be received by client web browsers (assuming no packet/s being dropped or corrupted in transmissions and the smallest link's bandwidth along the path being end user's last mile 500 Kbits/sec broadband). With W=64 it could take only 1 RTT or 1 OTT for client web browsers to completely download the website contents of 60 Kbytes (typical Internet RTTs are commonly around several tens to several hundreds of milliseconds, including the delay/s introduced by bufferings along the path/s). Were the smallest link's bandwidths along the path being end user's last mile 56 Kbits/sec analog modem Dial-up the time periods above would have been at least 6 seconds or 12 seconds as the transmissions over the last mile link could only be of maximum around 5 Kbytes per second (assuming the 30 Kbytes or 60 Kbytes worth of segments/packets are first buffered at end user's last mile ISP, at AOL web proxy servers, before being transmitted onwards to end user's webbrowser over the Dial-up). Even if in the very worst case the initial 20 or 64 MSS CWND window's worth of segments/packets were to immediately cause buffer overflows hence the segments/packets were dropped at any bottleneck link/s, modified TCP here could very quickly react accordingly (much much faster than existing RFC's minimum lowest floor default reactions time of 1 second minimum) in manners as described/briefly illustrated in preceding above eg rates decrement to ensure certain levels of subsequent bottleneck link/s utilization/throughput (instead of existing RFC's rates halving and ensuing prolonged periods of bandwidths utilizations), and/or more controlled aggressive subsequent rates increments/growths, and/or more controlled buffer delay levels congestion avoidance (eg ‘wait s seconds before allowing rates increments/growths . . . etc, instead of present existing RFC's only scheme of ‘wait for packet/s drops’) . . . etc.

Note were the modified TCP, or modified TCP for web servers, need be implemented in form of Monitor software/Proxy TCP . . . etc (eg without direct access to host TCP stack source codes for modifications) this would essentially simply requires the Monitor Software/TCP Proxy residing at sending source servers to ‘Spoof ACKs’ whenever required to the resident sending source servers' TCP stack to controlled more aggressively increment CWND window size/transmit rate, and/or to spoof zero or small receiver window size update packet whenever required to the resident sending source server's TCP stack to temporarily halt transmissions or to decrement transmit rates, and/or for Monitor Software to effect equivalent transmission rates decrement via ‘pause’/‘continuous pause’ (and/or allowing 1 or a small number of packets forwarding during each pause intervals) in forwarding onwards of intercepted TCP originated packets, and/or keeping a full window's worth of all actual data segments/packets sent by resident host's TCP stack to then perform all coupled or decoupled RTO retransmission/3DUP ACKs fast retransmissions relieving resident host TCP stack of all such responsibilities, and/or keeping multiple full window's worth of all actual data segments/packets sent by resident host TCP stack thus enabling multiple windows' worth of segments/packets to be generated by resident host TCP stack within a single RTT when Monitor Software does ‘Spoof ACKs’ to resident host TCP stack to effect controlled more aggressive rates increments/growth and/or when utilizing ACK Divisions/multiple DUP ACKs/Optimistic ACKs techniques to do so, and/or examine incoming returning ACK packets from the network and/or examine their RTTs/OTTs to react accordingly including whether to modify various fields (ACK Number, Seq Number, Timestamp values, various flags, advertised window size . . . etc) before forwarding onwards to resident host TCP stack or even discard, and/or . . . etc, as described in various earlier Methods/sub-component methods in the Description Body.

It is here noted that Monitor Software/TCP Proxy . . . etc could even keep the resident host's effective transmit window and/or CWND to be permanently fixed at certain required size or even at maximum negotiated Window Size at all times with the above mentioned combinations of techniques, methods and sub-component methods, leaving the transmission rates be controlled via only ‘pause’/‘continuous ‘pause’ and/or allowing 1 single or a small fixed number of packets to be forwarded during each pause intervals to act as ‘probes’.

(Immediately after the SYNC/SYNC ACK/ACK TCP connection establishment phase, sending source server's modified TCP may instead now immediately begin sending the very 1^{st} data segments/packets starting immediately with existing RFC's Slow Start's CWND window of 1 MSS segment size, but this may take many RTTs now to complete the contents transfer around tens of seconds to minutes as is in end users' typical common daily experience.)

(B1) Receiver Based Monitoring of latest uncongested RTTest(min) and/or latest uncongested OTTest(min) . . . etc to detect onset of packets beginning to be buffered and/or packet loss, in proprietary networks such as LAN/WAN/proprietary Internet and/or external Internet

(This is straight forward enough from earlier receiver based methods/sub-component methods and various methods/sub-component methods described in sections here and in the various parts of the Description Body, using remote ACK Divisions/multiple DUP ACKs/Optimistic ACKs, and/or window size updates of various sizes to cause ‘pause/s’, and/or eliciting ‘do-nothing’ ACK responses via replicated packets method, and/or 3 DUP ACKs to trigger fast retransmit to pre-empts RTO retransmissions, and . . . etc. See earlier section on Implementing TCP modifications to work over external Internet).

As an example, with Timestamp option negotiated during TCP connection establishment phase, receiver modified TCP or Monitor Software could now derive the source-receiver path's estimation equivalent of the actual uncongested one-way-trip-time of arriving packets, ie current latest observed OTTest(min). The cumulative total buffering delays, if any, encountered by any arriving packet could be derived by subtracting arriving packet's OTT by OTTest(min) (ignoring any usually very small random variances introduced by nodes' packets processing/forwarding time fluctuations). It is preferable for Selective Acknowledgement option to be utilized and Delayed Acknowledgement option to be disabled (eg by host PC's TCP/IP registry entries settings, but these are not a strict requirement at all). Modified TCP or Monitor Software would now be in position, now armed with estimation equivalent of uncongested source-receiver path's actual uncongested OTT and buffering delays levels, to react accordingly (remotely cause sending source TCP to pauses' and/or ‘continuous pause’ with 1 single packets forwarding allowed per pause interval, and/or ‘unpause’, and/or increment CWND sizes via Divisional ACKs/multiple DUP ACKs/Optimistic ACKs, and/or pre-empts RTO timeout via early 3 DUP ACKs fast retransmit, and/or . . . etc) as desired to achieve the maximum bandwidth utilization/throughput criteria specified while preserving friendly fair-sharing.

The immediately above example could be further simplified so as to not require any use of Timestamps options at all (ie not needing to derive nor make use of arriving OTT value nor OTTest(min) value nor the derived cumulative total encountered buffering delays value at all: receiver modified TCP or Monitor Software may instead very simply wait specified W milliseconds (eg 250 ms) interval for the next packet to arrive since the arrival time of the latest last received immediately previous packet and if this does not arrive within W milliseconds to then treat this as ‘trigger event’ (most likely the following packet was buffer-overflowed congestion dropped) to then immediately accordingly (remotely cause sending source TCP to ‘pauses’ and/or ‘continuous pause’ with 1 single packets forwarding allowed per pause interval, and/or ‘unpause’, and/or increment CWND sizes via Divisional ACKs/multiple DUP ACKs/Optimistic ACKs, and/or pre-empts RTO timeout via early 3 DUP ACKs fast retransmit, and/or . . . etc) as desired to achieve the maximum bandwidth utilization/throughput criteria specified while preserving friendly fair-sharing (but more aggressive than the immediately above example). It should here be noted that were a packet to encounter 3 buffering delays of eg 300 ms at each of the 3 different nodes A/B/C and subsequent being buffer-overflowed congestion drop at another node D (with eg 400 ms equivalent buffer capacity) along the path, and the ‘pause’ of eg 250 ms at sending source TCP would now not only reduces the buffer congestion level at node D to just 150 ms but also similarly reduces the buffer congestion levels at each of the nodes A/B/C to just 50 ms each. Whereas a specified or algorithmic derived ‘pause’ interval value of 450 ms would certainly totally clear all bufferings completely at each of the nodes A/B/C/D (ie all now totally non congested with no packets being buffered at all). The example immediately above however, armed with knowledge of OTT and OTTest(min) and derived cumulative encountered buffering congestion delays, could react accordingly with finer level of controls depending on knowledge of the above values cf this present further simplified example which could only mainly react after buffer-overflowed packet drops events (note even when all buffers at all nodes (assuming 400 ms equivalent of buffer capacities each) traversed are consistently steadily increasingly to very near but not yet already overflowed, the immediately following packet to the immediately previous received packet will still be arriving within eg 50 ms/100 ms/200 ms/250 ms . . . etc of its immediately preceding packet).

It is preferable to keep tracks of the current latest smallest observed elapsed intervals E(L) for a following next packet of length L=1 to negotiated maximum segment size MSS, arriving since last received packet (of any length), this gives us knowledge/estimation equivalent of the transmit time delay for a single packet of length L to completely exit on the lowest bandwidth link transmission media along the path (eg usually end users last mile 56 Kbs Dial-up or 500 Kbs Broadband, see also pages 192-195 in Description Body). The transmit time delay E(L) is expected to be linearly proportional to the packet's length L. We can now specify W milliseconds such that modified TCP or Monitor Software would only ‘trigger’ events to react accordingly upon eg (W milliseconds+E (L) of packet of length maximum negotiated segment size MSS) elapses without the packet arriving, or to react accordingly upon eg just W milliseconds if assuming E(L) of packet of length maximum negotiated segment size MSS has already been taken into consideration in deriving/specifying the value of W.

As another further simplified example among many, here is described an outline for a very simplified Receiver based modified TCP implemented in Monitor Software utilising inter-packet-arrivals interval techniques (which can be further modified/adapted, and can also be implemented directly within TCP itself instead of Monitor Software) giving better performance over external Internet eg much faster webpage downloads, ftp downloads . . . etc:
1. whenever receiving TCP packet from remote sender, check Source Address and Port if already in table of per flow TCPs ELSE create new per flow TCP TCB with various parameters: (NO NEED TO MAINTAIN EARLIER SEQ NO/TIME SENT TABLE ENTRIES FOR ALL INTERCEPTED PACKETS)
latest packet RECEIVED LOCAL SYSTEM TIME (received from remote sender, pure ACK or regular data packet), latest receiver packet's advertised window size (sent by local MSTCP to remote sender), latest receiver packet's ACK Number ie next expected Seq Number expected from remote sender (sent by local MSTCP to remote sender, requires per flow incoming and outgoing packets inspections, and we now should be able to immediately removes the per flow TCP table entry upon FIN/FIN ACK not just waiting for usual 120 seconds inactivity) . . . etc
   (optional) Upon Sync/Sync ACK completed, immediately set remote sender's CWND to eg 64 Kbytes user specified or dynamically algorithm derived, eg could also set to smaller or larger scaled sizes dependent on end user last mile link's bandwidth capacity. When set to eg 64K (which is the usual default maximum window size negotiated unless window scaling option selected, this could enable remote external Internet website's contents to be downloaded within just a single RTT compared to usual tens of seconds experienced). This is preferable done via eg 15 immediate DUP ACKs with eg ACKNo=remote sender's initial SeqNo+1, Divisional ACKs may not work well as some TCPs increment CWND only by the number of bytes ACKed instead and Optimistic ACK behavior may not be identical in all TCPs.

Note: alternative we would wait for the 1st data packet received from remote sender to then generate eg 15 DUP ACKs with ACKNo set to the same just received SeqNo from remote sender (at just 1 byte unnecessary retransmission expense), or using Divisional ACKs.

TCP uses a three-way handshaking procedure to set-up a connection. A connection is set up by the initiating side sending a segment with the SYN flag set and the proposed initial sequence number in the sequence number field (seq=X). The remote then returns a segment with both the SYN and ACK flags set with the sequence number field set to its own assigned value for the reverse direction (seq=Y) and acknowledge field of X+1(ack=X+1). On receipt of this, the initiating side makes a note of Y and returns a segment with just the ACK flag set and an acknowledgement field of Y+1.

2. If eg 300 ms (user specified or dynamically algorithm derived) expires without receiving next packet then:
==>we just need to within software detect next expected Seq No not arriving within eg 300 ms of previous last received packet to generate 3 DUP ACKs with ACK No set to the non-arriving next expected Seq No, AND at the same time to convey window update of eg 1800 bytes within the 3 DUP ACKs (equiv to sender's ‘pause’+1 packet): keeps sending the same 3 DUP ACKs window update of 1800 bytes incremented by 1800 bytes each time if eg 100 ms elapsed without receiving any pure ACK or regular data packet, BUT if any ACK or any regular data packet next received at all THEN send USUAL (not 3 DUP ACKs) same single window update restoring previous window size (ACKNo field set to ‘; recorded’ latest ‘largest’ ACKNo sent from local MSTCP to remote, or −1) repeatedly every 100 ms until any ACK or regular data packet next received again from remote THEN repeat above eg 300 ms expiration detection loop at very start of Step 2 above (optionally we could first at this point before looping again utilize Divisional ACKs/a fixed number of DUP ACKs/Optimistic ACK techniques here to set sending source CWND size eg to negotiated maximum window size 64 Kbytes/32 Kbytes or eg incrementing sending source CWND size by 16 DUP ACKs . . . etc. Note here we could also send 3 DUP ACKs in place of the single window update packet but after 2 further 100 ms elapsed the single window update ACK packets would have totaled to 3 DUP ACKs window update packets, of course an alternative here could also be any window update packets eg DUP SeqNo window update packet . . . etc.

Various Notes on some sub-component techniques which can be utilized:
Start at 1^{st} received packet after TCP connection establishment SYNC/SYNC ACK, if present observed RTT−current latest recorded RTTest(min) or present observed OTT current latest recorded OTTest(min) is greater than reasonable cumulative total buffering delays (eg caused by temporarily prolonged stop/gap in source packets generation) then ignore such occurrence and do not cause ‘trigger event’. Transmit rates decrement via CWND size percentage reduction eg [(present observed RTT−current latest recorded RTTest(min) or present observed OTT−current latest recorded OTTest(min))+T ms]/present observed RTT or OTT but note here with T=0 ms implies causing subsequent bottleneck link's throughput to be 100% of available bandwidth, and/or pause interval set to [(present observed RTT−current latest recorded RTTest(min) or present observed OTT−current latest recorded OTTest(min))+T ms]

Distinguishing between internal proprietary network's subnets addresses and external Internet to actuate corresponding appropriate Methods/Algorithms.

Inter-packets-arrivals techniques could be adapted for use, likewise ‘Synchronising Packets’ technique.

Bandwidths/links probing techniques eg pathchar/pipechar/pathchirp . . . etc could be deployed in conjunctions to derive finer levels of knowledge of the path/nodes/links traversed, to react accordingly better.

User input external Internet connection speed to allow max Window Size negotiation eg Dial-up to 5 Kbytes BUT ISPs could buffer even 64 Kbytes/sec and forward to user's 56 Kbs Dial-Up at eg 5 Kbytes per sec which would be very convenient eg when traversed path introduced lengthy eg several secs RTT or OTT.

Very fast reaction time to ‘pause’ reduce CWND minimizes packet drops percentage, ‘continuous pause’ further very flexibly reduces transmit rates decrements sizes, ie., from eg 64 Kbytes per RTT to just 40 bytes per eg 300 ms

TCP inherently unfair to high RTT flows, we eliminates this eg utilizing Inter-Packet-Arrivals intervals techniques.

Withholding several ACKs, ie delay slightly in forwarding onwards to sending source, for purpose of reducing sending source TCP's transmit rates/throughputs.

By being able to maintain close to 100% bottleneck link/s' bandwidths capacity utilizations/throughputs all the time, even after buffer-overflowed congestion packet drops and/or physical transmissions errors packet drops, modified TCPs enables approximately double the good throughputs/bottleneck bandwidths utilization compared to existing RFC's TCPs which very much under utilise the link/s' bandwidth capacity (as is very apparent from their AIMD additive-increase-multiplicative decrease ‘saw-tooths’ utilizations/throughputs graphs of existing RFC's TCPs)

Further Notes and Further Methods

Inter-packet-arrival intervals (eg 300 ms) technique could optionally be made active ONLY when less than a full effective window's worth of packets received/sent: otherwise 300 ms may definitely will elapsed without receiving new packet/s eg when OTT or RTT>eg 300 ms (for the returning ACKs to arrive back at sender). May also want to check latest received SeqNo−latest sent ACK number to see if eg > or < or =current effective window size may want to optionally keeps sending 3+DupNum DUP ACKs every eg 500 ms after SYNC/SYNC ACK/ACK (or after 1 or 2 very first received regular data packets . . . ) so remote server doesn't timeout setting CWND and/or SSthresh to 1 or 2 MSS. Sender TCP may or may not want to utilise algorithm during initial 64 Kbytes of data packets transfer if eg the returning ACK for 1st regular data packet sent−returning ACK RTT for SYNC ACK sent>C ms eg 100 ms (due to very sudden increase in congestions level of path traversed).

Refined Specification:

First set registry entries much preferably enabling SACK and disabling Delay Acknowledgement

Command line input parameters:
WaitTimeStamp(ms)—elapsed inter-packets-arrivals interval to infer ‘network congestion drops’
PauseTimeStamp(ms)—remote server pause interval upon ‘congestion’
DupNum—remote server during 3 DUP ACKs fast retransmit phase will further increases CWND size for each additional DUP ACKs received, we use this technique to send a large number DupNum of DUP ACKs to ramp up CWND
Offset—0 or 1, not very sure if the ACKNo field in the DUP ACKs would work if just set to latest updated
dwACKNumber recorded (ie latest largest value of ACKNo sent by receiver MSTCP to remote server) or works
only after subtracting 1 byte

1. Procedure for processing outgoing TCP packets (packets from our MSTCP to remote host)

Create new entry for TCP connection for this packet if necessary. I have to record some variables:
dwACKNumber (If ACK flag is signalled)—ACK field of TCP header
dwSEQNumber—Seq Number field of TCP header
dwTCPState—This TCB variable is for your own use for controlling TCP connection state, anyway you like.

Monitor SYNC/SYNC ACK/ACK to record dwMaxRcvWindowSize in third ACK packet in the sequence SYN/ACK. The per flow TCP is only to be created upon detecting SYNC from our receiver MSTCP sending to remote server (not to create otherwise).

Immediately upon sending the ACK response packet in TCP connection SYNC/SYNC ACK/ACK, even before receiving first data packet (assuming this works to increment remote server's CWND), to then generate 3+DupNum number of DUP ACKs with ACK number=dwACKNumber−Offset (dwACKNumber—is ACK number of third ACK response packet in TCP connection SYNC/SYNC ACK/ACK sequence) and dwMaxRcvWindowSize and dwSEQNumber field values keeps sending 3+DupNum number of DUP ACKs every WaitTimeStamp interval until very first data packet arrives (NOTE: Step 3 only activated after very first data packet arrives in program flows, Step 2 really is immediately active all the time).

2. Monitor incoming packet for FIN or RST from remote sender TCP, and RST from local MSTCP, then immediately terminates the TCP flow, else terminates after sixteen second total inactivity (i.e., no incoming/outgoing packets of any type whatsoever) regardless of any ongoing processes/loop activities.

3. Procedure for checking TCP flows. (NOTE even in midst of sending 3+DupNum DUP ACKs and/or window update packets loop the ACKNo and SeqNo must always reflect the instantaneous latest sent ‘targets’ ACKNo, ‘largest’ so MSTCP retransmission smaller ACKNo is ignored, and latest sent ‘largest’ SeqNo from local receiver's MSTCP).

If connection established and WaitTimeStamp milliseconds expires without receiving next packet from remote host to our MSTCP for any TCP flow, THEN send 3 DUP ACK+DupNum of DUP ACKs one after one in quick succession to advertise window size of zero bytes and with ACK numbers=latest updated dwACKNumber (recorded above) minus Offset and dwSEQNumber field values.

Keeps sending above 3+DupNum of DUP ACKs every 100 ms until any ACK or regular data packet next received again from remote host OR Pause TimeStamp milliseconds now elapsed without receiving a next packet whichever occurs first (NOTE: all pending yet unsent portion of 3+Dup Num DUP ACKs should now immediately stops upon next packet or elapsed PauseTimeStamp) THEN repeatedly keeps sending single pure window size update (with AckNo field set to dwACKNumber-OFFSET, NOT DUP ACKs, etc., and dwSEQNumber field values) of size=dwMaxRcvWindowSize every 50 ms intervals UNTIL a next normal data packet (not pure ACK) arrives again from remote host, whereupon after this we loop again at beginning of Step 3 above (i.e., again wait for WaitTimeStamp without receiving packet from remote host to ‘pause’ remote server, etc.).

Broadband networks (even over international backbone transport are very low loss rate, very low congestions.

Http (port 80 signature) flows should be allowed sending eg 64K bytes whole content in eg 1 RTT. Even if SYNC/SYNC ACK/ACK phase encounters retransmission (RFC default 1 sec) this would only encourage use of initial 64K bytes CWND since flows along bottleneck link now likely halve rates may perhaps want to space out (rates pacing sending one packet per R ms so that 64K bytes gets sent evenly spaced out over 1 sec), thus from inter-returning ACKs-arrival elapsed interval eg 100 or 300 ms etc. (if SeqNo sent and corresponding returning ACK expected and not arriving after elapsed interval should use no delay-ack but could adjust for delay-ack if utilized) to then immediately pause for the detected trigger events (usually packet drops) within RTT+(eg 100 ms or 300 ms) instead of RFC default one second not sending packets unnecessarily if likely to be dropped 64K bytes initial CWND would be a good choice; coping well with both last mile 56K and broadband media physical line rates.

Further from the minimum value of recorded inter-returning ACKs-arrival interval, etc., the last mile media physical line rates (56K, broadband, etc.) could be usefully derived unambiguously.

Receiver may also want to send 3+DupNum DUP ACKs (with ACKNo field set to latest largest recorded sent outgoing ACKNO) whenever detects local MSTCP on its own usual accord sends packets with ACKNo field=<latest recorded largest received SeqNo from remote TCP (i.e., eg ‘gap’ in received SeqNo, etc.), OR when receiving from remote TCP timeout retransmission (eg. returning ACKs or 3+DupNum DUP ACKs sent were lost, etc.) to ramp up remote CWND again (remote CWND now drops back down to 1 or 2 MSS after timeout).

A new way to existing TCP Congestion Control would be to:

1. Sender TCPWindowSize, and Receiver TCPWindowSize initialized to ‘arbitrary’ large value via scaling factor 0-14 like eg 2ˆ30 (1 Gigabyte), eg during TCP connection negotiation using Window Scaling Option (eg 64K+window scale) (scale factor 0=no scaling option required to be set, see RFC 1323).

2. Receiver TCP (or Receiver Monitor Software, etc.) upon SYNC/SYNC ACK, then ACK with window size of eg 4K bytes/16K bytes/64K bytes or W1 Kbytes, etc., upon receiving 4K bytes 16K bytes 64K bytes or any specified number of W1 or fraction of W1 Kbytes to then increase the advertised Receiver Window Size to W2 Kbytes eg N2 (4K bytes 16K bytes or W1 Kbytes etc.) where N2 is a fraction eg 1.5/2.0/3.5/5.0, etc., or algorithmically derived part of and so forth for W3, W4, Wn, etc., until data communications completed (total less than 2ˆ30, i.e., 1 Gbytes).

NOTE: Receiver based Monitor Software, etc., may modify intercepted receiver MSTCP outgoing packets modifying the advertised Receiver Window sizes (before forwarding the modified packet to remote sender TCP), thus achieving the new TCP congestion control method based solely on the continuously incremented Advertised Receiver Window Size.

AND/OR

Sender TCP (or Sender Monitor Software, etc.) upon SYNC then SYNC ACK with window size of eg 4 Kbytes/16 Kbytes/64 Kbytes/or W1 Kbytes, etc., upon receiving returning ACKs acking 4 Kbytes/16 Kbytes/64 Kbytes/or any specified number of W1 or fraction of W1 Kbytes to then increase the Sender Window Size to W2 Kbytes eg N2 (4 Kbytes/16 Kbytes/64 Kbytes or W1 Kbytes, etc.) where N2 is a fraction eg 1.5/2.0/3.5/5.0, etc. or algorithmically derived part of, and so forth, for W3, W4, WN, etc., until data communications completed (total less than 2ˆ30, i.e. 1 Gbytes, if exceeded to perhaps wrap round the Window Size like in eg SeqNo wrap-around, or new TCP connection to continue, etc.).

NOTE: Sender based Monitor Software, etc. may modify intercepted incoming packets from remote receiver modifying the Advertised Receiver Window sizes (before forwarding the modified packet to Sender TCP), thus achieving the new TCP congestion control method based solely on the continuously incremented Advertised Receiver Window Size.

Note also TCP could be symmetric, one end could both be Sender and Receiver, i.e., the above Method then needs be implemented-directional then.

The method would enable arbitrary finer more flexible more variety of control/pacing of packets transmissions, while (if required) preserving (or offered similar corresponding mechanisms) all other existing TCP error control/congestion control mechanisms like slow start/congestion control linear increase/3 DUP ACKs fast retransmit/timeouts, etc.

Instead of earlier method of sending 3+DupNum of DUP ACKs (or Divisional ACKs or Optimistic SACK techniques, etc.) to ramp up CWND (with eg accompanying detriment to SSthresh value on initial fast retransmit, end to end TCP semantics if using Optimistic ACKs, etc.), the same purpose and more could be better accomplished (eg incrementing the advertised window size value by eg 3+Dup Num of DUP ACKs, etc., without the accompanying disadvantages).

Sender's CWND should be initialized to the desired initial value 4 Kbytes/16 Kbytes/64 Kbytes or W Kbytes, etc., or Receiver may eg send 3+DupNum DUP ACKs or a series of such DUP ACKs at various times or Optimistic ACK, etc., to ramp up CWND initially (existing RFC 2414/3390 already allow 4 Kbytes initial CWND value, in which case there is no need to ramp up CWND). Existing servers on Internet at present already set SSthresh to arbitrary large value (eg=TCP Window Size value) which would enable rapid exponential ramp up of CWND value. However, in absence of large SSthresh setting Receiver may send a large number of eg 3+DupNum of DUP ACKs to cause linear ramp up of CWND (eg 1,000 DUP ACKs=40 Kbytes=320 Kbits which could all be sent well under 1 sec with Broadband, to ramp up CWND to 1 Mbytes assuming SMSS of 1 Kbytes or to ramp up CWND to 16 Mbytes if scaled Window factor of 16). Note with scaled Window factor of eg 16, the minimum window size increment resolution would be 16 bytes, i.e., not possible to increment by say 5/8/15, etc. bytes. With continuous incremented advertised Receiver Window Size method, receiver may ‘rates limit’ sender's rate of packets injections without needing sender to send out packets evenly spaced/evenly delayed inter-packets. Note it may be sufficient without Window Scale Factor to fully utilize this Method (eg TCP Window Size of eg 64 Kbytes without scaling option), since the permissible send window ‘enlarges’ with every returning ACKs received, i.e., receiver may continuously increment/decrement/adjust the advertised receiver window size utilizing knowledge of network conditions' trigger events (and/or knowledge of eg the latest valid SeqNo received/latest valid ACKNo sent, etc.). to eg continuously adjust rwnd thus sender's effective window size which is min (cwnd, rwnd, swnd) of eg rend values of 4/16/32/40 Kbytes, etc., when congested network detected via ‘trigger events’ and enlarges rwnd to eg 48/56/64 Kbytes, etc., thus sender's effective window size when network is detected uncongested/under utilized. Note this Method could be utilized on its own or in combination with any other Methods eg ‘pause’ methods. NOTE: Synchronization packets method may carry the continuously adjusted rwnd values.

To implement the Method on receiver only without any modifications on remote server whatsoever (on the initial CWSD, SSthresh value settings), receiver may choose to wait eg a number of seconds or a number of RTT's or a number of packets to have elapsed/received (without intervening sender's RTO timeout and/or receiver fast retransmit request where this occurs receiver may choose to activate the Method straight away even before sender's pending RTO timeout, etc., averting sender's RTO timeout) before activating the Method thus CWND already sufficiently larger and hence any fast retransmit request would maintain sufficiently high SSthresh (=CWND/2 after all packets already in flight before the 3 DUP ACKs fast retransmit request). Where required, or advantageous, as in http website access where whole contents usually, <64 Kbytes, receiver may immediately after SYNC/SYNC ACK/ACK or immediately after 1 or 2 regular data packets received, to then immediately ramp up CWND by Optimistic ACK (with ACKNo=latest valid SeqNo received+eg 4/16/32/64 Kbytes, etc., this will not affect SSthresh), at the same time establish a parallel TCP connection to the same remote IP number and same port number and same source IP number but different specified Port number where immediately after SYNC/SYNC ACK/ACK or immediately after 1 or 2 regular data packets received to OPTIONALLY ramp up send's CWND with 3+DupNum of DUP ACKs so that sender's CWND now=eg 4/16/32/64 Kbytes, etc. (or ramp up only when original TCP's initial data packets were not all received successfully). Were the original connection successfully received all eg 4/16/32/64 Kbytes the second TCP connection could now be immediately terminated via RST reset, OTHERWISE (or simultaneously with the original TCP) any missing initial 4/16/32/64 Kbytes worth of packets/segments could be obtained from the second TCP connection (eg forwarded to the original TCP receiver socket by Modified Software. Modified Software may also, if required record all packets flow in both directions eg authentication packets if any in the original TCP connection during the first 4/16/32/64 Kbytes receptions and script inject the exact same sequence into the second parallel TCP connection during the first 4/16/32/64 Kbytes reception). Note even if CWND initialized to eg max 64 Kbytes here receiver could still pace the sender's injection rates eg starting at 2/4/8 Kbytes, etc., by sending rwnd initially of 2/4/8 Kbytes and increment’ adjusting the rwnd (eg window update packets or regular data packets) according to events.

NOTE: by waiting eg for the 1st regular data packet to be received (or more . . . , or even immediately just after receiving SYNC ACK from sender TCP) to then ramp up sender's CWND by eg 3+DupNum DUP ACKS with ACKNo field set to the largest latest valid SeqNo received instead of usual largest latest valid SeqNo−1 (i.e. withhold ACKing the largest received one byte throughout the TCP session, or optionally) and then utilizing the continuous incrementing advertised receiver window size method (together with sufficiently large window scaling on both ends), we have now successfully bring both ends' TCP transmit rates under total control and preserved TCP semantics (and with ‘pause’ method both ends' TCP could now transmit at full wire speed subject only to ‘pauses’ congestion control i.e. CWND, both ends' TCP Window Sizes, SSthresh . . . etc needs play no further part at some point in time once the TCP flow stabilizes . . . HOWEVER its preferable to use the continuous increment rwnd starting from appropriate smaller values building up to eg full permissible physical wire speed rates or transmission speed permitted by current rwnd size (the flow now grown to be ‘stabilized’ . . . )

Obviously sender's max transmit rates is dependent on min(swnd, cwnd, rwnd)−unacked sent segments (or unacked sent segments decreases the swnd and acked segments increment the swnd, if swnd here is fixed at same initially negotiated window size throughout), and the continuous increment/decrement/adjust RWND Method will consider this in the rwnd updates.

Also now that remote server TCP transmit rates could now be paced by adjusting only the rwnd (remote server's cwnd, ssthresh, swnd now always could be maintained at arbitrary large or very large values), receiver based software could dynamically pace the remote sender's transmit rates via dynamic selection of values of rwnd window updates thus could modify all rwnd field values in all intercepted receiver MSTCP generated packets destined for remote server TCP to the required rwnd values to pace the sender's transmit rates (this would require packet checksum recomputation modification) receiver based software/TCP (which could also be implemented as sender based software/TCP modifications) could advantageously monitor arriving OTT values from timestamp fields, while the OTT values remains same as latest OTTest(min) (or same as prior known actual uncongested OTT) within small allowed variances (eg due to small variances in sender's OS/stack CPU processing time) receiver based software/TCP makes note of the attained latest largest rwnd==>this gives largest rwnd value attained so far during which packet traversing the path does not encounter any buffer delays or cumulative buffer delays of at most the same small allowed variance (and/or plus additional B ms of allowed cumulative buffer delays eg 0 ms/50 ms/100 ms . . . etc) as above==>subsequently whenever packets are congestion dropped receiver based software could advantageously/optimally set rwnd updates values (modified rwnd field values in intercepted packets) to this latest largest recorded rwnd value as defined in the foregoing==>ie upon congestion drop events and/or fast retransmit events . . . etc receiver continues to maintained pace of the sender's transmit rate so that the rate could be maintained at the historical highest rates attained by the flow under uncongested traversed path conditions thus maintaining very ideal high link bandwidths utilisations. Further receiver software/TCP may increment rwnd (whether emulating slow start exponential rwnd growth and/or congestion avoidance linear growth) continuously so long as arriving OTT value does not exceed latest (or actual uncongested OTT) OTTest(min) ie no buffer delays along the path (and/or optionally decrement downwards if arriving OTT exceeded Ottest(min), further but when the arriving OTT value then exceed latest (or known actual uncongested OTT) OTTest(min) by eg specified 10 ms/50 ms/100 ms . . . etc (eg due to other non-modified existing TCP flows incrementing their rates even when packets starts to be buffered, or UDP traffics) receiver based software/TCP may now choose to allow rwnd to be incremented again . . .

Note were all TCP flows along the path (which may also conveniently assigned minimum guaranteed portion of their bandwidth to TCP flows, and certain portion to UDP . . . etc) being such modified TCP mentioned in the immediately foregoing paragraph, such TCPs will always not cause any bufferings to be required==>almost totally uncongested/non-buffered path is maintained all the time. To ensure fair share allowing newly established modified TCPs' growth when pre-existing modified TCPs already together attained full utilisation of the traversed links' whole bandwidth, newly established TCPs may be allowed to grow their transmit rates or rwnd or cwnd until not more than eg 100 ms extra delay in OTTest(min) or RTTest(min) or their known actual values, and all modified TCPs upon experiencing eg >100 ms extra delay would all reduce their transmit rates or rwnd or cwnd . . . etc by certain percentage eg 10%/15%/25% . . . etc (this favour pre-existing established flows but also allows new established TCP to begin attaining their transmit rates growth). Note here there would not be congestion drops as long as all nodes traversed has more than eg 100 ms equiv worth of buffers. Another scheme will be to allow continuous transmit rates or rwnd or cwnd . . . etc growth until onset of packets starts being buffered (indicated by extra delays in OTTest(min) or RTTest(min) of latest OTT or RTT) whereupon their transmit rates or rwnd or cwnd will be decremented backwards one step (thus oscillating incrementing forward and decrementing backwards around the 100% utilisations level).

Note also the above various schemes can similarly easily be implemented as sender based TCPs.

Simply eg allowing transmit rates or rwnd or cwnd growths until congestion drop events (whereupon modified TCPs reverts to their largest attained transmit rates or rwnd or cwnd size under total non-congested conditions or percentage thereof, or simply percentage of present transmit rates or rwnd or cwnd sizes when congestion drops occur . . . etc) enables good co-existence with present RFC standard TCP flows. Where ‘pause’ method is incorporated, the ‘pause’ interval may also be derived from the latest OTT or RTT value just before congestion drops detected and the OTTest(min) or RTTest(min) or known uncongested actual OTT or RTT value: eg if latest OTT just before congestion drops event is 700 ms and OTTest(min) is 200 ms then could now set the ‘required’ pause interval to eg 500 ms (700 ms-200 ms) to just totally clear all the nodes' buffered packets or even more eg 600 ms or less eg 400 ms as required.

An example receiver based implementation, among several possibilities (note sender based would be similar but simpler), would simply be for receiver to request window scale option eg scaling to maximum of 256 MBytes (maximum possible scaling is to 1 Gigabyte, ie 2ˆ14*64 Kbytes or left shift 14 times the usual unscaled 16 bits window size, here maximum 256 Mbytes would be window scale factor of 12 ie 2ˆ12*64 Kbytes or left shift the usual unscaled 16 bits window size: see Google Search term ‘window scale size, http://rdweb.cns.vt.edu/public/notes/win2k-tcpip.htm, http://support.microsoft.com/default.aspx?scid=kb;en-us;199947, http://www.netperf.org/netperf/training/netperf-talk/0207.html, http://www.ncsa.uiuc.edu/People/vwelch/net_perf/tcp_windows.html http://www.monkev.org/openbsd/archive/bugs/0007/msg00022.html, http://www.freesoft.org/CIE/RFC/1072/4.htm, http://www.freesoft.org/CIE/RFC/1323/5.htm, http://www.networksorcery.com/enp/protocol/tcp/option003.htm, http://www.ehsco.com/reading/19990628ncw1.html, Google Group Search term window scale size, http://rdweb.cns.vt.edu/public/notes/win2k-tcpip.htm) gives minimum possible resolution of 4 Kbytes receiver window size (4 Kbytes incidentally corresponds to experimental RFC's initial CWND value):

1. remote server may correspondingly choose a scaled sender window size, however it may also simply allow receiver to scale but to choose not to scale its own sender's window size: this doesn't matter much (even if such negotiated window size/s are far too big for the last mile and/or first mile physical bandwidths eg 56K/500 Kbs . . . etc).

Note: If sender does similar window scaling factor as receiver, this could enable very simple ready usage of this method, without any new software or modified TCP required, by eg simply setting the receiver PC's TCPWindowSize registry value to eg 1 and eg scale factor of eg 2ˆ14 (minimum window size resolution now being approx 4 Kbytes) thus the sender's effective transmit window will at all times be limited to approx 4 Kbytes since receiver would now only ever sets its rwnd to at most 4 Kbytes at all times (whereas with receiver PC's registry setting or application socket buffer's setting of TCPWindowSize registry value of 2 and scaled factor of 14 this gives resolution of approx 16 Kbytes*2 ie 32 Kbytes)

2. receiver then where required modifies all intercepted outgoing packets ensuring each of their receiver window size field at all time does not exceed a suitable upper ceiling value eg 16 Kbytes for 56K receiver last mile's dial-up or eg 96 Kbytes for 500 kbs receiver's last mile DSL . . . etc

[the simple very elegant arrangements here would now have ensured very fast exponential sender's CWND growth throughout the whole of the TCP session eg at all times requiring only at most 6 RTTs time instead of requiring eg approx 64 RTTs time to reach CWND of 64K (note sender's initial SSThresh is set very very large to same value as scaled receiver window size) BUT the sender's maximum effective transmit rates at all times would be limited to the received modified receiver's window size upper ceiling's value==>the sender's sending rates at all times is always not more than that allowed by the receiver's window size upper ceiling, further governed by sender's sliding window’ size and the ‘self-clocking’ characteristics through returning ACKs (note the returning ACKs' rates reflects the smallest bottleneck link's available bandwidth, usually at the first or last miles media link). Onset of buffer delays along the path would slow the sender's BDP throughput, whereas limited congestion packet drops will cause receiver to request 3 DUP ACKs fast retransmit which sender's now halved CWND and SSthresh value would most certainly continues to remain very very much larger than receiver's window size upper ceiling value at all times, whereas sustained congestion packets drops will cause sender to timeout RTO retransmit which sender's CWND would now slow-start again at eg 4 MSS but again grows rapidly exponentially==>it can be seen that all such TCP flows' senders' CWND could now be limited to but also maintained almost all the time at near their receivers' window sizes' upper ceiling . . .

3. optionally, the receiver may pace the sender's injection rates of packets into the network by slowly increasing the receiver window size field of outgoing packets eg immediately after TCP establishment receiver may send an evenly spaced and timed series of eg 16 pure window update packets every eg 62.5 ms for eg 1 second starting with 4 Kbytes then 8 Kbytes then 12 Kbytes . . . then 64 Kbytes (instead of advertising 64 Kbytes upper ceiling window size immediately which would cause packets burst) thus ensuring no sudden large packets burst from sender (note returning ACKs if any during this series of window size updates would increase the packets injection rates possible, receiver however may optionally reduce the window update size values taking this into considerations). Receiver may optionally modify outgoing packets' receiver window size field values at any time where appropriate. Similarly such window size update/modifications could be carried in any desired manners of increments/decrements/adjustments at all times, possibly taking into consideration the latest outgoing returning ACKs' values sent . . . etc. This could be useful to fetch http website contents in fastest optimal manner immediately after TCP connection establishment (ie then pacing sender to send at eg receiver's last mile physical maximum line rates possible: note causing sender to immediately burst all eg 64 Kbytes contents in one RTT may be counter-productive . . . )

4. Further optionally, this could be implemented together with ‘pause’ method and/or ‘inter-packets-arrivals’ method and/or various methods described in preceding paragraphs . . . etc.

Eg where the uncongested RTT/OTT here is eg 50 ms, the ‘pause’method may here specify a Timeout period which is uncongested RTT/OTT (or latest estimated uncongested RTT/OTT) value between the two ends plus eg 200 ms of buffer delays, and ‘pause-interval’ upon Timeout of eg 150 ms→the bottleneck link's bandwidth here could be constantly 100% utilized at all times, since the ‘pause’ method here strives to keep the cumulative traversed path's buffers' occupied within a buffer occupancy small range at all times ie bottleneck link could always be 100% utilized.

Hence it is noted that sender's CWND mechanism here would be redundant to requirements in achieving congestion control purposes at some stage (except where other component methods such as Inter-Packet-Arrivals method plus 3+DupNum DUP ACKs to rapidly increment CWND size upon congestion trigger events averting RTO timeout events . . . etc are not incorporated, in which case hence CWND would continue to only play the part of network available bandwidth probings during the very initial stage exponential and/or linear growth to attain very large values (even though the connection's maximum transmit rate is at all times limited to eg comparatively very small rwnd value which the receiver advertises in scaled shifted format eg instead of advertising rwnd value of 64K receiver TCP now advertises only 4 if maximum scaled factor 14 utilised signifying rwnd value of 4 left shifted 12 places ie same as 64K: NOTE even though both ends now permits/negotiated very large maximum scaled window sizes, receiver TCP would only ever be able to advertise its usual physical current latest available maximum receiver window size eg if its physical maximum possible receive window buffer resource is 16K then the advertised receive window size field value in all packets generated by receiver TCP assuming maximum scaled factor of 14 utilised would only show a maximum possible value of 1 at all times), thereafter even halving of CWND and/or SSthresh values upon 3 DUP ACKs fast retransmit/recovery the halved CWND and/or Ssthresh values remain very large compared to rwnd: were network remains uncongested sender could happily keeps transmitting at maximum rates limited only by the available segments/bytes in sliding window (dependent on returning ACKs self-clocking characteristics) and/or rwnd or cwnd size, upon 3 DUP ACKs fast retransmit request sender's maximum transmit rate would now be limited only by the available segments/bytes in sliding window (which the available segments/bytes in sliding window would now appropriately be reduced by the proportions/number of yet unacked sent packets-in-flight, but here even though CWND and SSThresh are both halved they have no impacts whatsoever since the halved CWND and SStresh would still be far larger than RWND or SWND) thus in effect the transmit rate is now appropriately proportionally reduced, upon RTO timeout (usually after RFC's minimum lowest ceiling time period of 1 second) the sender transmit rate ie governed by restart CWND of 1 or several SMSS is now reduced to the minimum but could in fact almost always retains same transmit rate prior to RTO timeout since sender here would typically have sent a very large portion or whole entire effective window's worth of segments/bytes prior to the RTO timeout thus many RTO timeouts immediate transmissions in series will quickly follow in succession caused by the series of following yet unacked sent segments/packets and the size of the proportion/number of such ‘congestion drop’ packets in all the sent unacked segments within the effective sliding window (even if all were congestion dropped) would not reduce the sender's transmit rate after the eg 1 second RTO Timeout event but sender would have stopped any transmission during the eg 1 sec period prior to the RTO Timeout==>all intervening nodes' buffered packets would be cleared of eg 1 sec equivalent amount of this/these particular per modified TCP flows' buffered packets (or equivalent amount of other flows' buffered packets) and also very likely be cleared of eg 1 sec equivalent amount of most other unmodified existing TCP flows' buffered packets (or equivalent amount of other flows' buffered packets) since eg 1 sec equivalent amount far exceeds the nodes' usual buffer equivalent capacity of 200 ms-500 ms and some other TCP flows' whether modified or not could timeouts later at longer than RFC's minimum 1 sec (if their RTTs are unusually very large) helping to ensure total clearing of all the traversed nodes buffered packets (since all flows would RTO timeout even though some could be at slightly later times) [NOTE: this is synonymous to a large ‘pause’ interval of 1 sec].

This method at its simplest requires only users to set their local PCs TCP registry parameters to utilize large window scale factor such as scale factor of eg 12 whereas the 16 bit usual TCPWindowSize value can be set as small or as large as is required eg 1 byte to 64 Kbytes: with user PC scale factor of 12 ie maximum possible scaled window size value of 256 Mbyte and user PC TCPWindowSize value of just 1, and remote server negotiated scale factor of eg 12 and remote server TCPWindowSize of eg 64 Kbytes the remote server maximum transmit rates at any time will not exceed user PC scaled window size of 4 Kbytes (1*2ˆ12) per RTT (assuming intermediate softwares, if any, do not intercept and modify rwnd field values of outgoing packets from user PCs to be larger than 4 Kbytes). Note remote server's Ssthresh value is usually initialized to be same as the rwnd value negotiated during TCP connection establishment. To implement this method at sender remote server requires only the remote server's TCP stack to fix its SStresh values to be arbitrary very large eg to ‘infinity’ and to utilize window scale option for TCP connection negotiations (and/or fix its CWND value to its largest attained growth throughout, ie CWND could continuously increment eg from initial RFC value of 1 SMSS but never be decremented).

It had been noted that utilizing the modified TCP could increase the throughputs and reduce large file ftp transfer completion time, such as eg for data storage site backup applications over leased lines/DSL . . . etc. This is because with existing TCP the sender always increases its transmit rates all the time ie CWND monotonically increases until packets are dropped due to congestions whereupon sender TCP aggressively reduce its transmit rate ie resets CWND to eg 1 SMSS and begins the very long slow climb back up to the attained transmit rate or attained CWND size just before the RTO timeout (or just before receiving 3 DUP ACKs fast retransmit requests whereupon sender's transmit rate ie CWND is halved). Assuming if the TCP flows does not have 3 DUP ACKs fast retransmit mechanism enabled, the flow's transmit rates or throughput or CWND graph here would show the well known ‘saw tooths’ pattern slow linear climbing to maximum then sudden drop back to near ‘0’ repeatedly ie it's immediately apparent that up to half the link's physical available bandwidths are being wasted not utilized, whereas modified TCP flow would exhibit transmit rate or throughput or CWND graph of near constant 100% link's physical available bandwidth utilization ie possibly up to double the throughputs/halved the transfer completion time of unmodified TCP flows. With 3 DUP ACKs fast retransmit mechanism enabled, the TCP flow's graph would show a mixture of sudden dropping to half previous transmit rates level and near ‘0’ thus modified TCP flows would show somewhere between 33%-100% more throughputs compared to unmodified TCP flows→enabled possibly up to instant doubling of the link's ‘apparent’ physical bandwidths, where the link may be leased lines/InterContinental submarine optical cables/satellites/wireless . . . etc.

To recap, the above immediately preceding paragraphs ‘large sender scaled window size’ method (even if the connection at either ends really has no actual need for such large scale window size) could be immediately utilized by PC users without even needing any softwares nor modification to existing standard TCPs: users could manually set their PC's TCP system parameters enabling large scaled sender window size (eg TCPWindowSize and/or maxglobalTCPWindowSize, in Window 2000 setting TCPWindowSize larger than 64 Kbytes would automatically enable window scale factor), TCP1323opt 1 or 3 (1 is window scale factor enabled but without TimeStamp option, 3 is with Timestamp option), Window Scale Factor value between 1 and 2ˆ14. Receiver TCP's should allow sender TCP to negotiate window scale option, but receiver TCP's own receive maximum window size should be kept relatively small preferably so as to just be able to fully utilise the ‘bottleneck link's bandwidth capacity’ of the path traversed by IP packets (the bottleneck link here is usually either the sender's first mile media eg DSL or the receiver’ first mile eg leased line eg assuming the uncongested RTT between the two ends is eg 100 ms and stay constant at this eg 100 ms value throughout, and the bottleneck link's bandwidth capacity is 2 mbs, the receiver maximum window size here should be kept/set relative small to just eg 25.6 Kbytes (This ensures sender TCP's ‘effective window size’ at any time does not exceed 25.6 Kbytes thus would not transmit at rates higher than 2 mbs at any time, even though sender TCP's CWND could grow to quickly attain/far exceed receiver's maximum window size of eg 25.6 Kbytes and subsequent be maintained throughout at very large values allowed by its very large scaled maximum window size value which ensures that packet loss/corruption events causing fast retransmit would not now cause sender TCP's halved CWND size nor halved Sstresh value to dip below the receiver's maximum window size of eg 25.6 Kbytes at almost any time. Whereas after packet loss events causing RTO Timeout retransmit with sender CWND size resets to eg 1 SMSS, very much rarer, sender TCP's CWND could very quickly re-attain and exceed receiver's maximum window size of eg 25.6 Kbytes in just 5*eg 100 ms RTT ie in just 500 ms). The transmit rates graph/instantaneous throughput rates graph (as could be seen using Ethereal's IO-Graphs traffics display analysis facility http://ethereal.com) here would exhibit almost constant closer to 100% link bandwidths utilization ie the graph here would resemble ‘square wave signal form’ with top flat plateaus closer to 100% link utilization level, compared to existing standard TCPs which almost invariably exhibits ‘saw-tooths’ forms with plateaus at the valleys of the saw-tooths much further away from 100% link utilization level.

However, in the real world public Internet, the RTTs between two ends could vary by magnitude order over time (eg from 10's of milliseconds to 200 ms) unless the end to end connection's RTT is guaranteed by carrier's IP transit Service Level Agreement guaranteed RTT/bandwidth, thus it ‘throttling’ sender's transmit rates to the bottleneck link's bandwidth capacity via eg receiver maximum window size . . . etc would suffer magnitude order throughputs and/or ‘goodputs’ degradation during such times when such RTTs over public Internet lengthens: much better to set the receiver's maximum window size here to much larger values to be able to accommodate such lengthening public Internet's RTTs scenarios eg were receiver's maximum window size now be set to eg 8*the earlier eg 25.6 Kbytes then the end-to-end throughputs and/or ‘goodputs’ could be maintained to close to 100% bottleneck link's bandwidth capacity at any time assuming the RTTs does not lengthen to more than 8 times the uncongested RTT

Between the two ends.

It should be noted when sender TCP's CWND is stabilized and non-increasing (eg when CWND has reached the maximum sender window size value) it is the ACKs self-clocking feature that regulates how much sender TCP could transmit (the TCP Sliding Window), ie according to the rates of arriving returning ACKs, and the maximum rate of this returning ACK is in turned limited to the bottleneck link's bandwidth capacity of the traversed path ie how fast data from sender could be forwarded along the bottleneck link and this is approximately equal to bottleneck's bandwidth in bytes per second (if ignoring the eg 40 bytes overhead required for non-data IP packet header). When sender TCP's CWND continues to increment exponentially in ‘Slow-Start’ phase, CWND actually increments according to the number of returning ACKs during each successive RTTs (not necessarily exponential doubling during each successive RTTs) ie if TCP's present CWND is 8 Kbytes and sends out 8 Kbytes (assuming permitted by maximum sender and window sizes, sufficient ‘effective window’ with enough returned ACKs . . . ) of data segments with only 6 returned and 2 dropped in the next RTT then CWND would only now increment to 14 Kbytes (not doubled to 16 Kbytes) assuming in ‘Slow-Start’. Congestions will not arise so long as the now incremented CWND size (thus effective window now increased, not caused by increases in number of returning ACKs received) remains below that which would cause transmit rates to be over that which could be forwarded by the bottleneck link's bandwidth capacity. But if the transmit rates is now bigger than that of the bottleneck link's bandwidth capacity, some transmitted packets will now starts to be buffered at the bottleneck link (Internet nodes usually has approximately 200-400 ms equivalent of buffer capacities). At the stage when sender's transmit rate exactly matches that of the bottleneck link's bandwidth capacity, upon CWND now ‘doubled’ in size at the next RTT and assuming RTT here stays around 100 ms, then in this next RTT this extra over-bandwidth-capacity 100 ms equivalent worth of packets needs to be buffered at the bottleneck node. Assuming the rates of returning ACKs over the successive RTTs now stays at or around the maximum bottleneck link's bandwidth capacity (ie bottleneck link continues to forward data at 100% link's bandwidth utilization), then sender's CWND will be successively incremented by an amount equal to the bottleneck link's bandwidth capacity in each following successive RTT, each successive RTT slightly linger than immediately previous RTT due to successive eg 100 ms equivalent amount of extra buffered packet traffics introduced by incremented CWND (or incremented effective window) until eg the 4^{th} successive RTT where the bottleneck node now runs out of buffers thus causing packets to be dropped. Sender would then likely fast retransmit the dropped packets upon receiving 3 DUP ACKs from receiver TCP, in which case even the now halved CWND and SSthresh values would still almost invariably remain much larger than the relatively small receiver maximum window size value→thus sender TCP would thereafter continue to transmit at same previous rates undiminished by these packet drops events, and with ACKs returning at the rates equal to the bottleneck link's bandwidth capacity the sender's transmit rate now would continue to be at the exact maximum rates equal to the bottleneck link's bandwidth capacity (assuming this is equal or smaller than receiver's maximum window size). Note sender may also RTO Timeout retransmit the dropped packets only after minimum 1 second existing RFC default minimum time period, if not already taken care of by receiver's 3 DUP ACKs fast retransmit request, but these will be very much rarer: in which case sender's CWND would still very quickly exponential increases in just a few RTTs to re-attain/exceeds the relatively small receiver's maximum window size value (helped by ‘arbitrary’ large Ssthresh value). Sender's CWND here would ‘exponentially’ grow to very large values (tends towards the ‘maintained’ arbitrary large Ssthresh value) despite periodic fast retransmit halving of CWND and Sstresh values. Note once sender's TCP's CWND attained/exceeded receiver's maximum window size, it will thereafter pre-dominantly be its received share of the returning ACKs self-clocking rates, total rates of which at most equal to the bottleneck link's bandwidth capacity at any time, that will henceforth dictates sender TCP transmit rates. The other end's TCP response variances in generating reply ACKs may reduce the returning ACKs' rates to below that of bottleneck link's bandwidth capacity, buffer delays at intervening nodes along path traversed(lengthening RTTs) . . . etc may reduce the total returning ACKs' rates to all TCP flows traversing the bottleneck link to below/less than 100% of the bottleneck link's bandwidths capacity (hence setting receiver's maximum window size to be larger more than the very minimum size required, to fully utilise 100% of the bottleneck link's bandwidth capacity assuming same uncongested RTTs throughout TCP session, sufficient to compensate for such variances would enable 100% bottleneck link's bandwidths utilization at all times despite such variances) Here it can be seen that with sender's maximum Window Size and CWND values can be arbitrary large at any time (helped maintained so by ‘arbitrary’ large Ssthresh value), and with relatively small receiver maximum window size value, the end-to-end TCP connection utilizing above ‘unrequired’ but intentional ‘large scaled sender window size and relatively small receiver maximum window method’ here would tend towards a stabilized transmit rates equal to the botteleneck link's bandwidth capacity ie the transmit rates or throughput graph here would exhibit near 100% link utilization level ‘square wave form’.

Conventional file transport technologies such as FTP dramatically reduce the data rate in response to any packet loss, and cannot maintain long-term throughputs at the capacity of high-speed links. For example, a single FTP file transfer over an OC-3 link (155 Mbps) in a metropolitan area network stabilizes at 22 Mbps, assuming a packet loss percentage of 0.1% and latency of 10 ms.

We can add simple codes here just checking latest arriving ACK's inter-ACKpackets-return interval received at sender TCP from the receiver TCP>eg 300 ms (could also be caused by physical errors, not necessarily congestion drops: we catch both here) for sender's local intercept software to generate 3+DupNum DUP ACKs (with ACKNo=latest received ACK number from receiver TCP, and/or SeqNo=latest received SeqNo field from the receiver TCP) to local MSTCP pre-empts timeouts transmit rates reductions. its well known that even physical errors corruptions (not congestions) of 0.1% in packets transmitted would severely limit throughputs by 80%, see http://www.asperasoft.com/technology-faspvftp.html#continental

Outline:

1. just needs incorporates the incoming/outgoing packets intercept core and the per TCP flows TCB

2. record the latest ‘largest’ SeqNo field sent from local MSTCP to remote ‘lastsentSeqNo’

3. record the latest ‘largest’ incoming packet's ACKNo field received from remote ‘lastrcvACKNo’ (and the packet's SeqNo ‘lastrcvSeqNo’), and the time received ‘lastpktrcvtime’, and copy of this complete packet ‘lastrcvpkt’

4. IF present time−lastpktrcvtime>eg 300 ms AND lastsentSeqNo+1>lastrcvACKNo
THEN send 3 of the ‘lastrcvpkt’ (easier, no need to compute checksum for generated packet: duplicate SeqNo/duplicate data . . . etc, if present in lastrcvpkt, will just be ignored by local MSTCP while causing 3 DUP ACKs fast retransmit)

5. At software initialisation, edit TCP registry (and/or optionally per individual application's own socket buffer size) ensures all new TCP request large Window Scale factor 14 and TCPWindow Size 64K (ie max 1 Gigabyte), preferable SACK enabled, preferable no Delay-ACK.

[references: Google Search term ‘set socket buffer override large scale window size’ (or similar related terms), www.psc.edu/networking/perf tune.html, publib.boulder.ibm.com/infocenter/pseries/topic/com.ibm.aix.doc/aixbman/prftungd/2 365a83.htm, www.dslnuts.com/2kxp.shtml, http://www.ces.net/doc/2003/research/qos.html, forum java.sun.com/thread.jspa?threadID=596030andmessageID=3165552 netlab.caltech.edu/FAST/meetings/2002july/relatedWork.ppt, www.ncne.org/research/tcp/debugging/firstpackets.html)

Note: with both ends negotiated large window scale factor and large window size, per flow TCP will very quickly build up CWND values to eg 1,024*MSS of 1,500 bytes ie 1.5 Mbytes within 10 RTT eg 2.5 seconds. At any fast retransmit request whether software generated (eg preempting RTO timeouts) or from remote, halving of CWND and setting SSThresh to CWND/2 will not have any effect whatsoever reducing the ‘effective window’, the ‘effective window’ at any time after SYNC/SYNC ACK/ACK will always EITHER

1. be limited to the receiver's advertised receive window size at all time: receiver has usually say 16 Kbytes and thus in all subsequent packets receiver will advertise receive window size of ‘1’ (scale shifted 14 places=16 Kbytes)==>local sender's transmit rates at any time will always be rates to this receiver's advertised window size of ‘16K’ and very effectively ‘rates paced’ by the ACKs inherent self-clocking characteristics (as we have become very aware of past few days) NOTE: CWND and Sender window size could be arbitrary large, and does not play any further part in congestion controls (once CWND attained size much greater than receiver's maximum window size!!! thereafter its ACKs self-clocking feature that adjust maximum possible sending rates to the available bottleneck link's bandwidth, but of course, receiver can continue to dynamically adjust the advertised receiver window size to further exerts control on sender's transmit rates, or the intercept software residing at sender end may optionally dynamically modify incoming packets' receiver window size to exert similar control on sending MSTCP's transmit rates/‘effective window’), OR

2. we had intentionally over-set both the sender's maximum window size to be negotiated to arbitrary large scaled window size values (or just large unscaled 64K, scaled 256K . . . etc values), with receiver's maximum window size just slightly over-set during negotiation to eg 4 times larger than is actually required/needed (such as to eg 64K, 256K . . . etc instead of usual required/needed size of maximum default 16K) so that sender's CWND and SSthresh (which usually is set to same as the negotiated receiver maximum window size value) almost at all times maintain very much larger values despite frequent fast retransmit halvings (much larger value than receiver's relatively small actual system resource constrained advertised receiver window size) ensuring very efficient close to 100% bottleneck link's utilisation square wave form’: it's the maximum possible rates of returning ACKs self-clocking arriving back only at most at the bottleneck line rates that ensures this, since with both CWND and Sender window size now almost invariably always at all times be many magnitude orders greater than the particular sender window size value needed to ensure sender TCP could transmit at fast enough rates to utilise 100% of the traversed bottleneck link's bandwidth capacity (this is related to the well known bandwidth-delay-product, ie the well known RTTs*Window Size equation), further after CWND has quickly attained size greater than receiver's negotiated window size value (of above eg 64K, 256K . . . etc) sender TCP here will not subsequently ever increment actual ‘effective windows’ beyond receiver's negotiated maximum window size (of above eg 64K, 256K . . . etc) via window size growths during successive RTTs and thus would only subsequently ever to clock out/send out further packets upon receiving returning ACKs stream (maximum rates of returning ACKs always here constrained to be within the bottleneck link's bandwidth capacity).

NOTE: in both cases 1 and 2 above, intercept software (or TCP source code) could always modify receiver window size field values in incoming packets from remote receiver to be of any required smaller maximum values (whether dynamically derived eg from latest recorded minimum inter-returning ACKs-interval and uncongested RTT/OTT values or estimates . . . etc, or user may specify specific values from prior knowledge of the traversed bottleneck link's bandwidth capacity), thus ensuring sender TCP's effective window size never exceeds the size level needed to match traversed bottleneck link's bandwidth capacity now need not recourse to receiver's system resource constraints to limit dynamic receiver's advertised window size field value, and both sender's and receiver's maximum window size values can together be both negotiated to same arbitrary very very large scaled window size values.

NOTE: we may want to/need to further ensure sender's CWND definitely gets built up to sufficiently large or very large value ab initio upon ftp's TCP data transfer channel establishment, else an immediate packet drop at this very initial stage may cause sender's SSThresh to be set to half of the present initial very small CWND value: this could be achieved eg by intercept software storing a number eg 10 of the very 1st initially sent data packets and performs actual retransmissions to remote receiver of any of the eg 10 packets which were not received (ie checking incoming returning ACKNo during this time to detect missing packets not received at remote receiver TCP, and discarding/modifying/or not forwarding such arriving packets back to local MSTCP to prevent local MSTCP from resetting Sstresh value to half the present initial very small CWND value at this time).

NOTE: where the sender's TCP source code is available for direct modifications, it will be much simple: eg just need here to modify source code so that Ssthresh value is now ‘permanently’ fixed to arbitrary very large value, and/or sending TCP's maximum sender window size is now ‘permanently fixed to arbitrary very large value . . . etc (there can be many ways to accomplish the purpose . . . ). Also all the methods/techniques could be correspondingly modified to work as receiver based control (instead of sender based control).

NOTE: should further be able to immediately utilise above ‘square wave form’ technique manually without any software required, in a very basic way:

1. manually set two PCs' registry accordingly for large window scale, large window, SACK, no Delay ACK;

2. large FTP between these 2 PCs;

3. the transmit rates/throughput graph of the FTP here should show ‘constant near 100% bottleneck link's utilisation level square wave form.

We may further may want to add minimum inter-packet-delay sending out regular data packets at the latest minimum ‘recorded’ inter-returning ACK-interval observed (in terms of eg bytes per second, which should correspond the bottleneck link's capacity, this value may further be derived/updated eg only from the immediately preceding specified previous time interval such as derived/updated every eg 300 ms), buffer the packets if need to ==>no ‘burst buffering’ at routers which may contribute to unnecessary transient-congestion packet drops, not real congestion

Its possible for this intercept software to cause congestion drops from successive RTT exponential increment of CWND (while exponential incremented CWND remains=<receiver advertised window size eg allowing doubling of transmit rates despite ACKs self-clocking while previously already utilising 100% of bottleneck link's bandwidth, some user may even set actual physical receive buffer size system resource to be really large)

should incorporate existing ‘pause’ technique, ie ‘pause’ for latest minimum ‘recorded’ inter-returning ACK-interval (corresponds to bottleneck link's capacity) for every returning ACKs outside of ‘timeout’, ie simply not forwarding onwards to remote receiver TCP the next pending intercepted packet, if specified interval expires (eg 1.8*latest minimum recorded inter-returning ACK-interval) without receiving next new incoming returning ACK since the previous, for a period equal to eg the same latest minimum recorded inter-returning ACK-INTERVAL ie min-inter-returning ACK-interval==>here sender TCP could only transmit at most 2 packets (each been rates-paced minimum min-inter-returning ACK-interval of eg 50 ms between sending) before ‘pause’ triggered by the 1st sent's ACK returning outside 1.8*latest minimum recorded inter-returning ACK-interval eg 90 ms==>SOFTWARE DOES NOT ON ITS OWN CAUSE CONGESTION DROPS+INCREMENTAL DEPLOYMENT POSSIBLE OVER EXTERNAL INTERNET+TCP FRIENDLY+PRESERVES ATTAINED UNCONGESTED LEVEL TRANSMIT RATES THROUGHOUT EVEN WHEN OTHER TCPs CAUSE OUR PACKET DROPS (no see-saw). May further need/want to implement buffers to store intercepted packets waiting to be forwarded to remote receiver TCP and/or various informations on such buffered packets eg time received into buffer . . . etc, and to then generate 3 DUP ACKs fast retransmit request to local MSTCP (to pre-empts RTO Timeout at local MSTCP) if eg a particular buffered packet's wait time in the buffer queue approaches eg 1 second standard RFC's default minimum RTO time period, and to further replaced this particular buffered packet in the queue with any latest new ‘fast retransmitted’ packet.

NOTE: an alternative TCP congestion control mechanism, without necessarily needing any of the existing standard RFC's Sliding Window/AIMD mechanism . . . etc, and/or working in parallel as intercept software (and/or direct TCP source code modifications) with existing standard RFC's Sliding Window/AIMD mechanism . . . etc, would be to incorporate above immediately preceding paragraphs' inter-arriving ACK-interval ‘transmit rate paced’ technique together with ‘transmit rate pause’ technique (to pause/skip packets forwarding to remote receiver upon eg next returning ACK arrives outside specified time period since the previous ACK arrived), and to either increment/decrement MSTCP packets generation rates (to be made available for forwarding at faster incrementing/slower decrementing rates) adjusting according to eg latest value of inter-returning ACKs-interval between latest successive packets and/or the particular packet's actual RTT value or OTT value (which should show up onsets of congestions buffering along path traversed, or total absence of which, very well) OR to utilise in parallel existing standard RFC TCP's very own existing AIMD mechanism (and/or together with buffering of packets waiting to be forwarded to remote receiver, and/or 3 DUP ACKS fast retransmit request generation to local MSTCP to pre-empts RTO Timeout of stale queued packets and/or latest new retransmit packets to be replacing the old version packet queued in the buffer and/or event-list time received/time sent information and/or per packet RTT/OTT monitoring . . . etc to effect inter-returning ACK-interval ‘transmit/pause rate pace’ techniques). At periodic specified time period, the above schema could ensure two or a small number of packets are available for forwarding onwards to remote receiver one immediately after another in very quick successions possible allowable by the immediate 1^{st} mile link's bandwidth to ensure the traversed path's latest best estimate of bottleneck link's bandwidth capacity is continuously updated from subsequent arriving latest recorded minimum inter-returning ACK-interval value (eg waiting till two or a small number of packets are available before forwarding them onwards together . . . etc, Note the actual bottleneck link's bandwidth capacity could further be derived on the finer level of bytes per second instead of packets of certain size per second, and the transmit rate pace and/or transmit rate pause techniques could be adapted to utilise this derived common finer granularity of bytes per second knowing the actual size of the pending packet size to be transmitted onwards). The schema here could utilise own devised algorithm for incrementing/decrementing paced transmit rate different from existing RFC's Sliding Window congestion avoidance mechanism. The transmit rates here should exhibit same constant near 100% bottleneck link's utilisation level ‘square wave form’ and at all times the transmit rates will oscillates within very small band around the near 100% bottleneck link's utilisation levels.

Note local intercept software here could generate window size update packet or modify receiver window size field values in incoming packets from remote receiver TCP, eg ‘0’ or very small values as required, to local MSTCP to temporarily ‘stop’ (or reduce the packets sending rates of local MSTCP) local MSTCP from generating/sending out new packets, such as when the number of packets in the intercept software's forwarding buffer packets queue exceeds certain number or total size. This prevents excessive very large packets queue from building up which may cause eventual RTO Timeouts in local MSTCP.

Large FTP Transfer Improvements Quantifications:

Simplified:

In order to achieve minimum 50% throughput improvements (eg from 1 MBS to 1.5 MBS, there would be further sizable improvements from other factors), the constant periodic packet loss (and fast retransmit) occurs the very moment sender transmit rate reaches maximum line rate:

(1) assuming constant periodic 1 every 1,000 packet loss rate and RTT of 200 ms, max window size needs be 200 packets (300 kbytes) to transmit all and to throttle rates to 1,000 packets in one second:

SSthresh value commonly hovers around ½*max window size (100 packets or 300 kbytes), due to successive fast retransmits halving, CWND needs to increment by 100 packets (150 kbytes) to re-attain max bandwidth transmission rate==>100 RTTs required (20 seconds)

minimum link's bandwidth needs be 600 kb/s to transmit 1,000 packets in 20 seconds (1,000*1,500*8/20)

(2) assuming constant periodic 1 every 100 packet loss rate and RTT of 200 ms, max window size needs be 20 packets (30 kbytes) to transmit all and to throttle rates to 1,000 packets in one second:

SSthresh value commonly hovers around ½*max window size (10 packets or 15 kbytes), due to successive fast retransmits halving, CWND needs to increment by 10 packets (15 kbytes) to re-attain max bandwidth transmission rate==>10 RTTs required (2 seconds)

minimum link's bandwidth needs be 600 kb/s to transmit 100 packets in 2 seconds (100*1,500*8/2)

Such ‘Square Wave form’ TCPs would be TCP friendly, were the TCPs flows traversing the botteleneck link consists of all such ‘Square Wave form’ flows or a mixture of such ‘Square Wave form’ flows and existing standard RFC TCP flows, the total rates/total number of returning ACKs to all such flows/all such mixture of flows would still be limited to not more than corresponding to the bottleneck link's bandwidth capacity of the path traversed→such ‘Square Wave form’ TCP flows could be incrementally deployed over the external Internet, maintain/retain their attained transmit rate despite packet drops caused by other existing standard RFC's TCP flows and/or ‘saw-tooth’ effect of the mixture of flows and/or public Internet congestion packet drops and/or BER packet corruptions (bit error rates) while able to remain TCP friendly to all such ‘Square Wave form’ TCP flows and/or other existing standard RFC's TCP flows (Note new TCP flows could in any event almost always begin their transmit rate growths utilizing the network nodes buffers' capacity)

With modified TCPs if the link's traffic starts being buffered their corresponding echoed RTT would now exceed certain specified multiplicant*uncongested RTT value (for the particular packet size, usually determined by system MTU size or MSS size) of the particular source-destination, and software may now pause the transmissions of the per TCP flow for specified ‘pause’ interval==>this ensures all traversed nodes' buffers are immediately cleared of any of this per TCP flow's buffered packets (or equivalent) during this ‘pause’ interval==>thus there will not ever be congestion packet drops! However there is always possibility of physical transmission errors causing RTO timeout and CWND resets to 1 MSS (this will be very rare and does not affect the improved throughputs performance much), but we could also incorporate our ‘receiver based’ Inter-Packet-Arrivals technique and 3 DUP ACKs fast retransmit method together with preceding paragraphs ‘large scaled window size’ method to pre-empts sender RTO timeout events/pre-empts sender's transmit rate halving or resets to ‘0’.

hence the per TCP flows here would not RTO timeout to drop their transmit rates (CWND resets to 1 MSS) to cause ‘saw-tooth’ transmit rates/throughput graph which invariably waste half the physical available bandwidths, equivalent required reductions in transmit rates to avoid congestion packet drops is now only effected via ‘pause’ intervals==>the transmit rates/throughput graph should now show the physical bandwidth being close to 100% utilisation almost all the time.

An alternative method utilizing modified TCP to pre-empt ‘saw-tooths’ phenomena above, is to set the sender TCP's maximum send window size, i.e., TCPWindowSize system parameter value (and/or various other related parameter values) so that sender TCP's maximum possible Bandwidth Delay Product (max window size RTT) value would never exceed the link's physical bandwidths, thus, there could not be congestion packet drops, assuming this TCP flow is the only flow utilizing the link at the time. When choosing the appropriate max TCPWindowSize value, the finite time period it takes for a packet of maximum permitted size (determined by MTU value of MSS value) to completely exit onto the lowest bandwidth link along the traversed path would needs to be added to the uncongested ping RTT (of every small negligible packet size) value of the particular source-destination, this gives us the minimum RTT value for use in the Bandwidth-Delay-Product equation (in real life the actual RTT values would be bigger taking into considerations variances introduced by various components, for example, CPU ACK generation processings, etc.). Further, if the returning ACK would possibly be carried piggy-backed on a regular data packet (e.g., if receiver is also sending data symmetrically) then the returning maximum size data packet's finite time to completely exit onto lowest bandwidth link along the return traversed path would again needs be added to the above to give us the minimum RTT value for use in the Bandwidth-Delay-Product equation. Selective Acknowledgment option would enhance the performance here, and Delay Acknowledgement option even if enabled will not have any real effects assuming the data packet stream is continuous and assuming the finite time it takes for a maximum permitted size data packet to exit onto the lowest bandwidth link along the path/return path traversed is negligible (i.e., lowest bandwidth link is still of large bandwidth capacity, for example, it takes 50 ms for a 1,500 bytes data packet to exit onto next onwards link of 240 kbs, whereas it takes approximately 250 ms for a 1,500 bytes data packet to exit onto next onwards link of 56 kbs. With source-destination very small byte size ping packet RTT of, for example, 50 ms such exit times dominates the value making up the calculation of minimum RTT value to use in max window size TCPWindowSize calculations).

An Incrementally Immediately Deployable TCP Modifications Over External Internet

At present, standard RFC TCPs data transfer throughput performs badly over path/network with high congestion drops rates and/or high BER rates (physical transmission bit error rates), especially in long distance fat pipes network (LFN) with high RTT values and very large bandwidth paths. Standard RFC TCPs' inherent AIMD (additive increase multiplicative decrease) sawtooths transmission waveform constantly fluctuating surges between 0%-much over 100% of physical link's/bottleneck link's bandwidth capacity, could also contributes to packet drops itself.

At present TCPs halves its Congestion Window CWND size, thus halves its transmission rates, upon packet loss events as notified via 3 DUP ACKs Fast Retransmission requests or RTO Retransmission Timeout. At present TCP also couldn't discern non-congestion-related causes of packet drops event such as BER effects, and treats all packet loss events as being caused by congestions of the path/network.

It is a common well documented phenomena that a path with just 1% total loss rates would halve the achievable TCP flow's throughputs. Typical loss rates in Asia being 5%-40%, North America 2%-10%, as could be seen in http://internettrafficreport.com.

Here is outlined an improvement modification to existing standard RFCs' TCP SACK, which could totally eliminates all the above described shortcoming over high loss rates path/network, which could be incrementally immediately deployable over external Internet and could also be TCP flows friendly, based on the following general principles (or various combinations of the steps or sub-component steps/processes or sub-component processes thereof):

(1) Upon packet drops event as notified by 3 DUP ACKs modified TCP here would need only reduce its Congestion Window CWND size by the number of bytes corresponding to the total segments/packets notified to be lost/dropped (the ACK Number field in the incoming DUP ACK packet/s (which triggers Fast Retransmit and/or subsequent multiple DUP ACKs which increases/inflates the halved CWND size) indicates the initial lost packet's Sequence Number, whereas the Selective Acknowledgement fields would indicate Blocks of contiguous Sequence Number successfully received out-of-order: ie the ‘missing gap/s sequences’ between the ACKNo and the smallest SeqNo SACKed block, and the missing gap/s SeqNo between the SACKed blocks themselves, gives us the missing dropped gap/s packet/s' Sequence Numbers thus the total number of bytes indicated to be dropped). Whereas the largest SACKNo within the DUP ACK indicates the largest SeqNo successfully received, and this could optionally be utilised to increment modified TCP's CWND size accordingly (as if modified TCP's largest received ACKNo is now set to largest received SACKNo within the 3rd DUP ACK triggering Fast Retransmit and/or subsequent multiple DUP ACKs, BUT only for the purpose/effect as to increasing the size of CWND/‘effective window’ size and certainly not for the purpose/effect of advancing of the modified TCP's sliding window's left edge at all ie the end to end semantics of TCP's ACKNo field is to be completely preserved as specified in existing standard TCPs otherwise) thus allowing more segments/packets to be sent/injected into the network by modified TCP as SACKed instead of as ACKed, in the same manner as to the effects incoming ACKNo field has on existing standard TCP's effective window size increment BUT not in anyway as to the effect of the advancement of sliding window's left edge (which would cause the ‘missing gap/s SeqNo’ to no longer be kept within the current window's worth of data possible to be Fast Retransmitted/RTO Timeout Retransmitted again: Note here subsequent increment of received ACKNo, if smaller than the above largest SACKNo utilised to increment CWND/effective window size, should not have the effect of increasing modified TCP's CWND/effective window size again but will have the effect of advancing the modified TCP's sliding window's left edge).

AND/OR

(2) Upon packet drops event as notified by 3rd DUP ACKs modified TCP flow here would need only ensure their total number of outstanding transmitted in-flight-bytes in the network (ie total bytes of all sent packets, including encapsulations/header whether data carrying packet or non-data carrying control packets, transmitted into the network between the time since the data carrying packet, with same SeqNo as the ACKNo of the present 3rd DUP ACK's, was sent and the time of arrival of this present 3^{rd} DUP ACK with same SeqNo) would now be adjusted/reduced to be the same number as computed here: the total number of transmitted in-flights-bytes transmitted into the network during the RTT of this particular 3^{rd} DUP ACK triggering Fast Retransmission ie the total number of transmitted bytes into the network between the time of transmission of the packet with same SeqNo as the 3^{rd} returning DUP ACK's ACKNo triggering Fast Retransmission and the time of receipt of this particular 3^{rd} DUP ACK, DIVIDED by minRTT divided by the RTT for this particular 3^{rd} DUP ACK.

MinRTT is the latest estimate of the actual totally uncongested RTT between the TCP flow's end points, thus if all flows traversing the congestion drops node are all such modified TCP flows acting in unison, this particular node here should subsequently be uncongested or near congested: minRTT here is simply the value of recorded smallest RTT of the observed so far of the modified TCP flow, which would serve as the latest best estimate of the actual physical uncongested RTT of the flow (obviously if the actual physical uncongested RTT of the flow is known, or provided beforehand, then it should or could be used instead).

The total number of transmitted in-flights-bytes transmitted into the network during the RTT of this particular 3^{rd} DUP ACK triggering Fast Retransmission ie the total number of transmitted in-flights-bytes transmitted between the time of transmission of the packet with same SeqNo as the 3^{rd} returning DUP ACK triggering Fast Retransmission and the time of receipt of this particular 3^{rd} DUP ACK, could be derived by maintaining an time-ordered event entries list (ie purely based in the order of their transmittal into the network) consisting triplet fields of SeqNo of the packet sent, and TimeSent, total_number_of_bytes of this packet including encapsulation/header. Thus the RTT value of the 3^{rd} DUP ACK packet with a particular Acknowledgement Number could be derived as present arrival time of this present 3^{rd} DUP ACK−TimeSent of the data carrying packet with same SeqNo as the present 3^{rd} returning DUP ACK. And the total transmitted in-flights-bytes could be derived as the sum of all the total_number_of_bytes fields of all entries between the event list's entry with same SeqNo as the returning 3^{rd} DUP ACK, and the event list's very last entry.

This event list size could be kept small by removing all entries with SeqNo<the 3^{rd} DUP ACK's ACKNo.

A simplified alternative, in place of calculating the transmitted total number in-flights-bytes, would be to approximate them as the largest SeqNo transmitted−largest ACKNo received, at the time of transmittal/sending of the data packet with same SeqNo as the present returning 3^{rd} DUP ACK's ACKNo: this gives total number of in-flights-datasegmentbytes ie pure data segments in-flights not including encapsulations/header/non-data-carrying control packets.

Among various possible ways to implement modifications on existing standard RFC's TCP source codes to adjust/reduce the total number of outstanding transmitted in-flight-bytes in the network Upon packet drops event as notified by 3rd DUP ACKs are:
immediately reduce the present ‘effective window’ size via reducing Congestion Window ie CWND size to be the same number as the total number of transmitted in-flights-bytes transmitted into the network during the RTT of this particular 3^{rd} DUP ACK triggering Fast Retransmission ie the total number of transmitted bytes into the network between the time of transmission of the packet with same SeqNo as the 3^{rd} returning DUP ACK's ACKNo triggering Fast Retransmission and the time of receipt of this particular 3^{rd} DUP ACK, DIVIDED by [minRTT divided by the RTT of this particular 3^{rd} DUP ACK] rounded to the nearest byte. This would result in the an appropriate number of subsequent returning ACKs no longer having the effect of ‘clocking’ out new packets into the network since Congestion Window CWND size needs be incremented by an appropriate number of subsequent returning ACKs to re-attain its previous size, before any new arriving returning ACK/s would be able to ‘clock’ out new packets into the network: the number of returning ACKs required here before being able to ‘clock’ out new packet/s would be or normally corresponds to the number of returning ACKs required to acknowledge the same number of bytes as the number of bytes CWND had been reduced by.
alternatively instead of the above reduction procedure, CWND here would only be incremented in the ratio of arriving 3^{rd} DUP ACK's RTT/minRTT*the number of sent segment bytes acked by this arriving 3^{rd} DUP ACK, rounded to the nearest bytes or fractions carried forward (instead of the usual standard RFC's TCP increment by the number of sent segment bytes acked by arriving new ACKs): this is continued for all subsequent multiple same or incremented ACKNo DUP ACKs or new ACKs, until the reductions is achieved whereupon this reduction process ceases. Note some older TCP implementations may increment CWND by 1 SMSS for each arriving new ACK instead of incrementing by the number of sent segments bytes acked by this arriving new ACK, in which case the reduction process may also instead be effected by only incrementing CWND by 1 SMSS only once for every other RTT/minRTT number of arriving ACKs received (whether DUP ACKs or new ACKs, but rounded to the nearest integer eg if RTT/minRTT=2.5 then could increment CWND by 2 for every 5 arriving new ACKs). This has the effect of smoothing the in-flights-bytes reduction process, so there is still an appropriately reduced continuous transmissions and reception of new packets throughout the in-flights-bytes reduction process.

The congestion drop/s notification event caused by RTO Timeout Retransmissions could be:
treated in the same way as 3^{rd} Dup ACK or subsequent very same ACKNo multiple DUP ACK/s, as described above ie causes reduction process of the in-flights-bytes to remove buffered residencies packets but not to resets/reduce CWND size.

OR
treated in the exact same way as in existing standard RFC specification ie resets CWND to 1 SMSS and re-enters slow start exponential increments: but note here since Ssthresh value would never have been halved in modified TCPs here the slow start would grow rapidly again up to the initial Ssthresh value (which would not have been reduced by any successive Fast Retransmission events)

Further, subsequent congestion drop notification event, eg subsequent multiple DUP ACKs with unchanged same ACKNo, third DUP ACKs with new incremented ACKNo, (or even RTO Timeout Retransmission eg detected by TCP retransmitting without 3^{rd} DUP ACKs triggering Fast Retransmissions) must allow existing ‘in-flight-bytes reduction’ process/procedure to be completed if new computation does not require bigger reductions (ie does not require resulting in smaller total in-flights-bytes), otherwise this new process/procedure may optionally take over. (could also alternatively allow such process/procedure to commence only once per RTT, based on a particular ‘marked’ SeqNo returning then checking if there had been any congestion drop notification event/s during this RTT).

Since modified TCP here could derive the RTT of the particular return ACK (or return ACK immediately prior to the RTO Timeout Retransmission) causing congestion drop/s event notification, modified software could further discern if the same event above was actually a ‘false’ congestion drop/s notification and react differently if so: ie if the RTT associated with the particular congestion drop/s event notification is the same as the latest estimated uncongested RTT of the end points (or if known/provided before hand), or even not differ by certain specified variance amount within bounds of a single node's smallest buffer capacity equivalent in milliseconds, then this particular congestion drop/s notification could rightly be treated as arising from physical transmission errors/corruption/BER (bit error rates) instead, and modified software could simply retransmit the notified dropped segment/packet without needing to cause/enter into any in-flights-bytes reductions process whatsoever.

Note here, unlike existing standard RFC's TCP, modified TCP here would not necessarily automatically need to reduce/halve/resets CWND size upon congestion drop/s notification event caused by new 3^{rd} DUP ACK/subsequent same ACKNo multiple DUP ACKs following the new 3^{rd} DUP ACK and/or RTO Timeout Retransmissions: modified TCP here needs only ever necessarily reduce CWND size appropriately upon congestion drop/s notification event/s to reduce the number of outstanding in-flights-bytes to appropriately derived values.

It is noted any bottleneck neck link would continuously forward sent packet towards receiver TCPs at the bottleneck's physical line rates, regardless of the buffer residency occupations levels at the bottleneck node and/or congestion drop/s occurrences, at any time→thus the sum of all the bytes acknowledged during the RTT period/s associated with the returning ACKs received at all the sender TCPs would be almost invariably equal to the bottleneck link's physical bandwidth at any time if the bottleneck bandwidth is fully utilised. It is also noted that TCP's congestion avoidance algorithm should strive to keep the bandwidth utilisation levels at close to 100% of the bottleneck/s' link bandwidth as far as possible, instead of existing standard RFC TCP's gross under-utilisation caused by CWND size halving upon congestion drop/s notification event/s. Various different in-flights-bytes reduction levels/reduction amounts/reduction ratios/algorithms could be devised, and could also be based on various other parameters eg largest received ACKNo and/or largest sent SeqNo and/or CWND size and/or effective window size and/or RTT and/or minRTT . . . etc (such as eg allowing for certain tolerated levels of buffer residency occupations instead of totally clearing all the buffer residency packets/‘extra’ buffered in-flights-bytes of the modified TCP flows . . . etc) at the time of the congestion drop/s notification event/s and/or such historical events.

AND/OR

(3) The physical bottleneck link of a TCP connection over the Internet is usually either the receiver TCP's last mile transmission media or the sender TCP's first mile transmission media: these are usually 56 Kbs/128 Kbs PSTN dial-up or typical 256 Kbs/512 Kbs/1 Mbs/2 Mbs ADSL link. In these situations regardless of how fast the transmission rates of the sender TCP (which existing standard RFC's TCPs inevitably continuously probe the path's bandwidth by injecting ever increasing larger of bytes in each subsequent RTT, either exponential doubling of CWND during slow-starts or linear increments of CWND during congestion avoidance), the bottleneck link could only forward all the flows' traffics at maximum line rates limited by its bandwidth→increasing the sending rates beyond that of the current bottleneck link's line rates (the current bottleneck link may change from time to time depending on network's traffics) will not result in any higher throughputs of the TCP flow/s beyond the bottleneck link's physical line rates. Thus TCPs here could advantageously be modified to not send at a rate greater than the bottleneck link's maximum possible physical line rates. To do so would only cause the ‘extra’ beyond bottleneck's physical line rate's amount of packets/bytes sent during each RTT to be inevitably buffered or dropped somewhere along the two end points of the TCP flow.

Here is an example procedure, among several possible, to determine the path's bottleneck link's physical bandwidth:
the successive RTT values could be readily derived, since existing standard RFC TCPs already performs calculations/derivations of successive RTT values based the a ‘marked’ TCP packet with particular SeqNo for each successive RTT periods.
the throughput rate for each successive RTTs could be derived by first recording or deriving the total number of transmitted in-flights-bytes transmitted into the network during the RTT of this particular ‘marked’ SeqNo packet ie the total number of transmitted in-flights-bytes transmitted between the time of transmission of the packet with the particular ‘marked’ SeqNo and the time of its returning ACK (or SACKed), which could be derived by maintaining an time-ordered event entries list (ie purely based in the order of their transmittal into the network) consisting triplet fields of SeqNo of the packet sent, and TimeSent, total_number_of_bytes of this packet including encapsulation/header. Thus the RTT value of the particular ‘marked’ packet with a particular SeqNo could be derived as present arrival time of this present returning ACK (or SACKed)−TimeSent of the data carrying packet with the particular ‘marked’ SeqNo. And the total transmitted in-flights-bytes could be derived as the sum of all the total_number_of_bytes fields of all entries between the event list's entry with same SeqNo as the returning 3^{rd} DUP ACK, and the event list's very last entry. This event list size could be kept small by removing all entries with SeqNo<the 3^{rd} DUP ACK's ACKNo. A simplified alternative, in place of calculating the transmitted total number in-flights-bytes, would be to approximate them as the largest SeqNo transmitted+number of data bytes of this largest SeqNo packet−largest ACKNo received, at the time of arrival of the 3^{rd} DUP ACK: this gives total number of in-flights-datasegmentbytes ie pure data segments in-flights not including encapsulations/header/non-data-carrying control packets.

Alternatively as an approximation and/or simplification of the total number of transmitted in-flights-bytes transmitted between the time of transmission of the packet with the particular ‘marked’ SeqNo and the time of its returning ACK (or SACKed), throughput rate calculations/derivations for each successive RTTs could be based on the particular ‘marked’ packet's SeqNo+the particular ‘marked’ packet's data payload size in bytes−largest ACKNo received at the time when the particular ‘marked’ SEQNo packet is sent.

The throughput rates for the RTT here hence could be computed as above derived total number of transmitted in-flights-bytes transmitted into the network during the RTT period/this RTT value (1 seconds).
Record is kept of the largest throughput rate value attained in all the RTTs and continuously updated, hereinafter known as maxT. Also recorded is the RTT value associated with this period when largest throughput rate maxT was attained hereinafter known as RTT_maxT, together with the total number of transmitted in-flights-bytes associated with this period when largest throughput rate maxT was attained hereinafter known as In_Flights_BYTES_maxT.
whenever throughput rate in any RTT period=<maxT ie throughput rate in this RTT period does not become >maxT, and IF [total number of in-flights-bytes during this RTT_period/In_Flights_Bytes_maxT]>[RTT value in milliseconds during this period/RTT_maxT in milliseconds] THEN the bottleneck link's physical bandwidth capacity or line rate is now derived/obtained. Rationale here is because if the in-flights-bytes in this RTT period is eg double that of associated with maxT period and the RTT value for this period is eg remains the same as (or less than twice) RTT_maxT, THEN the reason throughput rate for this RTT does not exceed maxT is because maxT is already the same as the bottleneck link's physical bandwidth capacity/line rate, thus despite many more in-flights-bytes during this RTT period and this RTT value has not increased disproportionately the throughput rate in this RTT being limited at the bottleneck's line rate does not increased to be greater than maxT. The test formula may further include a mathematical variance tolerance value eg “IF [total number of in-flights-bytes during this RTT period/In_Flights_Bytes_maxT]>[RTT value in milliseconds during this period/RTT_maxT in milliseconds]*variance tolerance (eg 1.05/1.10 . . . etc)
Once the true bottleneck link's physical bandwidth capacity/line rates is derived/obtained (=maxT), modified TCP could then no longer to continuously probe for path's bandwidth as aggressively as in existing RFC standard TCPs' slow start exponential CWND increment/congestion avoidance linear CWND increment per RTT, which invariably strives to cause unnecessary congestion packet drops and/or burst-packet-drops. Here modified TCP may thereafter limit any subsequent increment in CWND size (optionally and/or effective window size) in any subsequent next RTT period to be not more than eg 5% of the [CWND size (optionally and/or effective window size) associated with maxT at the time of maxT (which now equals the bottleneck line rate) being attained*(the last previous ie latest RTT value in milliseconds/RTT_maxT in milliseconds). If, very unlikely, throughput rate in any subsequent RTT becomes greater than maxT, THEN maxT would be updated and the bottleneck line rate determination process repeats again. Thus modified TCP will not unnecessarily aggressively increment CWND size and/or effective window size to cause congestion drops and/or burst-packet-drops, beyond that necessarily required to keep the bottleneck link busy at its line rate.

Alternatively, modified TCP may optionally rates pace its packets generations/packets transmission onto network, ie the modified TCP only generates packets/send packets at the maxT bottleneck line rate: eg by setting minimum Inter-Bytes_forwarding_Interval=(1/(maxT/8))

once maxT attains/becomes equal to the bottleneck's true line rate, ELSE optionally setting minimum Inter-Bytes_forwarding_Interval=(1/(maxT/8))*2 (since CWND growth at this time would be at most exponential doubling that of CWND of previous RTT period)
Further optionally, modified TCP may ensure the packets generation/packets sending rate will be at the corresponding maxT rate (whether maxT has already attained rates equal to botteleneck's true line rate, or just latest largest maxT) at all times, instead of packets generation/packets sending rate as allowed/‘clocked’ out by returning ACKs (or SACKed) rates, subject to clearing of ‘extra’ in-flights-bytes and/or appropriate rates reductions for dropped packets processes as described upon congestion drop/s notification event/s: ie modified TCPs optionally will be made to generate packets/transmit at latest maxT rates not limited not limited by latest ACKs (or SACKed) returning rates, unless required to effect appropriate rates reductions to clear/reduce in-flights-bytes and/or reduce rates corresponding to number of dropped packets (eg reduce packets generation/transmitting rate in equivalent bits per second to eg maxT*minRTT/this period's RTT value, or to maxT−number of bytes dropped during this RTT*8, upon congestion drops notification events (which may be 3^{rd} DUP ACKs and/or subsequent multiple same ACKNO DUP ACKs, and/or RTO Timeout Retransmissions)).

Implementation without Changing Existing TCP Source Codes Directly:

without directly modifying TCP source code, the invention as described in immediately preceding paragraphs could be implemented as an independent TCP packets intercept software/agent, wherein the software keeps copy of a sliding window's worth of all sent data segments forwarded, performs all Fast Retransmit and/or RTO Timeout retransmissions, and/or rates pace forwarding onwards of intercepted packets from/towards local TCP (according to maxT value), forwarding rates adjustment processes upon congestion drops notification events.

Here are such implementation outlines, purely to provide an overview of the steps required which could be improved upon//modified. Further any refined detailed algorithmic/coding steps are purely for illustrative outline purposes only, and may be improved upon/modified:
Intercept software intercepts each and every packets coming from TCP/destined to MSTCP.
software maintains a copy of all data payload carrying packets in a well ordered list entries, according to ascending SeqNo.
Upon 3^{rd} DUP ACK notification, software performs Fast Retransmit from the data payload packets copy entry on the list with same SeqNo as the 3^{rd} DUP ACK and subsequent multiple DUP ACKs of the same ACKNo. Software keeps track of the cumulative number of DUP ACK/s of the same ACKNo value as DupNum, further Fast Retransmit all dropped packets as indicated by the ‘gap/s’ in Selective Acknowledgement fields. Software modifies each and every DUP ACK/s ‘ACKNo by decrementing this packet/s’ ACKNo value to be ACKNo−DupNum*eg 1,500, so TCP does not ever receive any DUP ACK/s with same ACKNo at all→TCP never reduces/halves CWND size due to Fast Retransmit (which will be taken care of by software now). Software does not decrease any CWND size value (this parameter is not even accessible by software).

Software incorporates the principles/processes/procedures as outlined in the General Principles earlier described, or combinations/sub-components thereof.

FURTHER;
software may even performs RTO Timeout Retransmission completely, instead of MSTCP (by incorporating RTO calculations from historical returning ACKs' RTT values): software thus could ‘spoof ACKs’ every single packets immediately upon receiving the packet/s from TCP for forwarding→TCP now does not even do RTO Timeout Retransmissions. Software may further ‘delay’ spoofing ACKs when receiving packet/s from TCP, as a technique to control TCP packets generation/TCP packets sending rates.
instead of modifying TCP's CWND size/effective window size (not even accessible to software) even though this is not a necessary essential required feature, software may instead either simulate a ‘mirror CWND mechanism/mirror effective window mechanism’ within the software itself, OR to instead give equivalent effects in other equivalent ways such as reduction of in-flights-bytes via eg rates pacing to control/adjust other parameter values like largestRcvACKNo, largestSentSeqNo, ensuring their subtraction difference to be of the required size, . . . etc.
software may also implements various standard TCP techniques such as CheckSum verification on each and every intercepted packets, SeqNo Wrap Around detections and comparisons, TimeStamp Wrap Around detection and comparisons, as defined in existing standard RFCs . . . etc

Here are some simple outlines on the software designs, for purely illustrative purposes only and could be further corrected/improved upon/modified and/or completely differently designed:

1. PURE INTERCEPT FORWARDING:

2. +CHECKSUM+Wrap Arounds:

3. +FAST RETRANSMIT ONLY THE SAME DUPACKed PACKET COPY, JUST ONCE FOR SAME DUP ACKNo:

4. +FAST RETRANSMIT ALL PACKET COPY, JUST ONCE FOR SAME DUP ACKNo:

5. +FAST RETRANSMIT ONLY ALL PACKET COPY UP TO LARGEST SACKed ‘GAP/S’, JUST ONCE FOR SAME ACKNo DUP ACKs:

6. +FAST RETRANSMIT ONLY ALL PACKET COPY UP TO LARGEST SACKed ‘GAP/S’ and >LARGESTRTXSEQNo, @EACH DUPACKs: (does not want software to repetitively Fast Retransmit multiple times unnecessarily for each subsequent same ACKNo DUP ACKs, and/or new incremented ACKNo DUP ACKs, could record/update largest Fast Retransmitted packet's SeqNo, LargestRtxSeqNo, to not again unnecessarily re-send already fast retransmitted packets upon receiving subsequent same ACKNo DUP ACKs.

LATER ON:

7. +INTER-PACKET-FORWARDING-INTERVALS (determined by user input of pre-known bottleneck line rates):

8. +as in (7), using latest estimated bottleneck line rates instead of user input

9. +TCP FRIENDLY ALGORITHMS operating via controlling/adjusting INTER-PACKET-FORWARDING-INTERVAL value

Initial Basic Rates Pace Module Simple Outline:

1st Stage Rates Pace Module Specifications to be added (this specification only performs smoothing out packets transmissions onto network, nothing else):

1. have user input the bottleneck link's bandwidth in kbs, eg SAN.exe B (eg 512 kbs): this is usually sender's/user's first mile upload bandwidth but could occasionally be receiver's last mile (if user doesn't know receiver's last mile's bandwidth just input user's first mile: DSL subscribers' upload bandwidth is usually much smaller than download bandwidth)

[later software can provide latest estimated value of B, not needing any user inputs]

2. incorporate a simple rates pace module which ensures minimum inter-bytes-interval forwarding, eg if forwarding a packet of size S1 (eg 1,000 bytes total length, encapsulation+header+payload) then makes sure 1,000 bytes/(B/8) elapsed before begin forwarding of next packet size of S2 (eg 750 bytes now) . . . and so forth . . . total packet size S could be ascertained from TCP Header

3. all packets to be forwarded, whether new MSTCP packet/Fast Retransmissions/RTO Retransmissions . . . etc, are first appended to an yet-to-be-forwarded packets buffer: this buffer best needs be well ordered and but needs not be ‘gapless’, arriving packets from either MSTCP or software Fast Retransmit appended/inserted in ascending SeqNo order (ie so Fast Retransmit/MSTCP RTO Retransmit packet gets forwarded first ahead of other datapackets with larger SeqNo). Same SeqNo pure ACKs/data packets would need to be inserted in the order of their arrivals relative to each other.

(Note: MSTCP here continues to do all RTO Retransmissions)

[Later Specification enhancement:
useful to add a Total Packet Length in Bytes field to the packet entries in this yet-to-be-forwarded list, for easy counting of total transmitted bytes in each RTT, based on round trip single ‘marked packet's SeqNo . . . and subsequent next forwarded packet's SeqNo following round trip completion . . . and so forth. This list, needed to implement pacings, is different from Packet Copy list which should here at this 1st stage be well ordered but needs not be ‘gapless’
whenever yet-to-be-forwarded buffer>eg 10K bytes then send ‘0’ window update to MSTCP and modify all incoming packets' window size to ‘0’ recompute checksum.
‘mark’ a packet's SeqNo (starting with the 1st packet after SYNC/SYNC ACK/ACK)/sent time/sets this_RTT_total_bytes_forwarded=this ‘mark’ packet's length, and immediately start counting next_RTT_total_bytes_forwarded (not including this ‘mark’ packet). If returning packet's ACKNo>‘mark’ SeqNo then record this RTT value (present system time−sent time) and record this_RTT_total_bytes_forwarded. Then select the next ‘mark’ SeqNo as the very latest forwarded packet's SeqNo (if there are data packets, not pure ACKs, forwarded prior to the previous ‘mark’ SeqNo returning, otherwise wait for a next data packet to be forwarded) . . . etc . . . and so forth (just needs keep record only of latest updated instances of RTT value and this RTT_total_bytes_forwarded)
software should increment DupNum count only if DUPACK packet is pure ACK ie not carrying data, or data carrying packet with SACK flag set (if remote client also sends data we could starts getting many same SeqNo packets even if there is no drops). And increment another variable DupNumData (number of data payload packets with same SeqNo) and modify all incoming packets with same SeqNo to −(DupNum+DupNumData: DupNumData is updated in similar manner to DupNum and DupNum processing now needs to distinguish between pure DUPACK packet and packet with data payload

Various of the component features of all the methods and principles described here could further be made to work together, incorporated into any of the Methods illustrated, various topology network types and/or various traffics/graphs analysis methods and principles may further enable links' bandwidths economy. NOTE also figures used wherever occur in the Description body are meant to denote only a particular instance of possible values, eg in RTT*1.5 the FIG. 1.5 may be substituted by another value setting (but always greater than 1.0) appropriate for the purpose and particular networks, eg perception period of 0.1 sec/0.25 sec . . . etc. Further all specific examples and figures illustrated are meant to convey the underlying ideas, concepts and also their interactions, not limited to the actual figures and examples employed.

The above-described embodiments merely illustrate the principles of the invention. Those skilled in the art may make various modifications and changes that will embody and fall within the principles of the invention thereof.

11 Oct. 2005 Filing

Some Examples of Simple Implementations of Increment Deployable External Internet NextGen TCP

Background Materials
latest RTT of packet triggering the 3rd DUP ACK fast retransmit or triggering RTO Timeout, is readily available from existing Linux TCB maintained variable on last measured roundtrip time RTT
the minimum recorded min(RTT) is only readily available from existing Westwood/FastTCP/Vegas TCB maintained variables, but should be easy enough to write few lines of codes to continuously update min(RTT)=minimum of [min(RTT), last measured roundtrip time RTT]. Also with receiver based TCP modifications/Receiver based TCP rates controls, OTTs and min(OTT) could be utilised in the place of sender based RTTs and min(RTT) which could benefit from sender's Timestamp option, OR receiver based TCP may utilise inter-packet-arrivals technique instead of depending on needs to ascertain OTTs and min(OTT)

### REFERENCES

http://www.cs.umd.edu/˜shankar/417-Notes/5-note-transportCongControl.htm: RTT variables maintained by Linux TCB
http://www.scit.wlv.ac.uk/rfc/rfc29xx/RFC2988.html: RTO computation
Google Search term ‘tcp rtt variables’
http://www.psc.edu/networking/perf tune.html: tuning Linux TCP RTT parameters
Google Search: ‘tcp minimum recorded rtt’ or ‘linux tcp minimum recorded rtt variable’. NOTE: TCP Westwood measures minimum RTT
Google Search terms ‘CWND size tracking’, ‘CWND size estimation’, ‘Receiver based CWND size tracking estimation’, ‘RTT tracking’, ‘RTT estimation’, ‘Receiver based RTT tracking estimation’, ‘OTT tracking’, ‘OTT estimation’, ‘Receiver based OTT tracking estimation’, ‘total in-flights-packets tracking’ ‘total in-flights-packets estimation’, ‘Receiver based total in-flight-packets tracking estimation’ . . . etc

Initial Simple Implementations Ideas

TO verify testing using modified linux:

At its simplest sufficient, just needs modify 1 line and insert a loop delay code (to ‘pause’ Linux TCP executions):

1. in the Linux fast retransmit module code, upon 3 DUP ACKs do not halve CWND, ie CWND now unchanged (instead of CWND=CWND/2)

2. at the same time, and at the same code section location, simply insert few lines of codes to ‘pause’ executions of the Linux TCP program (simulating ‘pause’) for 0.3 seconds. [ONLY LATER: its much preferable to allows the very 1st DUP ACKed packet to be retransmitted unhindered, and next only set 300 ms countdown global variable ‘Pause’ at this same location, then Linux TCP at its ‘final packet transmit’ code section to check this ‘Pause’ variable=0 to allow any kinds of transmissions whatsoever (assuming Linux implements ‘final transmit’ queue to hold packets halted by this ‘Pause’)

to

write few lines of codes to drop packets and introduce latency delays before sending packet, just allows user input constant periodic drop interval and number of consecutive drops (eg 0.125 and 1 ie drop 1 packet once every 8 generated packets [equiv 12.5% packet loss rates], or 0.125 and 3 ie drop 3 consecutive packets once every 8 generated packets [equiv 37.5% packet loss rates]) and RTT latency (eg 200 ms).

codes needs just not forward onwards based on the drop interval and consecutive drops number, and scheduled all surviving packets to be forwarded eg 200 ms later than their received local systime==>these scheduled to be forwarded onwards surviving packets needs be held in a queue (with their own individual scheduled forwarding onwards local systime) for forwarding onwards onto network

Could quickly verify on 10 mbs LAN and wireless router link adjusted to 500 kbs (remember to set Ethernet to ‘half duplex’ mode), together with various simulated loss rates and latencies. At its simplest sufficient, just needs modify 1 line and insert a loop delay code (to ‘pause’ Linux TCP executions):

1. in the Linux fast retransmit module code, upon 3 DUP ACKs do not halve CWND, ie CWND now unchanged (instead of CWND=CWND/2)

2. at the same time, and at the same code section location, simply insert few lines of codes to ‘pause’ executions of the Linux TCP program (simulating ‘pause’) for 0.3 seconds.

Large file transfers SAN FTP over high loss rates high latency external Internet/LFN should now show close to 100% available bandwidths utilisations! could interpose eg Shunra software to simulate eg 10% drop rates and/or 300 ms latency ie simulating long distance high loss rates, or simply write codes to drop packets and introduce latency delays before sending packet. could also easily verify this using Simulations like NS2

It is very clear now that the present size, once attained, of sender TCP's CWND would not cause congestion drops in anyway whatsoever, since sender TCP will only inject new packets corresponding exactly to the returning ACKs rates: note its the accelerate momentary increase in CWND size (momentarily injecting more packets into network than the returning ACKs rates, eg exponential increment doubling that of returning ACKs rates, that is the main cause of packet drops: once CWND attained present existing size already however large it wouldn't cause more new packets to be injected into network than the returning ACKs rates, this could only occur on CWND's momentary size increment)

It is really simple modifying few lines of Linux source codes, on Windows just need first getting the Intercept software module up to take over all fast retransmit functions from MSTCP. To implement in Windows, needs intercept each incoming/outgoing packets and modify incoming DUP ACKs' Acknowledgement Number field so MSTCP doesn't ever gets notified/knows of any lost packet Fast Retransmission requests (our intercept software does all the fast retransmissions functions now, not MSTCP): This Intercept Software module may further also take over all RTO Timeout retransmissions functions from MSTCP (could eg mirror MSTCP very own RTO Timeout tracking algorithm, or devise new modified desired algorithms). With Intercept Software module now taking over all of existing MSTCP's DUP ACKs Fast Retransmit and RTO Timeout retransmissions functions, Intercept Software could now have complete total controls over MSTCP new packets generation/transmit rates via immediate spoofing/temporary halting of SPOOF ACKs back to MSTCP for packets intercepted, and/or setting receiver window size field within the SPOOF ACKs to ‘0’ to halt MSTCP packets generation.

In eg Linux/FreeBSD/Windows Source codes, should be able to just amend/insert few lines to have this NextGenFTPi immediately shown working in very basic way:

1. In the Linux 3 DUP ACKs fast retransmit module, just need to remove the codelines which changes CWND to CWND/2 (ie CWND now becomes unchanged). All other codelines needn't be amended at all: eg SSthresh now remains sets to CWND (ie TCP now only additive increase by 1 segment for every RTT instead of exponential doubling). THIS IN ITSELF SHOULD NOW SHOW CLOSE TO 100% LINK UTILISATION EVEN ON LFN/EXTERNAL INTERNET WITH HIGH DROP RATES! (ie SHOWN WORKING IN A VERY CRUDE WAY HERE)

to help test, may want to use software like Shunra which could introduce % packet drops and/or simulate path latencies, interposing this software between NextGenFTP and the network at the sending side, or code similar simple utility

2. [Optional but definitely needed later] NextGenFTP really should ‘pause’ for an appropriate interval upon packet drops events such as 3 DUP ACKs, to clears all its own ‘extra’ sent in-flights packets that are being buffered (whereas all existing regular TCPs/FTPs drastically halves their CWND, causing severe unnecessary well documented throughputs problems). In eg Linux, needs just insert some codes to keep a record min(RTT) or min(OTT), if the actual real uncongested RTT or uncongested OTT not known before hand, of the smallest observed RTTs of the flow, and upon 3 DUP ACKs to ‘halt’ all packets injections into network for eg 0.3 seconds (which is the most common router buffer size in equivalent seconds) or some algorithmically derived period ( . . . later) [NOTE COULD ALSO INSTEAD OF PAUSING, TO JUST SET CWND TO APPROPRIATE CORRESPONDING ALGORITHMICALLY DETERMINED VALUE/S! such as reducing CWND size by factor of {latest RTT value (or OTT where appropriate)−recorded min(RTT) value (or min(OTT) where appropriate)}/min (RTT), OR reducing CWND size by factor of [{latest RTT value (or OTT where appropriate)−recorded min(RTT) value (or min(OTT) where appropriate)}/latest RTT value] ie CWND now set to CWND*[1−[{latest RTT value (or OTT where appropriate)−recorded min(RTT) value (or min(OTT) where appropriate)}/latest RTT value]], OR setting CWND size to CWND*min(RTT) (or min(OTT) where appropriate)/latest RTT value (or OTT where appropriate), . . . etc depending on desired algorithm devised]. Note min (RTT) being most current estimate of uncongested RTT of the path recorded,

3. [Optional but definitely needed later] the bottleneck link's available bandwidth along the flow's path could easily be determined (quite well documented, but not perfect compared to our own technique developed), thus once this upper limit of available bandwidth is known/determined, NextGenTCP should thereafter no longer cause CWND increments (whether exponential doubling or linear increment)==>once NextGenTCP transmit at this attained upperlimit rates, it no longer unnecessarily cause CWND increments to unnecessarily cause packet drops!

Initial Simple Implementations Ideas (Refinement 1):

TO verify testing using modified linux:

At its simplest sufficient, just needs modify 1 line and insert a loop delay code (to ‘pause’ Linux TCP executions):

1. in the Linux fast retransmit module code, upon 3 DUP ACKs do not halve CWND ie CWND now unchanged (instead of CWND=CWND/2)

2. at the same time, and at the same code section location, simply insert few lines of codes to ‘pause’ executions of the Linux TCP program (simulating ‘pause’) for 0.3 seconds. [LATER: its much preferable to allows the very 1st packet to be retransmitted and next only set 300 ms countdown global variable ‘Pause’ at this same location, then Linux TCP at its ‘final packet transmit’ code section to check this ‘Pause’ variable=0 to allow any kinds of transmissions whatsoever (assuming Linux implements ‘final transmit’ queue to hold packets halted by this ‘Pause’)

[ONLY LATER: its much preferable to allows the very 1st packet to be retransmitted and next only set 300 ms countdown global variable ‘Pause’ at this same location, then Linux TCP at its ‘final packet transmit’ code section to check this ‘Pause’ variable=0 to allow any kinds of transmissions whatsoever (assuming Linux implements ‘final transmit’ queue to hold packets halted by this ‘Pause’)

ONLY MUCH LATER: this could conveniently be achieved by/implemented (as suggestions only):

1. in the Linux fast retransmit module code, upon 3 DUP ACKs do not halve CWND, ie CWND now unchanged (instead of CWND=CWND/2)

2. at the same time, and at the same code section location, simply setting 300 ms countdown global variable ‘Pause’ at this same location (exactly where CWND now modified to be unchanged instead of CWND/2) then Linux TCP at its ‘final packet transmit’ code section to check this ‘Pause’ variable=0 to allow any kinds of transmissions whatsoever EXCEPT where packet's SeqNo=<largest sent unacked SeqNo (which could readily be obtained from existing TCP parameters, ie ONLY allows packets to be forwarded onwards regardless of ‘Pause’ variable>0 ONLY IF packet is a retransmit old SeqNo packet) ie Linux TCP could always allow all fast retransmit and/or RTO Timeout retransmission packets to be forwarded onwards immediately unhindered regardless of CWND or effective window size constraints whatsoever (since retransmission packets would not in anyway increment existing packets-in-flights whatsoever! but note whereas forwarding onwards new packets with SeqNo>largest sent unacked SeqNo could increase existing total packets-in-flights)

Another implementation would simply be to never decrement CWND whatsoever, upon congestion drop event/s to countdown ‘pause’ variable (whether fixed eg 300 ms interval or derived such as latest RTT−min(RTT) interval . . . etc) and not allow CWND increments whatsoever if ‘pause’ variable>0==>aggressive in that this implementation does not help reduce extra in-flights-packets that are being buffered [also CWND could be simply be always unchanged/undecremented instead of setting to ‘0’ or largest.UNA.SeqNo−SEnt.UNA.SeqNo, together with both STEP 1 and Step 2]

could also introduce this non-increment part while ‘pause’ variable>0 into earlier implementation below, so returning ACKs advancing Sliding Window's left edge would only cause new packet/s (ie packet/s with SeqNo>largest.Sent.SeqNo) to be injected at the same rate corresponding to the returning ACKs-Clocking rate and not cause ‘accelerative’ CWND increment/extra accelerative exponential or linear new packet/s injection beyond the rate of the returning ACKs-Clocking rate. When ‘countdown ‘pause’ global variable>0, Linux TCP should not increment CWND whatsoever even if incoming ACK now advances Sliding Window left edge . . . ie Linux TCP could inject new packets into network at the same rate as returning ACKs-Clocking rate BUT not to ‘exponential double’ or ‘linear increase’ beyond the rates of returning ACKs-Clocking rates (easily implemented by modifying all CWND increment code lines to first check if countdown ‘pause’>0, if so bypass increment)

also alternatively Linux modification could just simply require:

1. Do not change/decrement CWND value whatsoever upon congestion drop event/s, and also do not increment CWND whatsoever during ensuing ‘pause interval’ eg 300 ms triggered by congestion drop event (or algorithmically derived interval like latest RTT−min(RTT) . . . or max[latest RTT−min(RTT), eg 300 ms] . . . etc)==>upon congestion drop event/s modified Linux TCP does not inject new ‘accelerative’ packet/s into network (ie with SeqNo>largest.Sent.SeqNo) beyond the returning ACKs clocking rate during the ‘triggered pause interval’ [ie CWND would not be incremented by returning ACKs which advanced the Sliding Window's left edge, even if CWND<Sender/Receiver max window size]

and/or OPTIONALLY

2. always allow retransmission packets (ie packet with SeqNo=<largest.Sent.SeqNo) to be forwarded onwards unhindered by Sliding Window mechanism whatsoever

more refined to ‘STEP 1 . . . just set an eg 300 ms ‘pause’ countdown setting CWND to (Largest.SENT.SeqNo−SENT.UNA.SeqNo) and restores CWND after counted down . . . ==>this way Linux Fast Retransmit module could ‘stroke out’ missing gap packets indicated by incoming same SeqNo multiple subsequent DUP ACKs SACK fields since each subsequent arriving multiple same SeqNo DUP ACKs increments CWND to Largest.SENT.SeqNo−SENT.UNA.SeqNo+1 [whereas if setting CWND to ‘0’ could prevents missing gap packets' retransmission forwarding onwards]==>STEP 1 modifications itself alone should work pretty well without needing STEP 2, but with STEP 1 and STEP 2 modifications together it doesn't matter too much even if CWND were to be set to ‘0’ setting CWND to Largest.SENT.SeqNo−SENT.UNA.SeqNo has same effect as setting to ‘0’ in preventing ‘accelerative’ new additional packets from being injecting into networks, but allows retransmission packets (with SeqNo=<Largest.SENT.SeqNo) to be forwarded onwards unhindered

Existing RFC's TCPs Source Code Modifications and Simplified Test Outlines:

test bed should be (compared to unmodified Linux TCP server):

modified Linux TCP server [+eg 2/5/20% simulated packet drops+eg 100/250/500 ms RTT latency]−>router−>existing Linux TCP client

The link between router and client could be 500 kbps, router could have a 10 or 25 packet buffer. Sender and receiver window sizes of eg 32/64/256 Kbytes.

Suggestions OF Linux TCP Modification Specification:

(a simple technique achieving ‘transmission pause’ by setting CWND=0 during eg 300 ms interval, for easy real life Linux modifications implementations)

1. wherever existing Linux TCP multiplicative decrease CWND (CWND=CWND/2) upon congestion drops events (3 DUP ACKs which halves CWND and RTO Timeout which resets CWND to 0) to instead leaves CWND unchanged and just set a 300 ms ‘pause’ countdown setting CWND to (Largest.SENT.SeqNo−SENT.UNA.SeqNo) and restores CWND after counted down, also should set SSThresh to original CWND value instead of halved or Largest.SENT.SeqNo−SENT.UNA.SeqNo CWND value==>this is exactly equivalent to ‘pausing’ for 0.3 seconds easy implementation.

[STEP 2 here could be optional but prefers, could be added after tests with only STEP 1]

2. enabling unhindered any retransmission packets with SeqNo=<largest existing sent SeqNo, regardless of CWND/effective window Sliding Window slots availability:

at the Sliding Window code sections where Linux TCP checks whether to allows packet to be immediately forwarded onwards (ie depending whether Largest.SENT.SeqNo−SENT.UNA.SeqNo<effective window size), we could very simply insert code to ‘BYPASS’ this check IF packet's SEqNo=<Largest.SENT.SeqNo (ie retransmission packet, which should not be hindered forwarding onwards whatsoever regardless)=>this way Linux TCP Retransmission Module could always ‘stroke out’ all ‘missing gap packets’ indicated by 3rd DUP ACKs/subsequent multiple DUP ACKs IMMEDIATELY. [remember to incorporate SeqNo wraparounds protections]

Useful Notes on Windows Platforms Intercept Fast Retransmit Module

This module (taking over all fast retransmit functions from MSTCP, and modifying incoming ACKNos of incoming DUP ACKs so MSTCP never gets to know of any DUP ACK events whatsoever) should retransmit all ‘missing gap packets’ indicated by SACK fields of incoming same SeqNo DUP ACKs, keeps a list of all retransmitted SeqNos during this same SeqNo multiple DUP ACKS, and will not needlessly retransmit what has already been retransmitted during subsequent same series of SeqNo DUP ACKs EXCEPT where the subsequent same SeqNo DUP ACK now indicates receipt of retransmitted SeqNo packet/s on this ‘Retransmitted List’: in which case the Module should only again retransmit ‘earlier retransmitted missing gap packets’ (ie already on the Retransmitted List) with SeqNo<largest retransmitted SeqNo received indicated by newly arriving same SeqNo Dup ACKs.

Of course, on subsequent new incremented SeqNo 3rd DUP ACKs (SeqNo now different and incremented), this Module could again retransmit all ‘missing gap packets’ indicated by SACK fields of incoming same SeqNo DUP ACKs afresh. Obviously it's preferable in subsequent version/s to above described version/algorithms to:

‘1. wherever existing Linux TCP multiplicative decrease CWND (WND=CWND/2 or CWND=1 on RTO Timeout) upon congestion drops events (3 DUP ACKs which halves CWND and RTO Timeout which resets CWND to 1) to instead leaves CWND unchanged and just set a minimum of (latest RTT of packet triggering the 3rd DUP ACK fast retransmit or triggering RTO Timeout−min(RTT), 300 ms) ‘pause’ countdown setting CWND to 1 and restores CWND to current Largest.SENT.SeqNo−SENT.UNA.SeqNo after ‘pause’counted down (which may be different value altogether to when ‘pause’ was first activated) after counted down, also should set SSThresh to Largest.SENT.SeqNo−SENT.UNA.SeqNo value (as at the time when ‘pause’ was triggered) instead of halved or ‘1’ CWND value=>this is exactly equivalent to ‘pausing’ for 0.3 seconds easy implementation.’

Note: this way, after ‘pause’counted down, modified Linux TCP will not cause sudden ‘burst’ transmissions utilising the returning ACKs-Clocking accumulated during the ‘triggered pause’ interval to again immediately congest drop the link again: BUT after ‘pause’counted down only to transmit then at the subsequent returning ACKs-Clocking rate (ie not including any of the returning ACKs-Clocking tokens accumulated during the ‘pause’ interval

FURTHER PERHAPS EVEN MORE PREFERABLE: ‘1. wherever existing Linux TCP multiplicative decrease CWND (CWND=CWND/2 or CWND=1 on RTO Timeout) upon congestion drops events (3 DUP ACKs which halves CWND and RTO Timeout which resets CWND to 1) to instead leaves CWND unchanged and just set a minimum of (latest RTT of packet triggering the 3rd DUP ACK fast retransmit or triggering RTO Timeout−min(RTT), 300 ms) ‘pause’ countdown setting CWND to Largest.SENT.SeqNo−SENT.UNA.SeqNo [Note: setting this CWND value, instead of 1, would enable all retransmission packets ie with SeqNo=<Largest.SENT.SeqNo to be forwarded onwards immediately unhindered whatsoever by Sliding Window slots availability, BUT note after ‘pause’counted down current Largest.SENT.SeqNo−SENT.UNA.SeqNo would still always be the same as in the case of CWND instead being set to ‘1’ prior to ‘pause’ countdown] and restores CWND to current Largest.SENT.SeqNo−SENT.UNA.SeqNo after ‘pause’ counted down (which may be different value altogether to when ‘pause’ was first activated) after counted down, also should set SSThresh to Largest.SENT.SeqNo−SENT.UNA.SeqNo value (as at the time when ‘pause’ was triggered) instead of halved or ‘1’ CWND value=>this is exactly equivalent to ‘pausing’ for 0.3 seconds easy implementation.’

Existing RFC's TCPs Source Code Modifications and Simplified Test Outlines (Refinement 1):

this initial simplest STEP 1 TCP source code modification alone, should do to initially confirm close to 100% available link's bandwidth utilisation

specific settings test bed should be (compared to eg unmodified Linux/FreeBSD/Windows TCP server):

modified Linux TCP server−>(could be implemented using IPCHAIN) simulated 1 in 10 packets drops 200 ms RTT latency(larger preferred)−>router−>existing Linux TCP client

The link between router and client could be 1 mbs (larger preferred), router could have a 1 mns*eg 0.3 pause value chosen/8=40 Kbytes (ie 40 1 KBytes packet) buffer size. Sender and receiver window sizes of 64 Kbytes (larger preferred).

Suggestions of Initial Simplest 1 Step Linux TCP Modification Specification:

(a simple technique achieving ‘transmission pause’ by setting CWND=0 during eg 300 ms interval, for easy real life Linux modifications implementations)

1. wherever existing Linux TCP multiplicative decrease CWND (CWND=CWND/2 or CWND=1 on RTO Timeout) upon congestion drops events (3 DUP ACKs which halves CWND and RTO Timeout which resets CWND to 1) to instead leaves CWND unchanged and just set a 300 ms ‘pause’

countdown setting CWND to 1 and restores

CWND to original value after counted down, also should set SSThresh to original CWND value

instead of halved or ‘1’ CWND value==>this is exactly equivalent to ‘pausing’ for 0.3 seconds easy implementation.

Note: this would halt all transmissions/retransmissions forwarding onwards for eg 300 ms (to clear buffers) upon 3rd DUP ACKs and RTO Timeouts EXCEPT the very 1st retransmission packet upon the very 3rd DUP ACK triggering Fast Retransmission mechanism and RTO Timeouts (these always get forwarded onwards by Linux TCP regardless of Sliding Window slots availability!). Also any subsequent multiple fast retransmission packets held up/halted by this 300 ms ‘pause’ will be forwarded onwards immediately once 300 ms counted down (only if CWND has not reached maximum send/receive window size, since we do not decrement CWND whatsoever CWND likely already exceeded maximum send/receive window size thus subsequent multiple fast retransmission packets held up/halted by this 300 ms ‘pause’ would likely only be forwarded onwards only at the same rates as returning ACKs-Clocking rate (however luckily including any returning ACKs cumulated during the 300 ms pause period) when 300 ms counted down==>this simplest of modifications would already be of ‘phenomenal’ commercial success with Google/Yahoo/Amazon/Real Player . . . etc

Existing RFC's TCPs Source Code Modifications and Simplified Test Outlines (Refinement 2):

‘1. wherever existing Linux TCP multiplicative decrease CWND (CWND=CWND/2 or CWND=1 on RTO Timeout) upon congestion drops events (3 DUP ACKs which halves CWND and RTO Timeout which resets CWND to 1) to instead leaves CWND unchanged and just set a minimum of (latest RTT of packet triggering the 3rd DUP ACK fast retransmit or triggering RTO Timeout−min(RTT), 300 ms) ‘pause’ countdown setting CWND to 1 and restores

CWND to original value after counted down, also should set SSThresh to original CWND value

instead of halved or ‘1’ CWND value=>this is exactly equivalent to ‘pausing’ for 0.3 seconds easy implementation.’

NOTE: this way if the packet drop event is triggered by physical transmission errors/BER instead of expected usual complete buffer exhaustions (typical buffer size is 300 ms) causing drops, modified Linux TCP doesn't needlessly ‘pause’ or halt any forwarding onwards at all: were the packet drops caused by BER and the link is uncongested, the ‘pause’ countdown will now be correctly set to 0 ms instead of looping forever ‘pausing’ consecutive 300 ms forever. NOTE earlier IPCHAIN method simulating packet drops events DO NOT correspond to congestions or full buffer exhaustions events at all HOWEVER the earlier modification specifications below will still work, but the test bed should now instead be:

unmodified Linux TCP server with eg 5 multiple large FTPs into ROUTER 1 via 1 mbs link and/or congestive traffic generators (or could even be periodic short 300 ms UDP congestive burst generation every eg 1.5 seconds)
   |(1 mbs link)

modified Linux TCP server−>(1 mbs link) ROUTER 1 (1 mbs link)−>existing Linux TCP client

The link between router and client could be 1 mbs (larger preferred), router could have a 1 mns*eg 0.3 pause value chosen/8=40 Kbytes (ie 40 1 KBytes packet) buffer size. Sender and receiver window sizes of 64 Kbytes (larger preferred). NOTE: This way any packet drop/s events will strictly always correspond to full buffer exhaustions scenarios, and ‘pausing’ for 300 ms now makes good sense (or ‘pausing’ interval of triggering packet's RTT−min(RTT) IF=<300 ms, eg very small buffer capacity deployed)

FINALLY: earlier test bed set up with IPCHAIN will work with just not decrementing CWND size whatsoever without needing to ‘pause’ whatsoever==>exhibit 100% link utilisation BUT aggressive non-TCP friendly.

‘1. wherever existing Linux TCP multiplicative decrease CWND (CWND=CWND/2 or CWND=1 on RTO Timeout) upon congestion drops events (3 DUP ACKs which halves CWND and RTO Timeout which resets CWND to 1) to instead leaves CWND unchanged WHATSOVER, also should set SSThresh to unchanged CWND value instead of halved or ‘1’ CWND value==>this itself ensures close to 100% link utilisations regardless of drop rates and RTT latencies’

Receiver Based Increment Deployable TCP Friendly External Internet TCP Modifications

receiver TCP source code could be modified directly (or similarly Intercept Monitor be adapted to perform/work round to achieve same), and will even work with all existing RFC's TCPs:

OUTLINE (see also various earlier described techniques t, and sub-component techniques) [NOTE: its been clear now that CWND size once attained, however large does not on its own causes congestion drops: its the ‘accelerative momentary increases in CWND size eg exponential or linear growth that is the main cause of congestion packet/s drops (returning ACKs-Clocking rates . . . )

1 receiver TCP upon sending 3 DUP ACKs to follow through immediately with an algorithmic determined derived number/series of multiple same SEQNo DUP ACKs (rates of sending of such multiple same SeqNo DUP ACKs may also be controlled algorithmically to control sender TCPs' CWND size thus sending rates as desired), thus sender CWND size could be controlled eg to not be halved upon fast retransmit 3 DUP ACKs . . . or at dictated CWND size timed increments according to receiver's detect of path congestions levels (uncongested/onset of buffer delay of/above certain values, congestion packet drops . . . etc). Could be combined with various earlier techniques like large window sizes, inter-packet-arrivals to early detect packet drops, adjusting receiver window size (eg ‘0’ to totally pause sender's effective window size transmission rates, thus receiver window size now controls sender's effective window transmission rates instead of CWND) . . . etc. Receiver may also utilise sender's CWND size tracking method to help determine multiple DUP ACKs generation rates, also include 1 byte data in certain ACKs generated so sender will notify receiver of precisely which of the DUP ACKs received at sender TCP.

OR

1. receiver TCP withhold sending ACK for a certain earlier received SeqNo, thus sender TCP could now be made to only transmit (ie sender's CWND size timed increments) at receiver's rates of generating multiple same Seqno ACKs (algorithmically derived as desired), thus receiver could control sender's rate==>effectively sender TCP now almost always in fast retransmit mode. With large enough Receiver and Sender window size negotiated, the 1 same SeqNo multiple DUP ACKs could cause Gigabyte to be transferred to completion staying with the 1 same SeqNo series of DUP ACKs, or the SeqNo may be incremented to a larger (or largest) SeqNo successfully received at anytime before effective window size exhaustions to ‘shift’ sender's window edges. (may combine with technique/s to keep sender's CWND size sufficiently large at all times)

and/OR

1. receiver TCP never generates 3 DUP ACKs, just let sender RTO Timeout to retransmit (preferably sufficiently large window scaled sizes negotiated to ensure sender's continuous transmissions without being halted by unacked retransmissions held up before the longer RTO Timeout period triggered), BUT sender's CWND resets to ‘0’or ‘1’ upon RTO Timeout which receiver needs to ensures rapid exponential increments restoration of sender's CWND via a number of followed on same DUP ACKs after detecting RTO Timeout retransmissions.

Notes:
Routers may conveniently set buffer to magnitude smaller . . . like 50 ms (see google search research reports published on improved efficacies of such small buffer settings), also RED mechanism may be adapted to eg drop the eg very 1st buffered packet of any flow/s which has buffered packet/s residencies==>helps achieve real time transmissions/TCPs traffic input rates over such Internet subsets. Also TCPs could just simply rates throttle/‘pause’ to immediately clear onset of any bufferings/reduce CWND size appropriately to enable clearing of onset of any bufferings.
Receiver TCPs above may preferably utilise SACK fields to convey blocks of received SEqNos beyond the ‘clamped’ same SeqNo of series of multiple DUP ACKs, further SACK fields may also be utilised to convey occasional subsequent missing ‘gap’ packets (RFC's permit 3 blocks to be SACKed and SACKed SEqNos will not be unnecessarily retransmitted by existing RFC's TCPs)
Receiver TCPs here could utilise ‘SACK field's blocks’, generating ‘timed’ ‘clamped’ SeqNo of series of same SeqNo DUP ACKs (thus controlling sender's Sliding Window's Snd.UNA value to control effective window sizes, also number of generated same SeqNo multiple DUP ACKS to control sender's CWND size), setting receiver window sizes, tracking sender's CWND size techniques . . . etc enabling receiver to control or ‘pause’ sender's rates/effective window size/CWND size according to receiver's monitoring of path's onset of congestions/buffer exhaustion packet drops (distinguishable from BER packet drop/s while uncongested, as is distinguishable in the OTT time whether beyond recorded min(OTT) thus far . . . )

Various Notes
there are many different ways, and various different combinations of described sub-component methods possible, to implement the desired modifications in many various perhaps even simple ways. Eg were all TCPs in the network all being similarly modified, it would be very easy for each and every TCP senders to just ‘pause’ (or receiver based TCP to cause sender TCP to ‘pause’) for eg an interval latest RTT (or OTT where appropriate)−recorded min(RTT) (or min(OTT) where appropriate), to ensure PSTN like transmission qualities throughout the whole network/Internet subset/s. Instead of above ‘pausing’, the modified TCPs may each instead reduce their CWND size to eg CWND*(latest RTT−min(RTT))/latest RTT, OR to eg CWND*(latest RTT−min(RTT))/min(RTT) . . . etc depending on desired algorithms devised . . . eg to ensure total number of in-flights-packets are immediately reduced ASAP so that any extra in-flights-packets (more than the link/s' available physical bandwidth capacities could cope, without causing onset of buffering) which might cause or require bufferings could be totally cleared (or just reducing bufferings by certain levels), ie to ensure all subsequent still outstanding in-flights-packets now would not require bufferings along the path (or just reducing bufferings by certain levels).
where all Receiver TCPs in the network are all thus modified as described above, Receiver TCPs could have complete control of the sender TCPs transmission rates via its total complete control of the same SeqNo series of multiple DUP ACKs generation rates/spacings/temporary halts . . . etc according to desired algorithms devised . . . eg multiplicative increase and/or linear increase of multiple DUP ACKs rates every RTT (or OTT) so long as RTT (or OTT) remains less than current latest recorded min(RTT) (or current latest recorded min(OTT)) . . . etc. Further once RTT (or OTT) becomes greater than current latest recorded min(RTT) (or current latest recorded min(OTT) ie onset of congestion detected, Receiver based modified TCP (or Intercept Software/Forwarding Proxy . . . etc) may ‘pause’for algorithmically devised period and during this period Receiver based modified TCPs may ‘freeze’ generation of additional extra DUP ACKs except to match that required to match incoming new SeqNo packet/s (ie generating 1 DUP ACK for each 1 of the incoming new SeqNo packet/s'), this would allow reduction/clearing/prevention of the extra sender's total in-flights-packets from being buffered along the path.
Receiver based TCP could include eg 1 byte garbage data to be included in ‘selected marked’ DUP ACK/s, to help receiver to detect/compute RTT/OTT/total-in-flights-packets . . . etc using sender's ACKNo and SeqNo . . . etc subsequently received

21, Nov. 2005 Filing

Various Refinements and Notes

Increment Deployable TCP Friendly External Internet 100% Link Utilisation

Data Storage Transfer NextGenTCP:

At the top most level, CWND now never ever gets reduced at all whatsoever.

Its easy to use Windows desktop ‘Folder string seach’ facility to locate each and every occurrences of CWND variable in all the sub-folders/files . . . to be thorough on RTO Timedout . . . even if its congestion induced we do not reduce/resets CWND at all . . . our RTO Timedout algorithm pseudocodes, modifying existing RFC's specifications, would be to (for ‘real congestions drops’ indications):

Timeout: /* Multiplicative decrease */
recordedCWND=CWND (BUT IF another RTO Timeout occurs during a ‘pause’ in progress THEN recordedCWND=recordedCWND!/* doesn't want to erroneously cause CWND size to be reduced */)
ssthresh=cwnd (BUT IF another RTO Timeout occurs during a ‘pause’ in progress THEN SStresh=recordedCWND!/* doesn't want to erroneously cause SSTresh size to be reduced */);
calculate ‘pause’ interval and sets CWND ‘1*MSS’ and restores CWND=recordedCWND after ‘pause’ counted down;

our RTO Timedout algorithm pseudocodes, modifying existing RFC's specifications, would be to (for ‘non-congestion drops’ indications):

Timeout: /* Multiplicative decrease */

ssthresh=sstresh;

CWND=CWND;

/* both unchanged!*/

just need ensure RFC's TCP modified complying with these simple rules of thumb:

1. never ever reduces CWND value whatsoever, except to temporarily effect ‘pause’ upon ‘real congestion’ indications (restores CWND to recordedCWND thereafter). Note upon real congestion indications (latest RTT when 3rd DUP ACK or when RTO Timeout−min(RTT)>eg 200 ms) SSTresh needs be set to pre-existing CWND so subsequent CWND increments is additive linear

2. If non-congestion indications (latest RTT when 3rd DUP ACK or when RTO Timedout−min(RTT)<eg 200 ms), for both fast retransmit and RTO Timedout modules do not ‘pause’ and do not allow existing RFCs to change CWND value nor SStresh value at all.

Note current pause’ in progress (which could only have been triggered by ‘real congestions’ indication), if any, should be allowed to progress onto counted down (for both fast retransmit and RTO Timeout modules).

3. If there is already current ‘pause’in progress, subsequent intervening ‘real congestion’ indications will now completely terminates current ‘pause’ and begin a new ‘pause’ (a matter of merely setting/overwriting a new ‘pause’ countdown value): taking care that for both fast retransmit and RTO Timeout modules recordedCWND now=recordedCWND (instead of CWND) and now SStresh=recordedCWND (instead of CWND)

Very Simple Basic Working 1st Version Complete Specifications: Only Few Lines Very Simple FreeBSD/Linux TCP Source Code Modifications

[Initially needs sets very large initialised min(RTT) value=eg 30,000 ms, then continuously set min(RTT)=min (latest arriving ACK's RTT, min(RTT))]

1.1 IF 3rd DUP ACK THEN
IF RTT of latest returning ACK when 3 DUP ACKs fast retransmission−current recorded min(RTT)=<eg 200 ms (ie we know now this packet drop couldn't possibly be caused by ‘congestion event’, thus should not unnecessarily set SStresh to CWND value) THEN do not change CWND/SSTresh value (ie to not even set CWND=CWND/2 nor SSthresh to CWND/2, as presently done in existing fast retransmit RFCs)
ELSE should set SSThresh to be same as this recorded existing CWND size (instead of to CWND/2 as in existing Fast Retransmit RFCs), AND to instead keeps a record of existing CWND size and set CWND=‘1*MSS’ and set a ‘pause’ countdown global variable=minimum of (latest RTT of packet triggering the 3rd DUP ACK fast retransmit or triggering RTO Timeout−min(RTT), 300 ms)

Note: setting CWND value=1*MSS, would cause the desired temporary pause/halt of all forwarding onwards of packets, except the very 1st fast retransmit packet retransmission packet/s, to allow buffered packets along the path to be cleared ‘before TCP resumes sending]
ENDIF
   ENDIF

1.2 after ‘pause’time variable counted down, restores CWND to recorded previous CWND value (ie sender can now resumes normal sending after ‘pause’ over)

2.1 IF RTO Timeout THEN

IF RTT of latest returning ACK when RTO Timedout−current recorded min(RTT)=<eg 200 ms (ie we know now this packet drop couldn't possibly be caused by ‘congestion event’, thus should not unnecessarily reset CWND value to 1*MSS) THEN do not reset CWND value to 1*MSS nor changes CWND value at all (ie to not even resets CWND at all, as presently done in existing RTO Timeout RFCs)
ELSE should instead keeps a record of existing CWND size and set CWND=‘1*MSS’ and set a ‘pause’ countdown global variable=minimum of (latest RTT of packet when RTO Timedout−min(RTT), 300 ms)

Note: setting CWND value=1*MSS, would cause the desired temporary pause/halt of all forwarding onwards of packets, except the RTO Timedout retransmission packet/s, to allow buffered packets along the path to be cleared ‘before TCP resumes sending]

2.2 after ‘pause’time variable counted down, restores CWND to recorded previous CWND value (ie sender can now resumes normal sending after ‘pause’over)

THAT'S ALL, DONE NOW!

Background Materials
latest RTT of packet triggering the 3rd DUP ACK fast retransmit or triggering RTO Timeout, is readily available from existing Linux TCB maintained variable on last measured roundtrip time RTT. the minimum recorded min(RTT) is only readily available from existing Westwoord/FastTCP/Vegas TCB maintained variables, but should be easy enough to write few lines of codes to continuously update min(RTT)=minimum of [min(RTT), last measured roundtrip time RTT] References http://www.cs.umd.edu/˜shankar/417-Notes/5-note-transportCongControl.htm: RTT variables maintained by Linux

TCB<http://www.scit.wlv.ac.uk/rfc/rfc29xx/RFC2988.html>: RTO computation Google Search term ‘tcp rtt variables’

<http://www.psc.edu/networking/perf_tune.html>: tuning Linux TCP RTT parameters Google Search: ‘linux TCP minimum recorded RTT’ or ‘linux tcp minimum recorded rtt variable’. NOTE: TCP Westwood measures minimum RTT

Notes:

1. The above ‘congestion notification trigger events’, may alternatively be defined as when latest RTT−min(RTT)>=specified interval eg 5 ms/50/300 ms . . . etc (corresponding to delays introduced by buffering experienced along the path over and beyond pure uncongested RTT or its estimate min(RTT), instead of packet drops indication event.

2. Once the ‘pause’ has counted down, triggered by real congestion drop/s indications, above algorithms/schemes may be adapted so that CWND is now set to a value equal to the total outstanding in-flight-packets at this instantaneous ‘pause’ counted down time (ie equal to latest largest forwarded SeqNo−latest largest returning ACKNo)=>this would prevent a sudden large burst of packets being generated by source TCP, since during ‘pause’ period’ there could be many returning ACKs received which could have very substantially advanced the Sliding Window's edge.

Also as an alternative example among many possible, CWND could initially upon the 3^{rd} DUP ACK fast retransmit request triggering ‘pause’ countdown be set to either unchanged CWND (instead of to ‘1*MSS’) or to a value equal to the total outstanding in-flight-packets at this very instance in time, and further be restored to a value equal to this instantaneous total outstanding in-flight-packets when ‘pause’ has counted down [optionally MINUS the total number additional same SeqNo multiple DUP ACKS (beyond the initial 3 DUP ACKS triggering fast retransmit) received before ‘pause’ counted down at this instantaneous ‘pause’ counted down time (ie equal to latest largest forwarded SeqNo−latest largest returning ACKNo at this very instant in time)]→modified TCP could now stroke out a new packet into the network corresponding to each additional multiple same SeqNo DUP ACKs received during ‘pause’ interval, and after ‘pause’ counted down could optionally belatedly ‘slow down’ transmit rates to clear intervening bufferings along the path IF CWND now restored to a value equal to the now instantaneous total outstanding in-flight-packets MINUS the total number additional same SeqNo multiple DUP ACKS received during ‘pause’, when ‘pause’ has counted down.

Another possible example is for CWND initially upon the 3^{rd} DUP ACK fast retransmit request triggering ‘pause’ countdown be set to ‘1*MSS’, and then be restored to a value equal to this instantaneous total outstanding in-flight-packets MINUS the total number additional same SeqNo multiple DUP ACKS when ‘pause’ has counted down→this way when ‘pause’counted down modified TCP will not ‘burst’ out new packets but to only start stroking out new packets into network corresponding to subsequent new returning ACK rates

3. The above algorithm/scheme's ‘pause’ countdown global variable=minimum of (latest RTT of packet triggering the 3rd DUP ACK fast retransmit or triggering RTO Timeout−min(RTT), 300 ms) above, may instead be set=minimum of (latest RTT of packet triggering the 3rd DUP ACK fast retransmit or triggering RTO Timeout−min(RTT), 300 ms, max(RTT)), where max(RTT) is the largest RTT observed so far. Inclusion of this max(RTT) is to ensure even in very very rare unlikely circumstance where the nodes' buffer capacity are extremely small (eg in a LAN or even WAN), the ‘pause’ period will not be unnecessarily set to be too large like eg the specified 300 ms value. Also instead of above example 300 ms, the value may instead be algorithmically derived dynamically for each different paths.

4. A simple method to enable easy widespread implementation of ready guaranteed service capable network (or just congestion drops free network, and/or just network with much much less buffering delays), would be for all (or almost all) routers and switches at a node in the network to be modified/software upgraded to immediately generate total of 3 DUP ACKs to the traversing TCP flows' sources to indicate to the sources to reduce their transmit rates when the node starts to buffer the traversing TCP flows' packets (ie forwarding link now is 100% utilised and the aggregate traversing TCP flows' sources' packets start to be buffered). The 3 DUP ACKs generation may alternatively be triggered eg when the forwarding link reaches a specified utilisation level eg 95%/98% . . . etc, or some other trigger conditions specified. It doesn't matter even if the packet corresponding to the 3 pseudo DUP ACKs are actually received correctly at the destinations, as subsequent ACKs from destination to source will remedy this.

The generated 3 DUP ACKs packet's fields contain the minimum required source and destination addresses and SeqNo (which could be readily obtained by inspecting the packet/s that are now presently being buffered, taking care that the 3 pseudo DUP ACKs' ACK field is obtained/or derived from the inspected buffered packet's ACKNo). Whereas the pseudo 3 DUP ACKs' ACKNo field could be obtained/or derived from eg switches/routers' maintained table of latest largest ACKNo generated by destination TCP for particular the uni-directional source/destination TCP flow/s, or alternatively the switches/routers may first wait for a destination to source packet to arrive at the node to then obtain/or derive the 3 pseudo DUP ACKs' ACKNo field from inspecting the returning packet's ACK field.

Similarly to above schemes, existing RED and ECN . . . etc could similarly have the algorithm modified as outlined above, enabling real time guaranteed service capable networks (or non congestion drops, and/or much much less buffer delays networks).

5. Another variant implementation on windows:

first needs the module taking over all fast retransmit/RTO Timeout from MSTCP, ie MSTCP never ever sees any DUP ACKs nor RTO Timeout: the module will simply spoof acked every intercepted new packets from MSTCP (ONLY LATER: and where required send MSTCP ‘0’ window size update, or modify incoming network packets'

window size field to ‘0’, to pause/slow down MSTCP packets generations upon congestion notifications eg 3 DUP ACKs or RTO Timeout). Module builds a list of SeqNo/packet copy/systime of all packets forwarded (well ordered in SeqNo) and do fast retransmit/RTO retransmit from this list. All items on list with SeqNo<current largest received ACK will be removed, also removed are all SeqNos SACKed.

Remember needs incorporate ‘SeqNo wraparound’ and ‘time wraparound’ protections in this module.

By spoofing acks all intercepted MSTCP outgoing packets, our windows software now doesn't need to alter any incoming network packets to MSTCP at all whatsoever . . . MSTCP will simply ignore all 3 DUP ACKs received since they are now already outside of the sliding window (being already acked!), nor will sent packets ever timedout (being already acked!)

further we can now easily control MSTCP packets generation rates at all times, via receiver window size fields changes . . . etc. Software could emulate MSTCP own Windows increment/Congestion Control/AIMD mechanisms, by allowing at any time a maximum of packets-in-flights equal to emulated/tracked MSTCP's CWND size: as an overview outline example (among many possible), this could be achieved eg assuming for each returning ACKs emulated/tracked pseudo-mirror CWND size is doubled in each RTT when there has not been any 3 DUP ACK fast retransmit, but once this has occurred emulated/tracked pseudo-mirror CWND size would only now be incremented by 1*MSS per RTT. Software would only ever allows a maximum of instantaneous total outstanding in-flight-packets not more than the emulated/tracked pseudo CWND size, and to throttle MSTCP packets generations via receiver window size update of ‘0’/modifying incoming packets' receiver window size to ‘0’to ‘pause’ MSTCP transmissions when the pseudo-CWND size is exceeded.

This Window software could then keeps track of or estimate the MSTCP CWND size at all times, by tracking latest largest forwarded onwards MSTCP packets' SeqNo and latest largest network's incoming packets' ACKNo (their difference gives the total in-flight-packets outstanding, which correspond to MSTCP's CWND value quite very well). Window Software here just needs make sure it would stop ‘automatic spoof ACKs’ to MSTCP once total number of in-flight-packets>=above mentioned CWND estimate (or alternatively effective window size derived from above CWND estimate and RWND and/or SWND)

1. Methods for improving TCP and/or TCP like protocols and/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods avoid and/or prevent and/or recover from network congestions via complete or partial ‘pause’/‘halt’ in sender's data transmissions when congestion events are detected such as congestion packet drops and/or returning ACK's round trip time RTT/one way trip time OTT comes close to or exceeded certain threshold value eg known value of the flow path's uncongested RTT/OTT or their latest available best estimate min(RTT)/min(OTT).

2. Methods for improving TCP and/or TCP like protocols and/or other protocols, which could be capable of completely implemented directly via TCP/Protocol stack software modifications without requiring any other changes/re-configurations of any other network components whatsoever and which could enable immediate ready guaranteed service PSTN transmissions quality capable networks and without a single packet ever gets congestion dropped, said methods comprises any combinations/subsets of (a) to (c):
(a) makes good use of new realization/technique that TCP's Sliding Window mechanism's ‘Effective Window’ and/or Congestion Window CWND needs not be reduced in size to avoid and/or prevent and/or recover from congestions;
(b) Congestions instead are avoided and/or prevented and/or recovered from via complete or partial ‘pause’/‘halt’ in sender's data transmissions when congestion events are detected such as congestion packet drops and/or returning ACK's round trip time RTT/one way trip time OTT comes close to or exceeded certain threshold value eg known value of the flow path's uncongested RTT/OTT or their latest available best estimate min(RTT)/min(OTT);
(c) Instead or in place or in combination with (b) above, TCP's Sliding Window mechanism's ‘Effective Window’ and/or Congestion Window CWND value is reduced to a value algorithmically derived dependent at least in part on latest returned round trip time RTT/one way trip time OTT value when congestion is detected, and/or the particular flow path's known uncongested round trip time RTT/one way trip time OTT or their latest available best estimate min(RTT)/min(OTT), and/or the particular flow path's latest
observed longest round trip time max(RTT)/one way trip time max(OTT).

3. Methods for virtually congestion free guaranteed service capable data communications network/Internet/Internet subsets/Proprietary Internet segment/WAN/LAN [hereinafter refers to as network] with any combinations/subsets of features (a) to (f):
(a) where all packets/data units sent from a source within the network arriving at a destination within the network all arrive without a single packet being dropped due to network congestions;
(b) applies only to all packets/data units requiring guaranteed service capability;
(c) where the packet/data unit traffics are intercepted and processed before being forwarded onwards;
(d) where the sending source/sources traffics are intercepted processed and forwarded onwards, and/or the packet/data unit traffics are only intercepted processed and forwarded onwards at the originating sending source/sources;
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network; and
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP. do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions.

4. Methods in accordance with claim 3, wherein in said methods the improvements/modifications of protocols is effected at the sender TCP.

5. Methods in accordance with claim 3, wherein in said methods the improvements/modifications of protocols is effected at the receiver side TCP.

6. Methods in accordance with claim 3 above, wherein in said methods the improvements/modifications of protocols is effected in the network's switches/routers nodes.

7. Methods wherein the improvements/modifications of protocols is effected in any combinations of locations as specified in claim 6.

8. Methods wherein the improvements/modifications of protocols is effected in any combinations of locations as specified in claim 6, wherein said methods the existing ‘Random Early Detect’ RED and/or ‘Explicit Congestion Notification’ ECN are modified/adapted to give effect to that disclosed in claim 7 above.

9. Methods in accordance with claim 8 above or independently, wherein the switches/routers in the network are adjusted in their configurations or setups or operations, such as eg buffer size adjustments, to give effect to that disclosed above.

10. Methods in accordance with claim 9, wherein said methods:
existing protocols RFCs are modified such that sender's CWND value is instead now never reduced/decremented whatsoever, except to temporarily effect ‘pause’/‘halt’ of sender's data transmissions upon congestions detected (eg by temporarily setting sender's CWND=1*MSS during ‘pause’/‘halt’ and after ‘pause’/‘halt’ completed to then restore sender's CWND value to eg existing CWND value prior to ‘pause’/halt or to some algorithmically derived value the ‘pause’/halt’ interval could be set to eg arbitrary 300 ms or algorithmically derived such as Minimum (latest RTT of returning ACK packet triggering the 3^{rd} DUP ACK fast retransmit OR latest RTT of returning ACK packet when RTO Timedout, 300 ms) or algorithmically derived such as Minimum (latest RTT of returning ACK packet triggering the 3^{rd} DUP ACK fast retransmit OR latest RTT of returning ACK packet when RTO Timedout, 300 ms, max(RTT))
AND/OR
existing protocols RFCs are modified such that SSThresh is instead now set to existing CWND value prior to the congestion detection which triggers ‘pause’/‘halt’, ie subsequent CWND increments would only be linear additive beyond CWND value.

11. Methods as in accordance with claim 10, wherein in said methods if the congestion detection is due to non-congestion drops eg physical transmission errors or BER ie not due to congestion packet drops, then the ‘pause’/‘halt’ count down interval will be set to ‘0’ instead, ie no actual ‘pause’/‘halt’ of data transmissions will be initiated, also note that any pre-existing current ‘pause’/‘halt’ in progress will be allowed to progress normally onto counted down: congestion detection could be attributable to non-congestion reasons if eg latest returned ACK's RTT when 3^{rd} DUP ACK triggering fast retransmit or latest returned ACK's RTT when RTO Timedout−min(RTT)<eg 200 ms.

12. Methods as in accordance with claim 11, wherein in said methods if there is already a current ‘pause’/‘halt’ in progress, a subsequent ‘real’ congestion event indication will now extends the current ‘pause’/‘halt’ interval, a matter of merely setting/overwriting the present ‘pause’/‘halt’ countdown to a new value such as eg Minimum (latest RTT of returning ACK packet triggering the 3^{rd} DUP ACK fast retransmit OR latest RTT of returning ACK packet when RTO Timedout, 300 ms, max(RTT)).

13. Methods as in accordance with claim 12, wherein said methods:
any one, or all or almost all routers and switches at a node in the network to be modified/software upgraded to immediately generate total of 3 DUP ACKs to the traversing flows' sources to indicate to the sources to reduce their transmit rates when the node starts to buffer the traversing TCP flows' packets (ie forwarding link now is 100% utilised and the aggregate traversing TCP flows' sources' packets start to be buffered): the 3 DUP ACKs generation may alternatively be instead triggered eg when the forwarding link reaches a specified utilisation level eg 95% 98% . . . etc, or some other trigger conditions specified

14. Methods as in accordance with claim 13, wherein in said methods:
existing RED and ECN could similarly have their algorithm modified as outlined in the principles and schemes contained in any of the claims above, enabling real time guaranteed service capable networks (or non congestion drops, and/or much much less buffer delays networks).
